(19) United States
(12) Patent Application Publication
(10) Pub. No.: US 2025/0296804 A1
(43) Pub. Date: Sep. 25, 2025

(54) MEDIUM PROCESSING APPARATUS AND IMAGE FORMING SYSTEM INCORPORATING SAME

(71) Applicants: Keita Sakakibara, KANAGAWA (JP); Kei Sasaki, KANAGAWA (JP); Keisuke Sugiyama, KANAGAWA (JP); Shohei Saito, KANAGAWA (JP)

(72) Inventors: Keita Sakakibara, KANAGAWA (JP); Kei Sasaki, KANAGAWA (JP); Keisuke Sugiyama, KANAGAWA (JP); Shohei Saito, KANAGAWA (JP)

(73) Assignee: Ricoh Company, Ltd., Tokyo (JP)

(21) Appl. No.: 19/084,038

(22) Filed: Mar. 19, 2025

(30) Foreign Application Priority Data
Mar. 21, 2024 (JP) 2024-045527

(51) Int. Cl. B65H 37/04; B41J 3/44; B65H 43/08; G03G 15/00

(52) U.S. Cl. CPC B65H 37/04; B65H 43/08; B41J 3/44; B65H 2301/5161; B65H 2301/5162; B65H 2515/40; B65H 2553/41; B65H 2801/27; G03G 15/6544

(57) ABSTRACT

A medium processing apparatus includes a liquid applier, a medium processing device, and circuitry. The liquid applier includes a liquid application member, a pressing member, and a detector. The liquid application member contacts a medium and apply liquid to the medium to perform liquid application. The pressing member moves the liquid application member, and press the liquid application member against the medium. The detector detects an amount of the liquid applied to the medium subjected to the liquid application. The medium processing device performs a predetermined process on a bundle of media subjected to the liquid application. The circuitry is to control the liquid applier and the medium processing device to set an amount of movement of the liquid application member and a contact time of the liquid application member to the medium, to set a control mode, and change the control mode according to the liquid amount.

### CROSS-REFERENCE TO RELATED APPLICATION

This patent application is based on and claims priority pursuant to 35 U.S.C. § 119(a) to Japanese Patent Application No. 2024-045527, filed on Mar. 21, 2024, in the Japan Patent Office, the entire disclosure of which is hereby incorporated by reference herein.

### BACKGROUND

### Technical Field

Embodiments of the present disclosure relate to a medium processing apparatus and an image forming system incorporating the medium processing apparatus.

### Related Art

Various types of medium processing apparatuses are known that bind a sheet bundle of stacked sheet media. Such medium processing apparatuses employ binding processes including, for example, a “stapling process” for penetrating needle-shaped members (binding members) through a sheet bundle to bind the sheet bundle and a “crimp binding process” for applying pressure to and deform a part of a sheet bundle to bind the sheet bundle.

In order to adjust a liquid application amount in a medium processing apparatus in the art, there is disclosed a content in which the application amount is optimized by an environmental condition (preprocessing, ambient temperature, and conveyance distance) that is a factor affecting binding strength.

In the medium processing apparatus in the art, the amount of liquid to be applied to the medium in applying the liquid is adjusted based on environmental conditions, but even if the type of the medium is the same, the amount capable of holding the applied liquid varies depending on the manufacturing time, the manufacturing lot, and the storage environment after the manufacturing. In this regard, simply adjusting the liquid application amount by the adjustment based on the environmental conditions as in the medium processing apparatus in the art poses problems in suppressing the influence of the binding process on quality.

### SUMMARY

Embodiments of the present disclosure described herein provide a novel medium processing apparatus including a liquid applier, a medium processing device, and circuitry. The liquid applier includes a liquid application member, a pressing member, and a detector. The liquid application member contacts a part of at least one medium and apply liquid to the part of the at least one medium to form a liquid application. The pressing member moves the liquid application member between a liquid application position at which the liquid application member contacts the at least one medium and a separation position at which the liquid application member is separated from the liquid application position, and press, the liquid application member at the liquid application position, against the at least one medium. The detector detects a liquid amount of the liquid applied to the at least one medium subjected to the liquid application. The medium processing device performs a predetermined process on a bundle of media including the at least one medium subjected to the liquid application. The circuitry is to control the liquid applier and the medium processing device to set an amount of movement of the liquid application member moved by the pressing member and a contact time of the liquid application member to the at least one medium, to set a control mode, and change the control mode according to the liquid amount detected by the detector.

Further, embodiments of the present disclosure described herein provide an image forming system including an image former, a liquid applier, a medium processing device, and circuitry. The image former forms an image on at least one medium. The liquid applier includes a liquid application member, a pressing member, and a detector. The liquid application member contacts a part of the at least one medium and apply liquid to the part of the at least one medium on which the image is formed by the image former to perform a liquid application. The pressing member moves the liquid application member between a liquid application position at which the liquid application member contacts the at least one medium and a separation position at which the liquid application member is separated from the liquid application position, and press, the liquid application member at the liquid application position, against the at least one medium. The detector detects a liquid amount of the liquid applied to the at least one medium subjected to the liquid application. The medium processing device performs a process on, a bundle of media including the at least one medium, after applying the liquid by the liquid applier. The circuitry is to control the liquid applier and the medium processing device to set an amount of movement of the liquid application member moved by the pressing member and a contact time of the liquid application member to the at least one medium, to set a control mode, and change the control mode according to the liquid amount detected by the detector.

### BRIEF DESCRIPTION OF THE DRAWINGS

A more complete appreciation of embodiments of the present disclosure and many of the attendant advantages and features thereof can be readily obtained and understood from the following detailed description with reference to the accompanying drawings, wherein:

FIG. 1 is a diagram illustrating a general arrangement of an image forming system;

FIG. 2 is a view illustrating an internal configuration of a post-processing apparatus according to a first embodiment;

FIG. 3 is a schematic view of an edge binder, viewed from an upstream side in a conveyance direction;

FIG. 4 is a schematic view illustrating the edge binder as viewed from a liquid applier in a main scanning direction;

FIGS. 5A and 5B are schematic views each illustrating a configuration of a crimper of the edge binder;

FIG. 6 is a view illustrating a modification of the edge binder;

FIGS. 7A, 7B, and 7C are views illustrating a liquid application crimper according to a modification of the edge binder;

FIGS. 8A, 8B and 8C are views illustrating a liquid applying operation and a crimp binding operation performed by the liquid application crimper of FIGS. 7A, 7B and 7C;

FIG. 9 is a schematic view illustrating a staple binder as viewed from an upstream side in the conveyance direction;

FIG. 10 is a schematic view of a modification of the staple binder as viewed from the upstream side in the conveyance direction;

FIGS. 11A and 11B are views each illustrating the location and configuration of a second liquid storage tank in the post-processing apparatus;

FIG. 12 including FIGS. 12(A), 12(B) and 12(C) is a diagram illustrating a configuration of attachment and detachment of the second liquid storage tank in the post-processing apparatus;

FIG. 13 is a hardware configuration diagram of a control block to control the post-processing apparatus according to the first embodiment;

FIG. 14 is a flowchart of a binding process performed by the edge binder;

FIGS. 15A, 15B, 15C and 15D are diagrams illustrating positions of the edge binder during operation of a one-point binding;

FIGS. 16A, 16B, 16C, 16D, 16E, 16F, 16G and 16H are diagrams illustrating positions of the edge binder during operation of a two-point binding;

FIG. 17 is a graph illustrating a correlation between a conveyance time until being conveyed to the medium processing apparatus and a change in a sheet temperature heated on the upstream side;

FIG. 18 is an overall configuration diagram clearly illustrating a relay peripheral device in an example of the image forming system;

FIG. 19 is a diagram illustrating an example of a conveyance distance by a configuration of the image forming system;

FIG. 20 is an overall configuration diagram clearly illustrating a relay peripheral device in another example of the image forming system;

FIG. 21 is a diagram illustrating another example of a conveyance distance by the configuration of the image forming system;

FIG. 22 is a diagram illustrating an example of types of liquid application patterns based on a fixing temperature and a conveyance distance in an image forming process;

FIG. 23 is a diagram illustrating an example of a liquid application pattern selected on the basis of a fixing temperature and a conveyance distance in the image forming process;

FIG. 24 is a diagram illustrating an example of a liquid application pattern selected on the basis of a fixing temperature and a conveyance distance in the image forming process;

FIG. 25 is a diagram illustrating an example of a liquid application pattern selected on the basis of a fixing temperature and a conveyance distance in the image forming process;

FIG. 26 is a diagram illustrating an example of setting values of a pressing amount and a liquid application time based on a liquid application pattern;

FIG. 27 is a schematic view illustrating another example of the edge binder as viewed from a liquid applier in a main scanning direction;

FIG. 28 including FIGS. 28A and 28B is a flowchart illustrating an example of a process of liquid application control;

FIG. 29 is a diagram illustrating an example of adjustment values of a pressing amount and a liquid application time based on a liquid application control pattern;

FIG. 30 is a flowchart illustrating another example of the liquid application control processing;

FIG. 31 is a flowchart illustrating another example of the liquid application control processing;

FIG. 32 is a flowchart illustrating another example of the liquid application control processing;

FIG. 33 is a view illustrating an internal structure of a post-processing apparatus according to a second embodiment;

FIGS. 34A, 34B and 34C are views of an internal tray according to the second embodiment in a thickness direction of a sheet;

FIG. 35 is a schematic view of a crimper of the post-processing apparatus according to the second embodiment as viewed from a downstream side in a conveyance direction of the sheet;

FIGS. 36A and 36B are views of a liquid applier according to the second embodiment as viewed from the thickness direction of the sheet;

FIGS. 37A, 37B and 37C are cross-sectional views of the liquid applier taken along a line XXV-XXV of FIG. 36A;

FIGS. 38A, 38B and 38C are cross-sectional views of the liquid applier taken along a line XXVI-XXVI of FIG. 36A;

FIG. 39 is a hardware configuration diagram of a control block of the post-processing apparatus according to the second embodiment;

FIG. 40 is a flowchart of post-processing of the post-processing apparatus according to the second embodiment;

FIG. 41 is a diagram illustrating an overall configuration of a modification of the image forming system;

FIGS. 42A and 42B are diagrams illustrating Modification 1 of a controller of the post-processing apparatus; and

FIGS. 43A and 43B are diagrams illustrating Modification 2 of a controller of the post-processing apparatus.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, embodiments of the present disclosure are described below. As used herein, the singular forms “a,” “an,” and “the” are intended to include the plural forms as well, unless the context clearly indicates otherwise.

### Embodiment of Image Forming System

A description is given below of an image forming system 1 according to the present invention, with reference to the drawings.

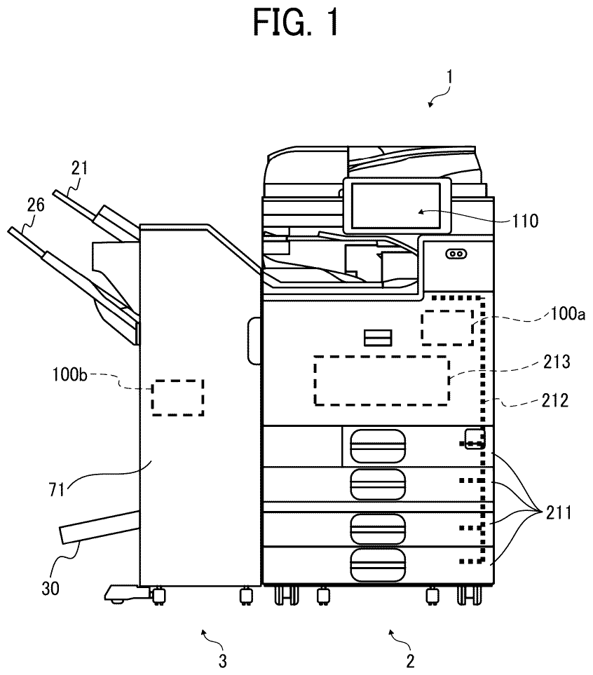

FIG. 1 is a diagram illustrating an overall configuration of the image forming system 1.

The image forming system 1 has, for example, an image forming function of forming an image on a sheet P as an example of a sheet-shaped medium and a post-processing function of performing post-processing on the sheet P on which the image has been formed. As illustrated in FIG. 1, the image forming system 1 includes an image forming apparatus 2 including the image forming function and a post-processing apparatus 3 serving as a medium processing apparatus including the post-processing function, according to an embodiment of the present disclosure. In the image forming system 1, the image forming apparatus 2 and the post-processing apparatus 3 operate in conjunction with each other.

In the present embodiment, the sheet-shaped medium or sheet-shaped medium to be processed in the image forming system 1 is described on the assumption that the medium is a sheet of “paper”. The object to be processed according to the present embodiment is not limited to a paper. For example, any material or specification may be used as long as an image can be formed on a medium in a known image forming process and the medium is a target of the image forming process. Examples of the medium include a medium that can be an object of a folding process or a binding process, and the material and specification of the medium are not limited to any particular material and specification.

The image forming apparatus 2 forms an image on the sheet P and ejects the sheet P having the image to the post-processing apparatus 3. The image forming apparatus 2 includes a sheet tray 211 that accommodates the sheet P, a conveyor 212 that conveys the sheet P accommodated in the sheet tray 211, and an image former 213 that forms an image on the sheet P conveyed by the conveyor 212. The image former 213 may be an inkjet system that forms an image using ink or an electrophotographic system that forms an image using toner. The image forming apparatus 2 also includes a controller 100a that controls various operations of the conveyor 212 and the image former 213. Since the image forming apparatus 2 has a typical configuration, a detailed description of the configuration and functions of the image forming apparatus 2 are omitted.

Sheets of paper are widely known as an example of sheet-shaped media. Further, in the following description, a sheet-shaped medium as a medium to be processed is referred to as a “sheet P.” Further, in the following description, a bundle of sheets of paper as a bundle of media is an example of a “sheet bundle Pb.”

### First Embodiment of Post-Processing Apparatus

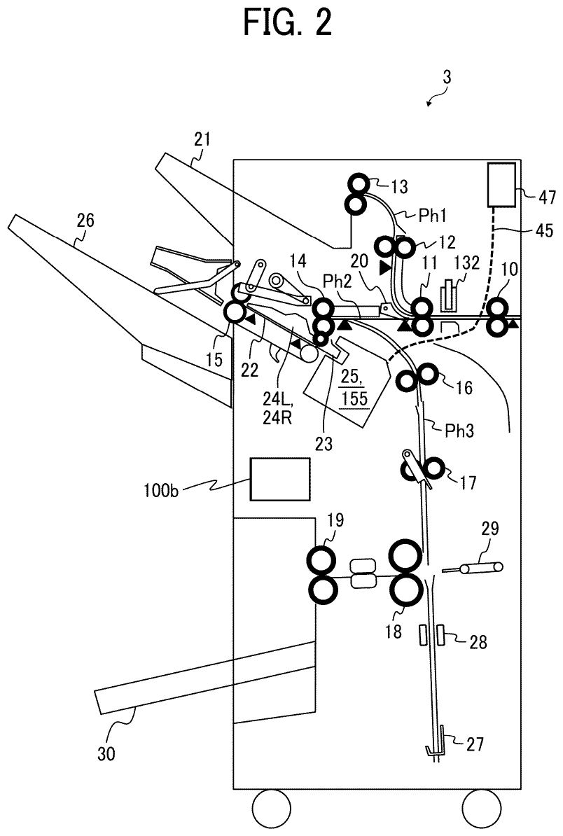

FIG. 2 is a diagram illustrating an internal configuration of the post-processing apparatus 3 according to the first embodiment of the present disclosure.

The post-processing apparatus 3 has a function that performs post-processing on the sheet P on which an image has been formed by the image forming apparatus 2.

An example of the post-processing according to the present embodiment is a binding process as a “crimping process” that binds, without staples, multiple sheets P on each of which an image is formed as a bundle of sheets, which may be referred to as a sheet bundle (bundle of media). Another example of the post-processing according to the present embodiment is a binding process as a “stapling process” that binds, with staples, the multiple sheets P on each of which an image is formed as a bundle of sheets (i.e., sheet bundle). In the following description, the bundle of sheets P may be referred to as a “sheet bundle Pb” as a bundle of media.

In the present embodiment, a description is given of liquid application process in a crimp binding process. However, the liquid application process performed in a stapling process is similar to the liquid application process in the crimp binding process. In the following description, the term “binding process” indicates both the “crimp binding process” and the “stapling process”, and is not limited to a binding method (whether a binding needle is used or a pressing and deforming process is performed).

More particularly, the “crimp binding process” according to the present embodiment is a process called “crimp binding” to apply pressure to the binding position corresponding to a part of the sheet bundle Pb to deform (pressure-deform) the binding position and bind the sheet bundle Pb. The binding process that can be executed by the post-processing apparatus 3 includes an edge binding process and a saddle binding process. The edge binding process is a process to bind an end (including an edge) of the sheet bundle Pb. The saddle binding process is a process to bind the center of the sheet bundle Pb.

The post-processing apparatus 3 includes conveyance roller pairs 10 to 19 (an example of conveyors), a switching member 20, and a controller 100b (an example of a control unit). The controller 100b controls the operations of, for example, the conveyance roller pairs 10 to 19 (an example of conveyors), and the switching member 20. Details of the controller 100b will be described below. The conveyance roller pairs 10 to 19 convey, inside the post-processing apparatus 3, the sheet P supplied from the image forming apparatus 2. More particularly, the conveyance roller pairs 10 to 13 convey the sheet P along a first conveyance path Ph1. The conveyance roller pairs 14 and 15 convey the sheet P along a second conveyance path Ph2. The conveyance roller pairs 16 to 19 convey the sheet P along a third conveyance path Ph3. A hole punch 132 is disposed between the conveyance roller pairs 10 and 11. The hole punch 132 performs punching on a sheet P conveyed by the conveyance roller pairs 10 and 11.

The first conveyance path Ph1 is a path extending to a first ejection tray 21 from a supply port through which the sheet P is supplied from the image forming apparatus 2. The second conveyance path Ph2 is a path branching from the first conveyance path Ph1 between the conveyance roller pairs 11 and 14 in a conveyance direction and extending to a second ejection tray 26 via an internal tray 22. The third conveyance path Ph3 is a path branching from the first conveyance path Ph1 between the conveyance roller pairs 11 and 14 in the conveyance direction and extending to an ejection tray 30.

The switching member 20 is disposed at a branching position of the first conveyance path Ph1 and the second conveyance path Ph2. The switching member 20 can be switched between a first position and a second position. The switching member 20 in the first position guides the sheet P to be ejected to the first ejection tray 21 through the first conveyance path Ph1. The switching member 20 in the second position guides the sheet P conveyed through the first conveyance path Ph1 to the second conveyance path Ph2. When a trailing end of the sheet P entering the second conveyance path Ph2 passes through the conveyance roller pair 11, the conveyance roller pair 14 is rotated in reverse to guide the sheet P to the third conveyance path Ph3. The post-processing apparatus 3 further includes a plurality of sensors that detects the positions of the sheet P in the first conveyance path Ph1, the second conveyance path Ph2, and the third conveyance path Ph3. Each of the multiple sensors is indicated by a black triangle in FIG. 2.

The post-processing apparatus 3 includes the first ejection tray 21. The sheet P ejected through the first conveyance path Ph1 is placed on the first ejection tray 21. Among the sheets P supplied from the image forming apparatus 2, the sheets P that are not bound are ejected to the first ejection tray 21.

The post-processing apparatus 3 further includes the internal tray 22 serving as a placement tray, an edge-binding end fence 23, side fences 24L and 24R, an edge binder 25, a staple binder 155, and the second ejection tray 26. The internal tray 22, the edge-binding end fence 23, the side fences 24L and 24R, the edge binder 25, and the staple binder 155 perform edge binding process on the sheet bundle Pb including a plurality of sheets P conveyed from the second conveyance path Ph2 to the internal tray 22. Among the sheets P supplied from the image forming apparatus 2, the sheet bundle Pb subjected to the edge binding process is ejected to the second ejection tray 26.

The “edge binding process” here means a binding process performed by the edge binder 25 and the staple binder 155. Specifically, the “edge binding process” includes, but not limited to, a “parallel binding process” that binds the sheet bundle Pb along one side of the sheet bundle Pb parallel to the main scanning direction, an “inclined binding process” that binds a corner of the sheet bundle Pb, and a “vertical binding process” that binds the sheet bundle Pb along one side of the sheet bundle Pb parallel to the conveyance direction.

In the following description, a direction in which the sheet P is conveyed from the conveyance roller pair 15 toward the edge-binding end fence 23 is defined as a “conveyance direction”. In other words, the “conveyance direction” in the present specification corresponds to a direction in which the sheet P ejected from the image forming apparatus 2 is moved toward the second ejection tray 26 by, for example, the conveyance roller pair 10 and is then changed by the conveyance roller pair 15 to move toward the edge-binding end fence 23 as a direction different from the direction toward the second ejection tray 26. A direction that is orthogonal to the conveyance direction and a thickness direction of the sheet P is defined as a “main scanning direction” or a “width direction of the sheet P.”

The plurality of sheets P that is sequentially conveyed through the second conveyance path Ph2 is temporarily placed on the internal tray 22 serving as a placement tray. The edge-binding end fence 23 aligns the position, in the conveyance direction, of the sheet P or the sheet bundle Pb placed on the internal tray 22. The side fences 24L and 24R align the position, in the main scanning direction, of the sheet P or the sheet bundle Pb placed on the internal tray 22. The edge binder 25 and the staple binder 155 perform the edge binding process on the sheet bundle Pb aligned by the edge-binding end fence 23 and the side fences 24L and 24R.

Then, the conveyance roller pair 15 ejects the sheet bundle Pb subjected to the edge binding process to the second ejection tray 26.

The post-processing apparatus 3 further includes a saddle-binding end fence 27, a saddle binder 28, a sheet folding blade 29, and the ejection tray 30. The saddle-binding end fence 27, the saddle binder 28, and the sheet folding blade 29 perform the saddle binding process on the sheet bundle Pb including the plurality of sheets P that is conveyed through the third conveyance path Ph3. Among the sheets P supplied from the image forming apparatus 2, the sheet bundle Pb subjected to the saddle binding process is ejected to the ejection tray 30.

The saddle-binding end fence 27 aligns the positions of the plurality of sheets P that is sequentially conveyed through the third conveyance path Ph3, in a direction in which the plurality of sheets P is conveyed. The saddle-binding end fence 27 can move between a binding position where the saddle-binding end fence 27 causes the center of the sheet bundle Pb to face the saddle binder 28 and a folding position where the saddle-binding end fence 27 causes the center of the sheet bundle Pb to face the sheet folding blade 29. The saddle binder 28 binds the center of the sheet bundle Pb aligned by the saddle-binding end fence 27 at the binding position. The sheet folding blade 29 folds, in half, the sheet bundle Pb placed on the saddle-binding end fence 27 at the folding position and causes the conveyance roller pair 18 to nip the sheet bundle Pb. The conveyance roller pairs 18 and 19 eject the sheet bundle Pb subjected to the saddle binding process to the ejection tray 30.

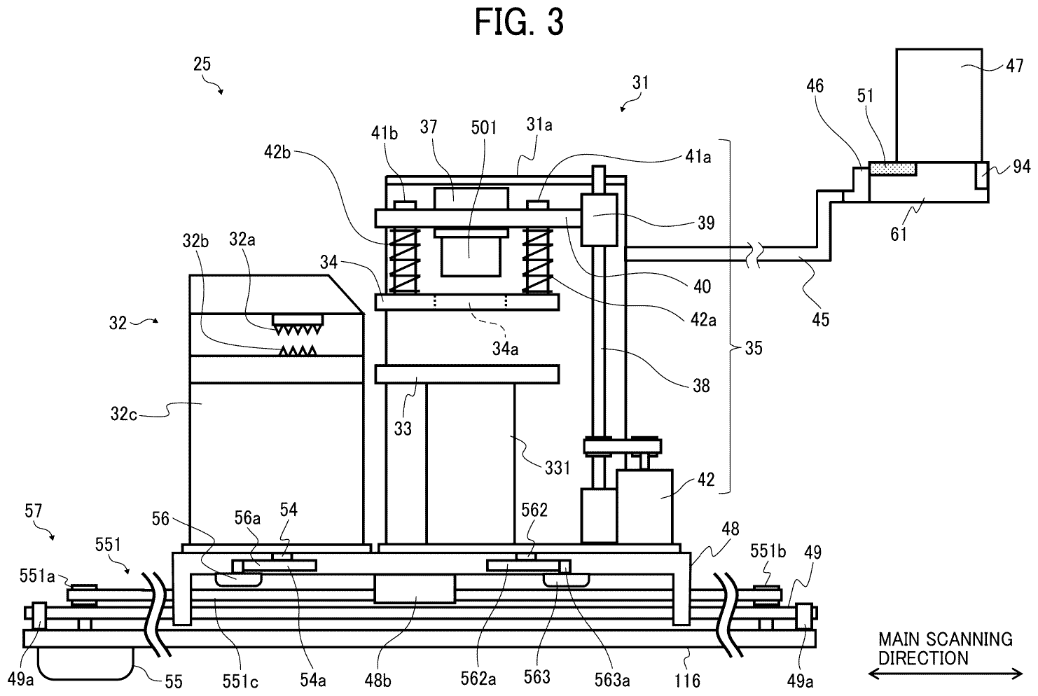

In addition, the post-processing apparatus 3 includes a liquid application member 501 (a part of the liquid applier), a liquid supply member 50 (a part of the liquid applier), and a first liquid storage tank 44 (a first liquid storage unit) in the edge binder 25. The first liquid storage tank 44 and the liquid supply member 50 are omitted in FIG. 3. The post-processing apparatus 3 includes a liquid supply path 45 (a part of the liquid supplier), a liquid supply pump 46 (a part of the liquid supplier), a second liquid storage tank 47 (a part of the second liquid storage unit), and a second liquid storage tank fixer 61 (a part of the second liquid storage unit) as a configuration for replenishing the first liquid storage tank 44 with the liquid. The liquid that is stored in the second liquid storage tank 47 is supplied to the first liquid storage tank 44 via the second liquid storage tank fixer 61, the liquid supply pump 46, and the liquid supply path 45.

### Configuration of Edge Binder

FIG. 3 is a schematic view illustrating the edge binder 25 of FIG. 2 that performs the liquid application process and crimp binding process, as viewed from an upstream side thereof in the conveyance direction.

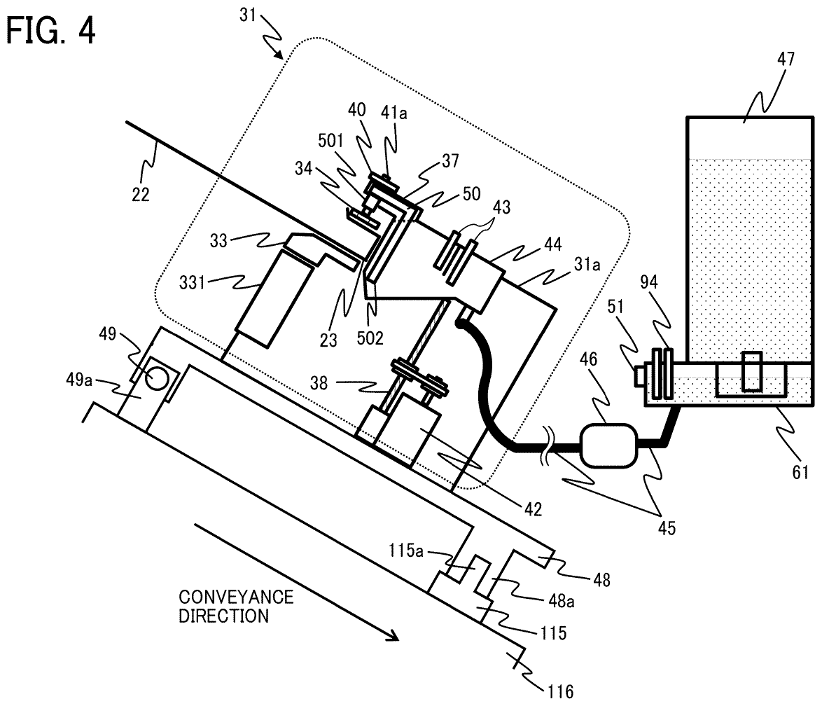

FIG. 4 is a schematic view illustrating a liquid applier 31 of the edge binder 25 when viewed from the main scanning direction.

As illustrated in FIG. 3, the edge binder 25 includes the liquid applier 31 that applies liquid to the sheet P or the sheet bundle Pb, and a crimper 32 that is an example of a medium processing unit and performs crimp binding on the sheet bundle Pb. The liquid applier 31 and the crimper 32 are disposed downstream from the internal tray 22 in the conveyance direction and adjacent to each other in the main scanning direction.

As illustrated in FIG. 4, the liquid applier 31 applies the liquid stored in the first liquid storage tank 44 to the sheet P or the sheet bundle Pb placed on the internal tray 22. The application of the liquid to the sheet P or the sheet bundle Pb by the liquid applier 31 and the operation of the liquid applier 31 in applying the liquid are referred to as “liquid application” below. The liquid applying operation of the liquid applier 31 involving control processing is referred to as a “liquid application process”.

More specifically, the liquid that is stored in the first liquid storage tank 44 as liquid for the “liquid application” includes, as a main component, the liquid state of a compound of hydrogen and oxygen compound represented by the chemical formula H₂O. The liquid hydrogen-oxygen compound is at any temperature. For example, the liquid hydrogen-oxygen compound may be so-called warm water or hot water. The liquid hydrogen-oxygen compound is not limited to pure water. The liquid hydrogen-oxygen compound may be purified water or may contain ionized salts. The metal ion content ranges from so-called soft water to ultrahard water. In other words, the liquid hydrogen-oxygen compound is at any hardness.

The liquid may include an additive in addition to the main component. The liquid that is stored in the liquid storage tank may include residual chlorine used as tap water. Preferably, for example, the liquid that is stored in the liquid storage tank may include, as an additive, a colorant, a penetrant, a pH adjuster, a preservative such as phenoxyethanol, a drying inhibitor such as glycerin, or a combination thereof. Furthermore, because water is used as a component of ink used for inkjet printers or ink used for water-based pens, such water or ink may be used for the “liquid application”.

The water is not limited to the specific examples described above. The water may be water in a broad sense such as hypochlorous acid water or an ethanol aqueous solution diluted for disinfection. However, tap water may be used simply to enhance the binding strength after the binding process because tap water is easy to obtain and store. A liquid including water as a main component as exemplified above enhances the binding strength of the sheet bundle Pb, in comparison with a liquid of which the main component is not water (liquid).

### Configuration of Liquid Applier

As illustrated in FIGS. 3 and 4, the liquid applier 31 is movable in the main scanning direction together with the crimper 32 by a driving force transmitted from an edge binder movement motor 55. The liquid applier 31 includes a lower pressure plate 33 serving as a receptacle for the sheet P or the sheet bundle Pb, an upper pressure plate 34, and a liquid applier movement assembly 35. The components of the liquid applier 31 (the lower pressure plate 33, the upper pressure plate 34, the liquid applier movement assembly 35, and a liquid applier movement motor 42) are held by a liquid application frame 31a and a base 48.

A liquid applier shaft 562 including a drive transmission gear 562a is fixed to a bottom face of the liquid application frame 31a that holds the components of the liquid applier 31. The liquid applier shaft 562 and the drive transmission gear 562a are held by the base 48 on which the liquid application frame 31a is disposed, so as to be rotatable in the forward and reverse directions. The drive transmission gear 562a meshes with an output gear 563a of a liquid applier pivot motor 563. The liquid applier 31 can be rotated in the forward and reverse directions about the liquid applier shaft 562 on the base 48 by a driving force transmitted from the liquid applier pivot motor 563 to the liquid applier shaft 562 via the output gear 563a and the drive transmission gear 562a.

The lower pressure plate 33 and the upper pressure plate 34 are disposed downstream from the internal tray 22 in the conveyance direction. The sheets P or the sheet bundle Pb that is placed on the internal tray 22 is also placed on the lower pressure plate 33. The lower pressure plate 33 is provided on a lower pressure plate holder 331. The upper pressure plate 34 is movable in the thickness direction of the sheet P or the sheet bundle Pb at a position where the upper pressure plate 34 faces the sheet P or the sheet bundle Pb placed on the internal tray 22.

In other words, the lower pressure plate 33 and the upper pressure plate 34 are disposed to face each other in the thickness direction of the sheet P or the sheet bundle Pb with the sheet P or the sheet bundle Pb placed on the internal tray 22 and interposed between the lower pressure plate 33 and the upper pressure plate 34. In the following description, the thickness direction of the sheet P or the sheet bundle Pb may be referred to simply as “thickness direction”. Further, the upper pressure plate 34 is provided with a through hole 34a passing through the upper pressure plate 34 in the thickness direction at a position opposite to the liquid application member 501 held via the holder 37 attached to the base plate 40. The liquid application member 501 is one end portion of a liquid supply member 50 (liquid absorber) described below and corresponds to a tip portion of the liquid supply member 50.

The liquid applier movement assembly 35 moves the upper pressure plate 34, the base plate 40, the holder 37, the liquid application member 501, the liquid supply member 50, and the first liquid storage tank 44 in the thickness direction of the sheet P or the sheet bundle Pb. The liquid applier movement assembly 35 according to the present embodiment moves the upper pressure plate 34, the base plate 40, the holder 37, the liquid application member 501, the liquid supply member 50, and the first liquid storage tank 44 in conjunction with each other with the single liquid applier movement motor 42. The liquid applier movement assembly 35 includes, for example, the liquid applier movement motor 42, a trapezoidal screw 38, a nut 39, the base plate 40, columns 41a and 41b, and coil springs 42a and 42b.

The liquid applier movement motor 42 generates a driving force to move the upper pressure plate 34, the base plate 40, the holder 37, the liquid application member 501, the liquid supply member 50, and the first liquid storage tank 44. The trapezoidal screw 38 extends in the thickness direction of the sheet P or the sheet bundle Pb and is provided with the liquid application frame 31a such that the trapezoidal screw 38 is rotatable in the forward and reverse directions. The trapezoidal screw 38 is coupled to an output shaft of the liquid applier movement motor 42 via, for example, a pulley and a belt. The nut 39 is screwed to the trapezoidal screw 38. The trapezoidal screw 38 is rotated in the forward and reverse directions by the driving force transmitted from the liquid applier movement motor 42. The rotation of the trapezoidal screw 38 causes the nut 39 to reciprocate on the trapezoidal screw 38.

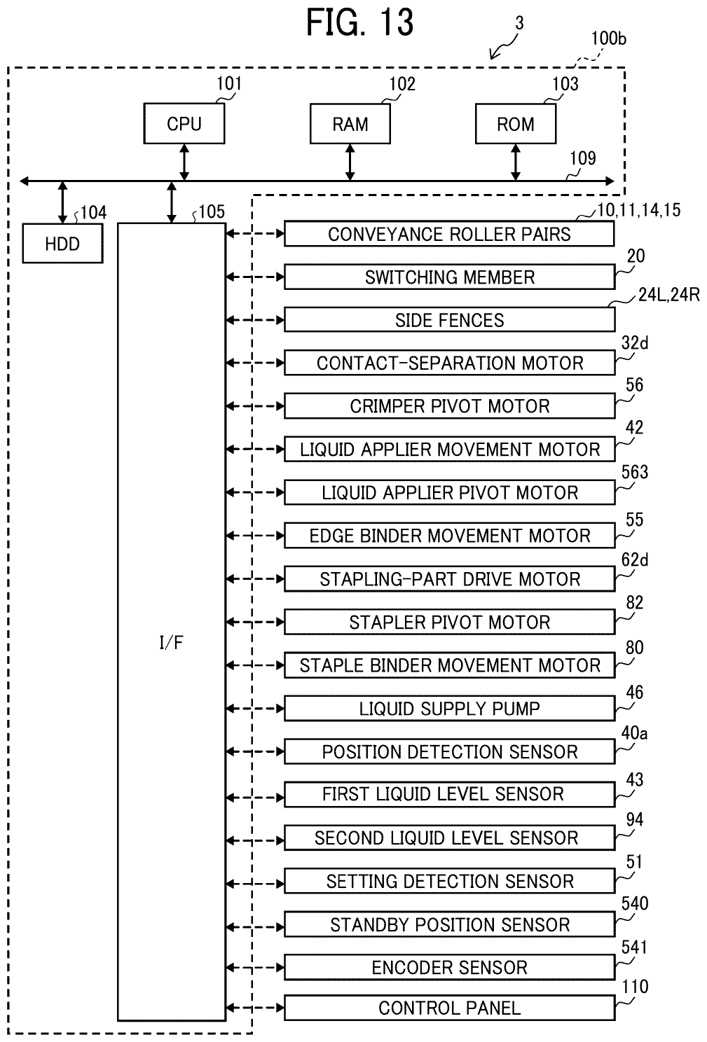

The base plate 40 is positioned apart from the upper pressure plate 34. The base plate 40 holds the liquid application member 501 with the tip portion of the liquid application member 501 protruding from the base plate 40 toward the upper pressure plate 34. The base plate 40 is coupled to the trapezoidal screw 38 via the nut 39 such that base plate 40 can reciprocate along the trapezoidal screw 38 as the trapezoidal screw 38 rotates in the forward and reverse directions. The position of the base plate 40 in the thickness direction of the sheet P or the sheet bundle Pb is detected by a position detection sensor 40a (see FIG. 13).

The columns 41a and 41b project from the base plate 40 toward the upper pressure plate 34 around the tip portion of the liquid application member 501. The columns 41a and 41b can relatively move with respect to the base plate 40 in the thickness direction. The columns 41a and 41b hold the upper pressure plate 34 with the respective tip ends closer to the lower pressure plate 33 than the other ends of the columns 41a and 41b. The other ends of the columns 41a and 41b opposite the ends closer to the lower pressure plate 33 are provided with stoppers that prevent the columns 41a and 41b from being removed from the base plate 40.

The coil springs 42a and 42b are fitted around the columns 41a and 41b, respectively, between the base plate 40 and the upper pressure plate 34. The coil springs 42a and 42b bias the upper pressure plate 34 and the columns 41a and 41b toward the lower pressure plate 33 with respect to the base plate 40.

The liquid applier 31 applies liquid to the sheet P or the sheet bundle Pb placed on the internal tray 22. More particularly, the liquid applier 31 brings the liquid application member 501 into contact with the sheet P or the sheet bundle Pb to apply the liquid to at least one sheet P of the sheet bundle Pb.

The liquid applier 31 includes a first liquid level sensor 43 (serving as a first liquid detector), the first liquid storage tank 44, the liquid application member 501, the liquid supply member 50, and the holder 37. The first liquid storage tank 44 stores the liquid to be applied to the sheet P or the sheet bundle Pb. The amount of liquid that is stored in the first liquid storage tank 44 is detected by the first liquid level sensor 43. The first liquid storage tank 44 is coupled to the base plate 40 via the holder 37.

The liquid application member 501 applies the liquid stored in the first liquid storage tank 44 to the sheet P or the sheet bundle Pb. The liquid application member 501, the liquid supply member 50 (liquid absorber) disposed in close contact with the liquid application member 501, and the first liquid storage tank 44 are held by the holder 37. The holder 37 is held by the base plate 40. The liquid supply member 50 has a first end in close contact with the liquid application member 501 and a second end immersed in the liquid stored in the first liquid storage tank 44. In other words, the second end of the liquid supply member 50 corresponds to a liquid immersion portion 502 that draws up the liquid and supplies the liquid to the liquid application member 501. The liquid application member 501 and the liquid supply member 50 are made of a material (e.g., sponge or fiber) having a high liquid absorption rate, such as an elastic resin formed of open cells. However, at least one of the liquid application member 501 or the liquid supply member 50 is not limited to a particular type as long as the at least one of the liquid application member 501 or the liquid supply member 50 is made of a material having properties of absorbing and holding the liquid and has a property of being crushable in accordance with a pressing force applied when the at least one of the liquid application member 501 or the liquid supply member 50 is in contact with the sheet P. In other words, the material may be any material as long as the material can absorb or draw up liquid by capillary action.

Accordingly, when the other end portion (the liquid immersion portion 502) of the liquid supply member 50 is immersed in the liquid stored in the first liquid storage tank 44, the liquid supply member 50 sucks up the liquid by capillary action. In other words, the liquid stored in the first liquid storage tank 44 is drawn up from the liquid immersion portion 502 of the liquid supply member 50, and the drawn up liquid is supplied to the liquid application member 501 that is coupled to the tip portion via the liquid supply member 50. Then, the liquid stored in the first liquid storage tank 44 is drawn up to the liquid application member 501 in close contact with one end portion of the liquid supply member 50, and thus the liquid level (stored liquid amount) of the liquid stored in the first liquid storage tank 44 detected by the first liquid level sensor 43 is lowered. As a result, the liquid is supplied from the second liquid storage tank 47 to the first liquid storage tank 44 by the liquid supply pump 46.

Although the case where the liquid supply member 50 and the liquid application member 501 are separate bodies has been described above, the liquid supply member 50 and the liquid application member 501 may be integrally formed of a material having the same properties (for example, a material having a high liquid absorption rate). In other words, the liquid application member 501 may be part of the liquid supply member 50. In such a case, liquid can be supplied from the liquid supply member 50 to the liquid application member 501 more smoothly by the capillary action and a reduction in cost can be achieved.

At this time, the liquid application member 501 draws up the liquid stored in the first liquid storage tank 44. By so doing, the amount of liquid (liquid level) in the first liquid storage tank 44 temporarily decreases to the level below the reference liquid level described below. In response to this decrease of liquid in the first liquid storage tank 44, a series of liquid supply operations for feeding liquid from the second liquid storage tank 47 to the first liquid storage tank 44 is performed. This series of liquid supply operations is mainly performed at the time of activation of the post-processing apparatus 3 or at the time of start of execution of the binding processing involving liquid application in the post-processing apparatus 3, and corresponds to the liquid supply operations for bringing the liquid application using the liquid application member 501 to be executable.

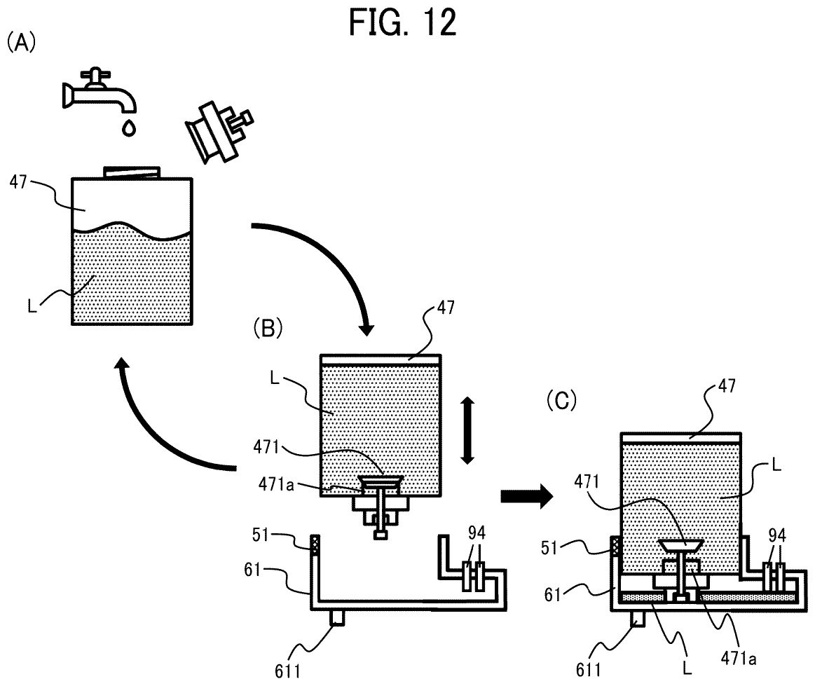

The edge binder 25 or the post-processing apparatus 3 is provided with the second liquid storage tank 47. The second liquid storage tank 47 is detachably attached to the second liquid storage tank fixer 61 (a part of the second liquid storage unit) disposed in the edge binder 25 or the post-processing apparatus 3 (see FIG. 12 including FIGS. 12(A), 12(B) and 12(C)).

The second liquid storage tank 47 is fixed (set) to the second liquid storage tank fixer 61 (a part of the second liquid storage unit) at a given position. By so doing, the liquid already stored in the second liquid storage tank 47 can be supplied to the first liquid storage tank 44.

The operation to supply liquid from the second liquid storage tank 47 to the first liquid storage tank 44 by the liquid supply pump 46 is executed in response to a decrease in the stored liquid amount (liquid level) in the first liquid storage tank 44. The stored liquid amount (liquid level) of the first liquid storage tank 44 is reduced by the liquid being consumed by liquid application by the liquid applier 31. In other words, the operation to supply liquid from the second liquid storage tank 47 to the first liquid storage tank 44 corresponds to the liquid supply operation in accordance with the execution of the job including liquid application by the liquid applier 31.

This liquid supplying operation corresponds to an operation of supplying liquid to the first liquid storage tank 44 so as to replenish liquid each time the stored liquid amount (liquid level) of the first liquid storage tank 44 falls below a reference liquid level, which is described below.

When the second liquid storage tank 47 is set in the second liquid storage tank fixer 61, the second liquid storage tank fixer 61 is filled with a certain amount of the liquid in the second liquid storage tank 47. The second liquid storage tank fixer 61 includes a setting detection sensor 51 (serving as a set detector) (see FIG. 12(B)). When the setting detection sensor 51 detects the set state of the second liquid storage tank 47 to the second liquid storage tank fixer 61 (see FIG. 12(C)), a signal indicating the set state is transmitted to the controller 100b, which is described below. Thus, the controller 100b to be described below detects whether or not the second liquid storage tank 47 is mounted on the second liquid storage tank fixer 61. Details of the second liquid storage tank 47 will be described below.

The first liquid storage tank 44 and the second liquid storage tank 47 are coupled to each other by the liquid supply path 45. The liquid supply pump 46 is disposed near the second liquid storage tank fixer 61. As the liquid supply pump 46 is driven, the liquid stored in the second liquid storage tank 47 is supplied (replenished) from the second liquid storage tank 47 to the first liquid storage tank 44 via the liquid supply path 45. Accordingly, the second liquid storage tank fixer 61 is a component of the liquid supplier that executes a liquid supply operation to supply liquid from the second liquid storage tank 47 to the first liquid storage tank 44. The liquid supply path 45 includes a flexible material. According to such a configuration, even if the first liquid storage tank 44 is moved by the liquid applier movement assembly 35, liquid can be supplied from the second liquid storage tank 47 to the first liquid storage tank 44.

The supply of liquid from the second liquid storage tank 47 to the first liquid storage tank 44 can be controlled in accordance with the detection result of the first liquid level sensor 43. In other words, the controller 100b, which is described below, determines whether the stored liquid amount (liquid level) in the first liquid storage tank 44 based on the detection result of the first liquid level sensor 43. In accordance with the determined stored liquid amount (liquid level) of the first liquid storage tank 44, the controller 100b controls the operation speed and time of the liquid supply pump 46. By so doing, the controller 100b can adjust the amount of liquid to be replenished to the first liquid storage tank 44 to maintain the stored liquid amount (liquid level) in the first liquid storage tank 44 at a constant level of liquid.

### Configuration of Crimper

As illustrated in FIG. 3, the crimper 32 as a post-processing device presses and deforms at least a portion (liquid application position) of the sheet bundle Pb, to which liquid has been applied by the liquid applier 31, by serrated upper crimping teeth 32a and lower crimping teeth 32b, and crimps the sheets P of the portion to bind the sheet bundle Pb. In other words, the crimper 32 can bind the sheet bundle Pb without staples. The components of the crimper 32 such as the upper crimping teeth 32a and the lower crimping teeth 32b are disposed on a crimping frame 32c. In the following description, such a way of pressing and deforming a given position on the sheet bundle Pb to bind the sheet bundle Pb may be referred to as “crimp binding”. In other words, the crimper 32 crimps and binds the sheet bundle Pb or performs the crimp binding on the sheet bundle Pb. The crimping and binding operation of the crimper 32 that involves control processing is referred to as “crimp binding process”.

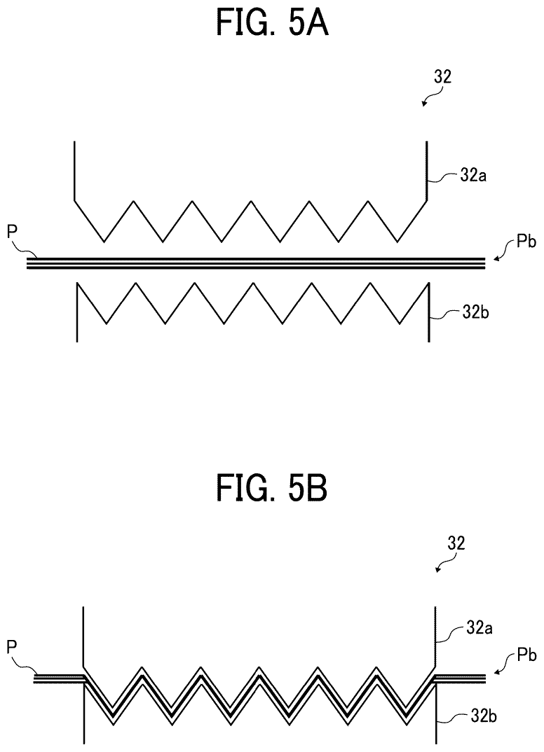

FIGS. 5A and 5B are schematic views illustrating the configuration of the crimper 32.

As illustrated in FIGS. 5A and 5B, the crimper 32 includes the upper crimping teeth 32a and the lower crimping teeth 32b. The upper crimping teeth 32a and the lower crimping teeth 32b are disposed to face each other in the thickness direction of the sheet bundle Pb to sandwich the sheet bundle Pb placed on the internal tray 22. The upper crimping teeth 32a and the lower crimping teeth 32b have respective serrate faces facing each other. The serrate face of each of the upper crimping teeth 32a and the lower crimping teeth 32b includes concave portions and convex portions alternately formed. The concave portions and the convex portions of the upper crimping teeth 32a are shifted from those of the lower crimping teeth 32b such that the upper crimping teeth 32a are engaged with the lower crimping teeth 32b. The upper crimping teeth 32a and the lower crimping teeth 32b are brought into contact with and separated from each other by the driving force of a contact-separation motor 32d illustrated in FIG. 13.

In the process of supplying the plurality of sheets P of the sheet bundle Pb to the internal tray 22, the upper crimping teeth 32a and the lower crimping teeth 32b are separated from each other as illustrated in FIG. 5A. When all the sheets P of the sheet bundle Pb are placed on the internal tray 22, the upper crimping teeth 32a and the lower crimping teeth 32b are engaged with each other as illustrated in FIG. 5B by the driving force of the contact-separation motor 32d to press and deform the sheet bundle Pb in the thickness direction. Thus, the sheet bundle Pb that has been placed on the internal tray 22 is crimped and bound. The sheet bundle Pb thus crimped and bound is ejected to the second ejection tray 26 by the conveyance roller pair 15.

The configuration of the crimper 32 as a crimping assembly is not limited to the configuration of a moving assembly exemplified in the present embodiment, and may be any other suitable structure in which the upper crimping teeth 32a and the lower crimping teeth 32b of the crimping assembly engage with each other. For example, the crimping assembly may bring the upper crimping teeth 32a and the lower crimping teeth 32b into contact with each other and separate the upper crimping teeth 32a and the lower crimping teeth 32b from each other with a link mechanism and a driving source that simply rotates in the forward direction or that rotates the forward and backward directions (e.g., the crimping assembly disclosed in Japanese Patent No. 6057167). Alternatively, the crimping assembly may employ a linear motion system to linearly bring the upper crimping teeth 32a and the lower crimping teeth 32b into contact with each other and separate the upper crimping teeth 32a and the lower crimping teeth 32b from each other with a screw assembly that converts the forward and backward rotational motions of a driving source into linear reciprocating motion.

As illustrated in FIG. 3, the edge binder 25 includes an edge binder movement assembly 57.

The edge binder movement assembly 57 moves the edge binder 25 (in other words, the liquid applier 31 and the crimper 32) in the main scanning direction along the downstream end of the sheet P, which is placed on the internal tray 22, in the conveyance direction. The edge binder movement assembly 57 includes, for example, the base 48, a guide shaft 49, the edge binder movement motor 55, and a driving force transmission assembly 551 that transmits the driving force of the edge binder movement motor 55 to the base 48, and a standby position sensor 540 (see FIG. 13).

The liquid applier 31 and the crimper 32 are attached to the base 48 with the liquid applier 31 and the crimper 32 being adjacent to each other in the main scanning direction. As illustrated in FIG. 4, the guide shaft 49 is held by multiple guide shaft brackets 49a disposed in the main scanning direction at a position on the upstream side of a binding assembly base 116 in the conveyance direction. As illustrated in FIG. 3, the guide shaft 49 extends in the main scanning direction on the binding assembly base 116. The guide rail 115 is disposed in the main scanning direction on the downstream side of the binding assembly base 116 in the conveyance direction. As illustrated in FIG. 4, the guide rail 115 includes a fitting target portion 115a that fits to a fitting portion 48a of the base 48 in the main scanning direction. In other words, the base 48 is movably held by the guide shaft 49 and the guide rail 115 in the main scanning direction on the binding assembly base 116.

The edge binder movement motor 55 generates a driving force to move the edge binder 25. The driving force transmission assembly 551 transmits the driving force of the edge binder movement motor 55 to the base 48 via pulleys 551a and 551b, a timing belt 551c, and a fastening portion 48b that fastens the base 48 and the timing belt 551c. Thus, the liquid applier 31 and the crimper 32 integrated by the base 48 move in the main scanning direction along the guide shaft 49.

The edge binder movement motor 55 according to the present embodiment is, for example, a servo motor that can stop the edge binder 25 at a target position (for example, a first binding position B1 described below) without returning the edge binder 25 to an origin position (for example, a standby position HP described below) every time the edge binder 25 is moved.

The post-processing apparatus 3 further includes a standby position sensor 540 (for example, a light shielding optical sensor, see FIG. 13) that detects that the edge binder 25 has reached the standby position HP (see FIG. 12(A)), and an encoder sensor 541 (see FIG. 13) attached to an output shaft of the edge binder movement motor 55. The controller 100b, which will be described below, detects that the edge binder 25 has reached the standby position HP, based on a detection result of the standby position sensor 540. The controller 100b to be described later also counts pulse signals output from the encoder sensor 541 to ascertain the current position of the edge binder 25 moved from the standby position HP.

However, a specific method of stopping the edge binder 25 at the target position without returning the edge binder 25 to the standby position HP is not limited to the aforementioned example. As another example, the post-processing apparatus 3 may include a sensor that detects that the edge binder 25 has reached a predetermined target position.

As illustrated in FIG. 3, a crimper shaft 54 provided with a drive transmission gear 54a is fixed to a bottom face of the crimping frame 32c that holds the components of the crimper 32. The crimper shaft 54 and the drive transmission gear 54a are held by the base 48 on which the crimping frame 32c is disposed, so as to be rotatable in the forward and reverse directions. The drive transmission gear 54a meshes with an output gear 56a of a crimper pivot motor 56. The crimper 32 can be rotated in the forward and reverse directions about the crimper shaft 54 on the base 48 by a driving force transmitted from the crimper pivot motor 56 to the crimper shaft 54 via the output gear 56a and the drive transmission gear 54a.

In the above description, the edge binder 25 has a configuration of moving along the guide shaft 49 with the crimper 32 and the liquid applier 31 being integrated, the embodiments of the present disclosure are not limited to the above-described configuration. For example, the crimper 32 and the liquid applier 31 may have a configuration of moving separately from each other.

### Modification of Edge Binder

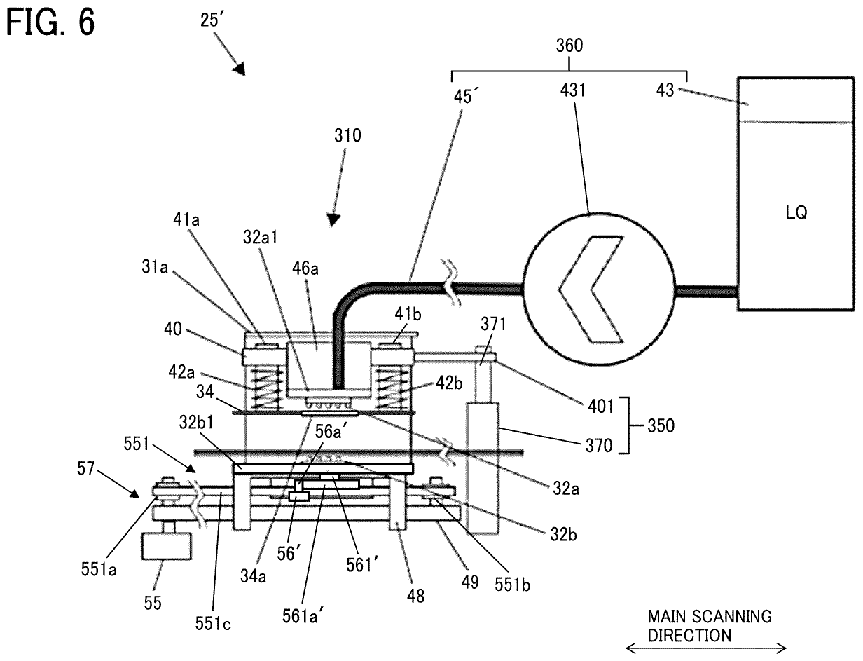

Specifically, referring now to FIGS. 6 to 8C, a description is given of an edge binder 25′ as a post-processing device and as a modification of the edge binder 25 included in the post-processing apparatus 3. A difference of the edge binder 25′ from the edge binder 25 according to the first embodiment is that the liquid applier 31 and the crimper 32 are integrated as a single unit. In the following description, components like those of the edge binder 25 described above are denoted by like reference numerals, and redundant descriptions thereof may be omitted unless otherwise required.

FIG. 6 is a schematic diagram illustrating the edge binder 25′, viewed from the upstream side of the edge binder 25′ in the conveyance direction.

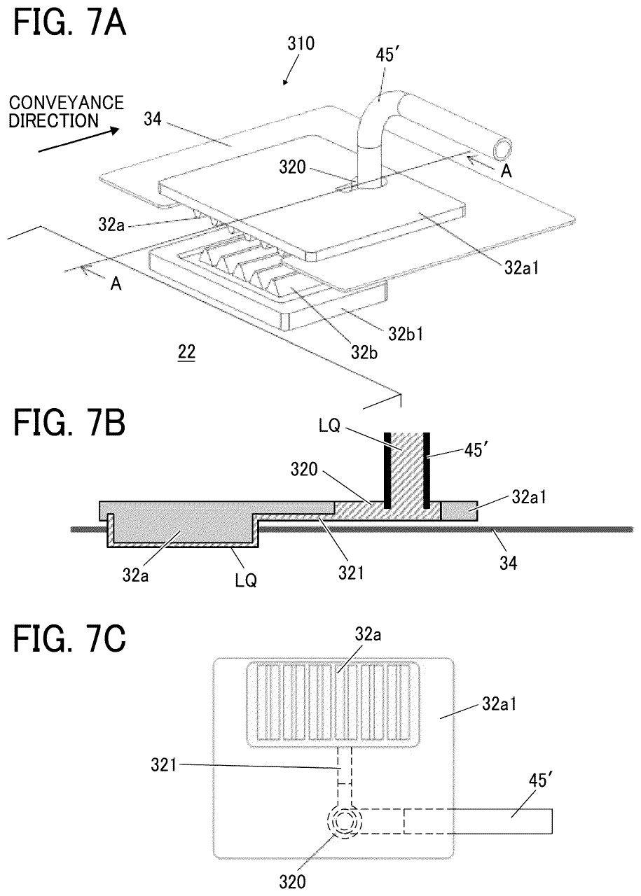

FIG. 7A is a perspective view of a liquid application crimper 310.

FIG. 7B is a cross-sectional view of the liquid application crimper 310 taken along line A-A in FIG. 7A.

FIG. 7C is a plan view of the upper crimping teeth 32a of FIG. 7A as viewed from the side at which the lower crimping teeth 32b is disposed.

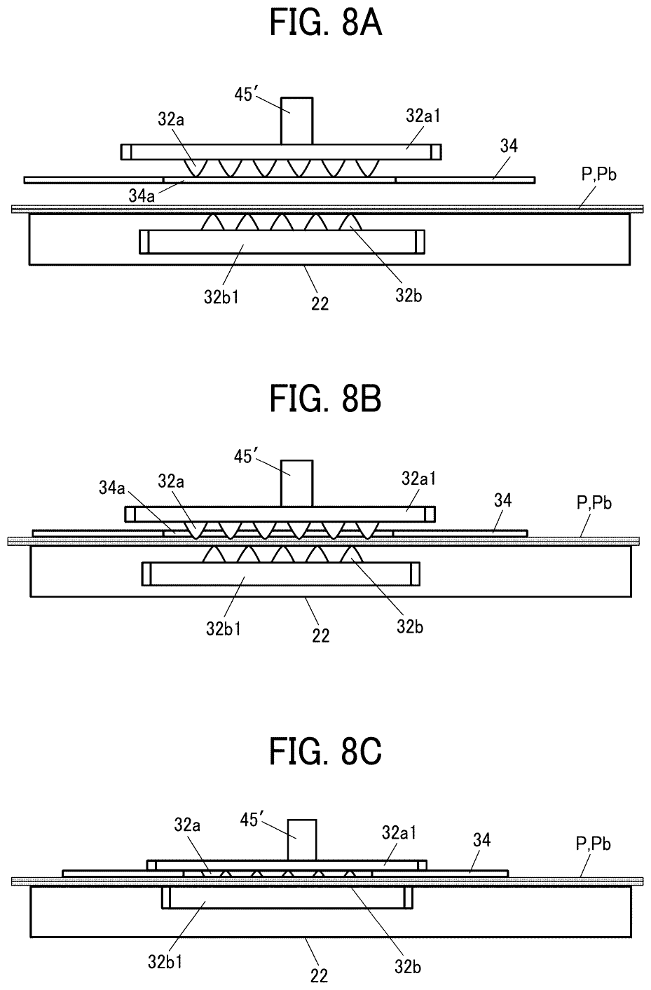

FIGS. 8A to 8C are diagrams illustrating the liquid application crimper 310 performing a liquid application operation and a crimp binding operation viewed from the downstream side in the conveyance direction.

As illustrated in FIG. 6, the edge binder 25′ includes the liquid application crimper 310 in which the liquid applier 31 and the crimper 32 (serving as a post-processing device) of the edge binder 25 according to the first embodiment are integrated as a single unit. The liquid application crimper 310 is disposed downstream from the internal tray 22 in the conveyance direction.

The liquid application crimper 310 applies liquid LQ stored in the first liquid storage tank 44 to the sheet P or the sheet bundle Pb placed on the internal tray 22. The liquid application crimper 310 can be moved in the main scanning direction by the driving force that is transmitted from the edge binder movement motor 55 to the base 48 by the driving force transmission assembly 551. The liquid application crimper 310 includes the upper pressure plate 34, the upper crimping teeth 32a, the lower crimping teeth 32b, a liquid application crimper movement assembly 350, and a liquid supply assembly 360. The components of the liquid application crimper 310 are held by the liquid application frame 31a and the base 48.

A liquid application crimper shaft 561′ provided with a drive transmission gear 561a′ is fixed to a bottom face of the liquid application frame 31a. The liquid application crimper shaft 561′ and the drive transmission gear 561a′ are held by the base 48 on which the liquid application frame 31a is disposed, so as to be rotatable in the forward and reverse directions. The drive transmission gear 561a′ meshes with an output gear 56a′ of a crimper pivot motor 56′. The liquid application crimper 310 can be rotated in the forward and reverse directions about the liquid application crimper shaft 561′ on the base 48 by a driving force transmitted from the crimper pivot motor 56′ to the liquid application crimper shaft 561′ via the output gear 56a′ and the drive transmission gear 561a′.

The liquid application crimper movement assembly 350 moves the upper pressure plate 34, the base plate 40, and the upper crimping teeth 32a in cooperation with each other in the thickness direction of the sheet P or the sheet bundle Pb by an electric cylinder 370. The base plate 40 holds an upper crimping teeth holder 32a1 and the upper crimping teeth 32a via a holder 46a. The base plate 40 movably holds the upper pressure plate 34 via the columns 41a and 41b. The base plate 40 is attached to the leading end of the rod 371 of the electric cylinder 370 via the connecter 401.

The columns 41a and 41b have respective lower ends holding the upper pressure plate 34. The coil springs 42a and 42b are externally inserted into the columns 41a and 41b between the base plate 40 and the upper pressure plate 34. The coil springs 42a and 42b bias the upper pressure plate 34 and the columns 41a and 41b in a direction away from the base plate 40.

The liquid supply assembly 360 includes the first liquid storage tank 44, a liquid supply pump 431, and the liquid supply member 45′. The liquid supply pump 431 supplies the liquid LQ via the liquid supply member 45′ to a liquid reservoir 320 of the upper crimping teeth holder 32a1 as illustrated in FIG. 7A. The liquid supply member 45′ is an elastic elongated member having a base end (proximal end) coupled to the liquid supply pump 431 and a distal end coupled to the liquid reservoir 320.

As illustrated in FIG. 7B, the upper crimping teeth 32a are integrated with the upper crimping teeth holder 32a1. The upper crimping teeth holder 32a1 includes the liquid reservoir 320 and a liquid supply path 321, and the liquid LQ stored in the liquid reservoir 320 is supplied to the upper crimping teeth 32a through the liquid supply path 321. The surface of the upper crimping teeth 32a is subjected to a hydrophilic treatment so that the liquid LQ that is supplied through the liquid supply path 321 uniformly spreads over the surface of the upper crimping teeth 32a. On the other hand, the portion of the upper crimping teeth holder 32a1 other than the upper crimping teeth 32a is subjected to a hydrophobic treatment so that the liquid LQ efficiently spreads over the surface of the upper crimping teeth 32a.

As illustrated in FIG. 6, the lower crimping teeth 32b are integrated with a lower crimping teeth holder 32b1, which is a part of the liquid application frame 31a. The lower crimping teeth 32b are attached to the base 48 via the lower crimping teeth holder 32b1.

Referring now to FIGS. 8A to 8C, a description is given of the liquid application operation and the crimp binding operation by the liquid application crimper 310. In the process of supplying the sheet P to the internal tray 22, as illustrated in FIG. 8A, the upper crimping teeth 32a and the lower crimping teeth 32b are separated from each other. When the sheet P is placed on the internal tray 22, the electric cylinder 370 is contracted to move the upper crimping teeth 32a and the upper pressure plate 34 toward the sheet P. Then, as illustrated in FIG. 8B, the upper pressure plate 34 first contacts the sheet P, and then the upper crimping teeth 32a pass through the through hole 34a of the upper pressure plate 34 and contacts the sheet P. At this time, since the liquid LQ has spread over the surface of the upper crimping teeth 32a, the liquid is applied from the upper crimping teeth 32a in contact with the sheet P to the liquid application position on the sheet P. When liquid application to the liquid application position is completed, the electric cylinder 370 is extended to separate the upper crimping teeth 32a and the upper pressure plate 34 from the sheet P. The above-described contact and separation operation (liquid application operation) of the upper crimping teeth 32a and the upper pressure plate 34 with respect to the sheets P is repeatedly performed on sheets P of the sheet bundle Pb.

When the sheet bundle Pb including a given number of sheets P is stacked on the internal tray 22, the electric cylinder 370 is further contracted to move the upper crimping teeth 32a toward the lower crimping teeth 32b. As illustrated in FIG. 8C, the upper crimping teeth 32a further moves toward the lower crimping teeth 32b with the sheet bundle Pb sandwiched between the upper crimping teeth 32a and the lower crimping teeth 32b. Thus, the upper crimping teeth 32a and the lower crimping teeth 32b press and deform the sheet bundle Pb to crimp and bind the sheet bundle Pb. In short, the crimp binding operation is performed.

### Configuration of Staple Binder

Specifically, a detailed description is now given of the staple binder 155 having a function of executing a stapling process.

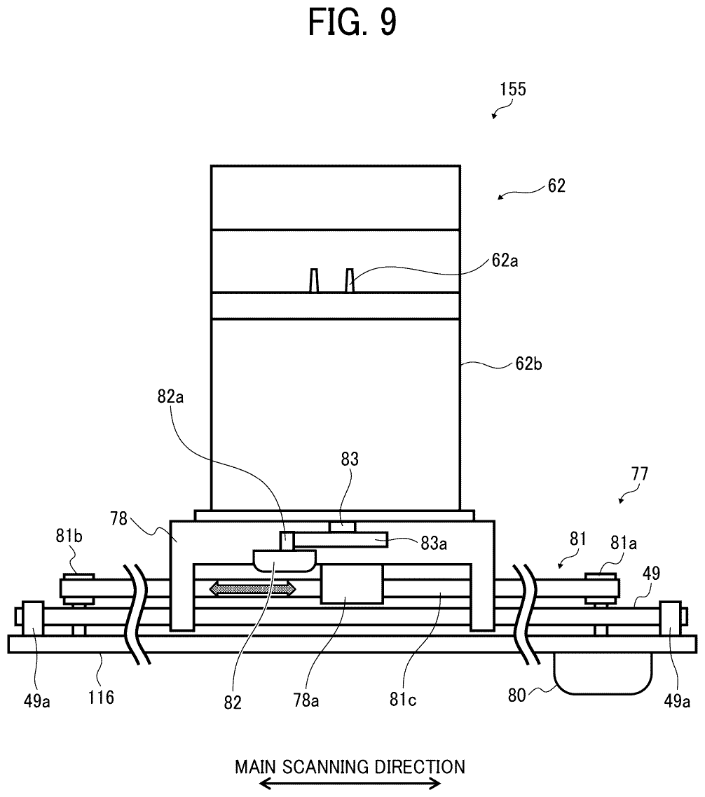

FIG. 9 is a schematic view of an upstream side of the staple binder 155 in the conveyance direction.

The staple binder 155 includes a stapler 62 that binds the sheet bundle Pb with staples. The stapler 62 is disposed downstream from the internal tray 22 in the conveyance direction and spaced apart from the edge binder 25 in the main scanning direction.

The stapler 62 serving as a medium processing unit has a configuration of performing so-called “stapling” (i.e., stapling process) to bind a sheet bundle Pb with a staple or staples. More particularly, the stapler 62 includes a stapling-part drive motor 62d illustrated in FIG. 13. The stapling-part drive motor 62d drives a stapling part 62a. The driving force of the stapling-part drive motor 62d causes a staple loaded in the stapling part 62a to penetrate through a sheet bundle Pb, so that the stapling part 62a binds the sheet bundle Pb. Since the stapler 62 has a typical configuration, a detailed description thereof will be omitted unless otherwise required.

As illustrated in FIG. 9, the staple binder 155 includes a staple binder movement assembly 77. The staple binder movement assembly 77 moves the staple binder 155 in the main scanning direction along a downstream end in the conveyance direction of the sheet P or the sheet bundle Pb placed on the internal tray 22. The staple binder movement assembly 77 includes, for example, a base 78, the guide shaft 49, a staple binder movement motor 80, and a driving force transmission assembly 81. The driving force transmission assembly 81 transmits a driving force of the staple binder movement motor 80 to the base 78 via pulleys 81a and 81b, a timing belt 81c, and a fastening portion 78a that fastens the base 78 and the timing belt 81c. A stapler shaft 83 including a drive transmission gear 83a is fixed to a bottom face of a stapling frame 62b that holds the components of the stapler 62.

The stapler shaft 83 and the drive transmission gear 83a are held by the base 78 on which the stapling frame 62b is disposed, so as to be rotatable in the forward and reverse directions. The drive transmission gear 83a meshes with an output gear 82a of a stapler pivot motor 82. The stapler 62 is rotatable in the forward and reverse directions about the stapler shaft 83 on the base 78 by a driving force transmitted from the stapler pivot motor 82 to the stapler shaft 83 via the output gear 82a and the drive transmission gear 83a.

The edge binder 25 and the staple binder 155 are supported by the common guide shaft 49. In other words, the edge binder movement assembly 57 and the staple binder movement assembly 77 move the edge binder 25 and the staple binder 155 in the main scanning direction along the common guide shaft 49. The edge binder movement assembly 57 and the staple binder movement assembly 77 can independently move the edge binder 25 and the staple binder 155.

### Configuration of Modification of Staple Binder

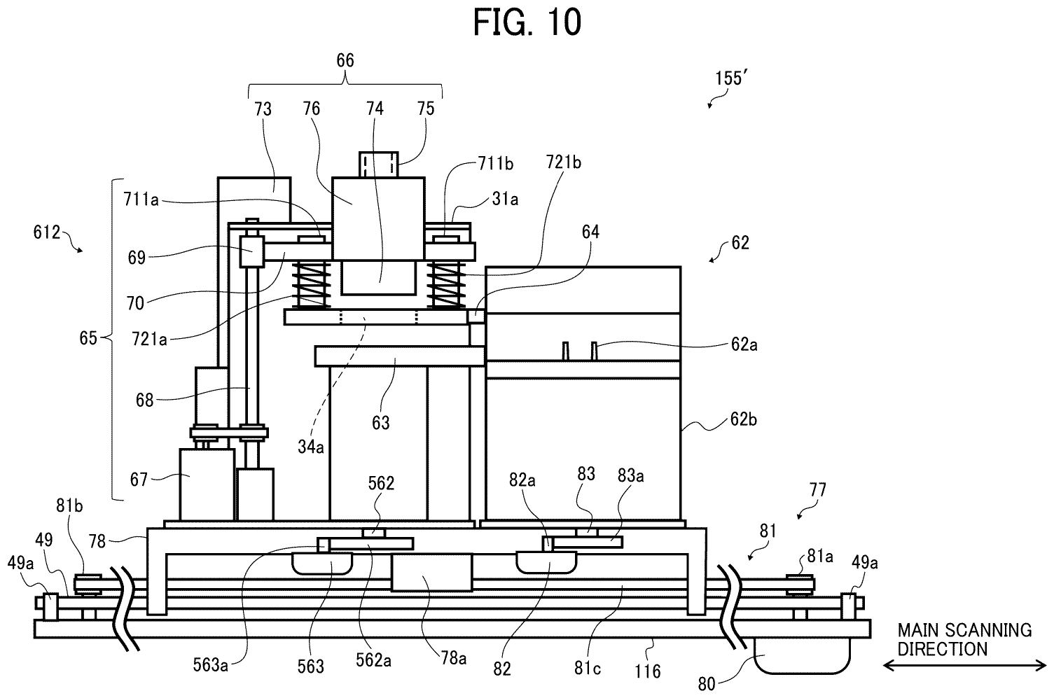

FIG. 10 illustrates a staple binder 155′ as a modification of the staple binder 155, and is a schematic diagram of the staple binder 155′ as viewed from the upstream side in the conveyance direction.

The staple binder 155′ is different from the staple binder 155 in that the staple binder 155′ includes a second liquid applier 612 in addition to the stapler 62. As illustrated in FIG. 10, the staple binder 155′ includes the second liquid applier 612 and the stapler 62. The second liquid applier 612 and the stapler 62 are disposed downstream from the internal tray 22 in the conveyance direction of the sheet P and adjacent to each other in the main scanning direction.

The second liquid applier 612 executes liquid application of applying liquid stored in a third liquid storage tank 73 to the sheet P or the sheet bundle Pb placed on the internal tray 22. A given area including a position to which the liquid is applied on the sheet P or the sheet bundle Pb by the second liquid applier 612 corresponds to a binding position to be stapled by the stapler 62. As illustrated in FIG. 10, the second liquid applier 612 includes a second lower pressure plate 63, a second upper pressure plate 64, a second liquid applier movement assembly 65, and a second liquid application assembly 66. The second liquid applier movement assembly 65 includes, for example, a second liquid applier movement motor 67, a second trapezoidal screw 68, a second nut 69, a second base plate 70, second columns 711a and 711b, and second coil springs 721a and 721b.

The second liquid application assembly 66 includes the third liquid storage tank 73, a second liquid supply portion 75, a second liquid application member 74, and a second joint 76. Since the second liquid application assembly 66 and the liquid application assembly of the liquid applier 31 (including the first liquid storage tank 44, the liquid supply member 50, the liquid application member 501, and the holder 37) illustrated in FIGS. 3 and 4 have common configurations, redundant descriptions thereof will be omitted unless otherwise required. Since the stapler 62 has a configuration similar to the configuration of the staple binder 155 illustrated in FIG. 9, a detailed description thereof is omitted below unless otherwise required. Since the second liquid applier 612 and the liquid applier 31 that are illustrated in FIG. 3 have common pivot mechanisms, redundant descriptions thereof will be omitted unless otherwise required. The pivot mechanism of the second liquid applier 612 includes the liquid applier pivot motor 563, the output gear 563a, the drive transmission gear 562a, and the liquid applier shaft 562.

As in the staple binder 155′ illustrated in FIG. 10, in the stapling process, the binding position is loosened and softened by applying liquid to the sheet P, and the binding needle can easily penetrate the sheet P. Thus, the number of sheets to be bound per sheet bundle Pb can be increased as compared with a case where the stapling process is performed without applying the liquid.

### Configuration of Second Liquid Storage Tank

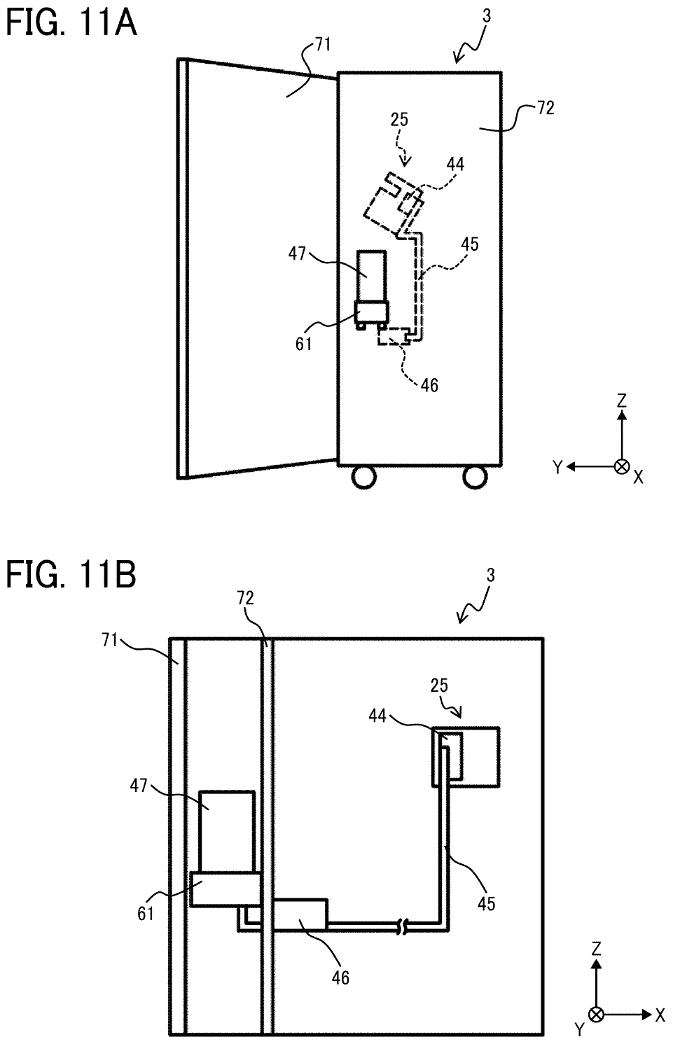

Referring now to FIGS. 11A, 11B and 12 (including FIGS. 12(A), 12(B) and 12(C)), a description is given of the arrangement and configuration of the second liquid storage tank 47 in the post-processing apparatus 3.

FIGS. 11A and 11B illustrate example arrangement and configuration of the second liquid storage tank 47 as the main tank.

FIG. 11A illustrates the post-processing apparatus 3 with a cover 71 opened.

FIG. 11B is a cross-sectional side view of the post-processing apparatus 3, illustrating the post-processing apparatus 3 with the cover 71 closed.

As illustrated in FIG. 11A, the second liquid storage tank 47 is located so as to be accessible when the cover 71 of the post-processing apparatus 3 is opened. As illustrated in FIG. 11B, the second liquid storage tank 47 and the second liquid storage tank fixer 61 are disposed on the near side in a depth direction (X direction) of the post-processing apparatus 3. The first liquid storage tank 44 is disposed on the far side in the depth direction (X direction) of the post-processing apparatus 3. A main body side plate 72 of the post-processing apparatus 3 is disposed between the arrangement position of the second liquid storage tank 47 and the second liquid storage tank fixer 61 and the arrangement position of the first liquid storage tank 44. The second liquid storage tank fixer 61 is attached to the main body side plate 72 of the post-processing apparatus 3.

FIG. 12 including FIGS. 12(A), 12(B) and 12(C) illustrates the second liquid storage tank 47 attachable to and detachable from the second liquid storage tank fixer 61 and a state where liquid is replenished to the second liquid storage tank 47.

As illustrated in FIG. 12 including FIGS. 12(A), 12(B) and 12(C), the second liquid storage tank 47 is attachable to and detachable from the second liquid storage tank fixer 61 so as to replenish the first liquid storage tank with liquid. As illustrated in FIG. 12(B), the second liquid storage tank fixer 61 is provided with the setting detection sensor 51 (set detector) serving as a setting detector that detects that the second liquid storage tank 47 is set in the second liquid storage tank fixer 61.

When the setting detection sensor 51 detects the set state of the second liquid storage tank 47 to the second liquid storage tank fixer 61 (see FIG. 12(C)), a signal indicating the set state is transmitted to the controller 100b, which is described below. Thus, the controller 100b to be described below detects whether or not the second liquid storage tank 47 is mounted on the second liquid storage tank fixer 61.

The second liquid level sensor 94 (serving as second liquid detector) that detects the amount of liquid L to be stored in the second liquid storage tank 47 is disposed in the second liquid storage tank fixer 61. The output value (voltage) of the second liquid level sensor 94 is transmitted to the controller 100b to be described later. The controller 100b to be described later determines the output value (voltage) of the second liquid level sensor 94 to determine whether the amount of liquid stored in the second liquid storage tank fixer 61 is a required amount of liquid. When the controller 100b to be described later determines that the second liquid storage tank 47 is in the mount state based on the output signal of the setting detection sensor 51, the controller 100b turns on the second liquid level sensor 94 so that the presence of liquid (liquid level) in the second liquid storage tank fixer 61 can be detected.

When the second liquid storage tank 47 is not mounted on the second liquid storage tank fixer 61 (i.e., is in a non-set state), a liquid discharge port 471a of the second liquid storage tank 47 is closed by a liquid supply valve 471 so that liquid L does not leak. As illustrated in FIG. 12(C), when the second liquid storage tank 47 is mounted on the second liquid storage tank fixer 61, the liquid supply valve 471 is pushed up to open the liquid discharge port 471a of the second liquid storage tank 47. By so doing, the liquid Lis flow out from the second liquid storage tank 47 to the second liquid storage tank fixer 61. As a result, the liquid L stored in the second liquid storage tank 47 flows out to the second liquid storage tank fixer 61. The liquid L flowing out of the second liquid storage tank 47 is stored in the second liquid storage tank fixer 61.

As a measurement to prevent liquid L from being frozen during maintenance of the post-processing apparatus 3, a liquid draining process may be performed to drain the liquid L in the post-processing apparatus 3. In the liquid draining process, the liquid L remaining in the first liquid storage tank 44 and the liquid supply path 45 is supplied by the liquid supply pump 46 to the second liquid storage tank fixer 61 via the liquid supply path 45 in the reverse direction. In order to deal with such a situation, the second liquid storage tank fixer 61 is set to the amount to sufficiently store liquid in the first liquid storage tank 44 and the liquid supply path 45. As illustrated in FIG. 12(B) and FIG. 12(C), the second liquid storage tank fixer 61 is provided with a liquid drain plug 611. After the liquid L remaining in the first liquid storage tank 44 and the liquid supply path 45 is reversely fed by the liquid supply pump 46 to the second liquid storage tank fixer 61, the liquid drain plug 611 is opened to discharge the liquid L stored in the second liquid storage tank fixer 61 from the inside of the post-processing apparatus 3.

### Configuration of Control Block of Post-Processing Apparatus

A description is given below of a configuration of a control block of the post-processing apparatus 3, with reference to FIG. 13.

FIG. 13 is a block diagram illustrating a hardware configuration for executing control processing in the post-processing apparatus 3.

As illustrated in FIG. 13, the post-processing apparatus 3 includes a central processing unit (CPU) 101, a random access memory (RAM) 102, a read-only memory (ROM) 103, a hard disk drive (HDD) 104, and an interface (I/F) 105. The CPU 101, the RAM 102, the ROM 103, the HDD 104, and the I/F 105 are connected to each other via a common bus 109.

The CPU 101 is an arithmetic unit and controls the overall operation of the post-processing apparatus 3.

The RAM 102 is a volatile storage medium that allows data to be read and written at high speed. The CPU 101 uses the RAM 102 as a working area for data processing.

The ROM 103 is a read-only non-volatile storage medium that stores programs such as firmware.

The HDD 104 is a non-volatile storage medium that allows data to be read and written and has a relatively large storage capacity. The HDD 104 stores, for example, an operating system (OS), various control programs, and application programs.

By an arithmetic function of the CPU 101, the post-processing apparatus 3 processes, for example, a control program stored in the ROM 103 and an information processing program (application program) loaded into the RAM 102 from a storage medium such as the HDD 104. Such processing configures a software controller including various functional modules of the post-processing apparatus 3. The software controller thus configured cooperates with hardware resources of the post-processing apparatus 3 to construct functional blocks that implement functions of the post-processing apparatus 3. In other words, the CPU 101, the RAM 102, the ROM 103, the HDD 104, and the I/F 105 constitute at least part of a controller 100b (control unit) serving as a control device that controls the operation of the post-processing apparatus 3.

The I/F 105 is an interface that connects the conveyance roller pairs 10, 11, 14, and 15, the switching member 20, the side fences 24L and 24R, the contact-separation motor 32d, the crimper pivot motor 56, the liquid applier movement motor 42, the liquid applier pivot motor 563, the edge binder movement motor 55, the stapling-part drive motor 62d, the stapler pivot motor 82, the staple binder movement motor 80, the liquid supply pump 46, the position detection sensor 40a, the first liquid level sensor 43, the second liquid level sensor 94, the setting detection sensor 51, the standby position sensor 540, the encoder sensor 541, and a control panel 110 to the common bus 109.

The controller 100b controls, via the I/F 105, the operations of the conveyance roller pairs 10, 11, 14, and 15, the switching member 20, the side fences 24L and 24R, the contact-separation motor 32d, the crimper pivot motor 56, the liquid applier movement motor 42, the liquid applier pivot motor 563, the edge binder movement motor 55, the stapling-part drive motor 62d, the stapler pivot motor 82, the staple binder movement motor 80, and the liquid supply pump 46. The controller 100b acquires detection results from the position detection sensor 40a, the first liquid level sensor 43, the second liquid level sensor 94, the setting detection sensor 51, the standby position sensor 540, and the encoder sensor 541. Although FIG. 13 illustrates only the components related to the edge binder 25 and the staple binder 155 that perform the edge binding, the components related to the saddle binder 28 that performs the saddle binding process are also controlled by the controller 100b.

As illustrated in FIG. 1, the image forming apparatus 2 includes the control panel 110. The control panel 110 includes an operation unit that receives instructions input by a user and a display serving as a notifier that notifies the operator of information. The operation unit includes, for example, physical input buttons and a touch screen overlaid on a display. The control panel 110 acquires information from the user through the operation unit and provides the information to the user through the display. A specific example of the notification unit is not limited to the display and may be a light emitting diode (LED) lamp or a speaker. The post-processing apparatus 3 may include a control panel 110 similar to the above-described control panel 110 of the image forming apparatus 2.

As described above, the post-processing apparatus 3 implements the function of performing operation control related to the liquid application by software (control programs) executed by the CPU 101 with hardware resources included in the controller 100b.

In some embodiments, the liquid application performed by the post-processing apparatus 3 may be performed in a form in which the staple binder 155 is provided with only the stapler 62 and the liquid application is performed using the liquid applier 31 of the edge binder 25. Conversely, the edge binder 25 may include only the crimper 32, and the liquid application may be performed in a mode in which the second liquid applier 612 is used. In other words, the post-processing apparatus 3 may have a configuration in which only one of the liquid applier 31 and the second liquid applier 612 performs the liquid application, regardless of the type of the binding process.

In the above description, the staple binder 155′ has a configuration of moving along the guide shaft 49 with the stapler 62 and the second liquid applier 612 being integrated, the embodiments of the present disclosure are not limited to the above-described configuration. For example, the stapler 62 and the second liquid applier 612 may have a configuration of moving separately from each other.

### Description of Binding Processing

A description is given below of the binding process executed by the edge binder 25 included in the post-processing apparatus 3.

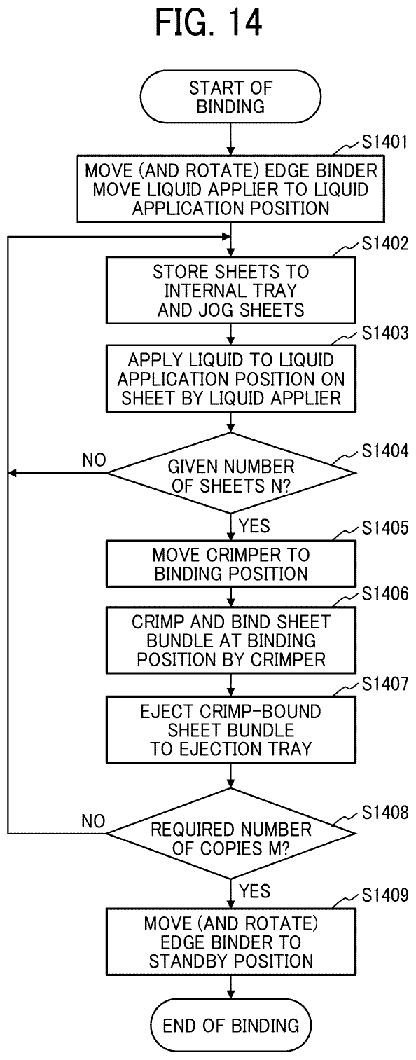

FIG. 14 is a flowchart of a process of executing one-point binding process.

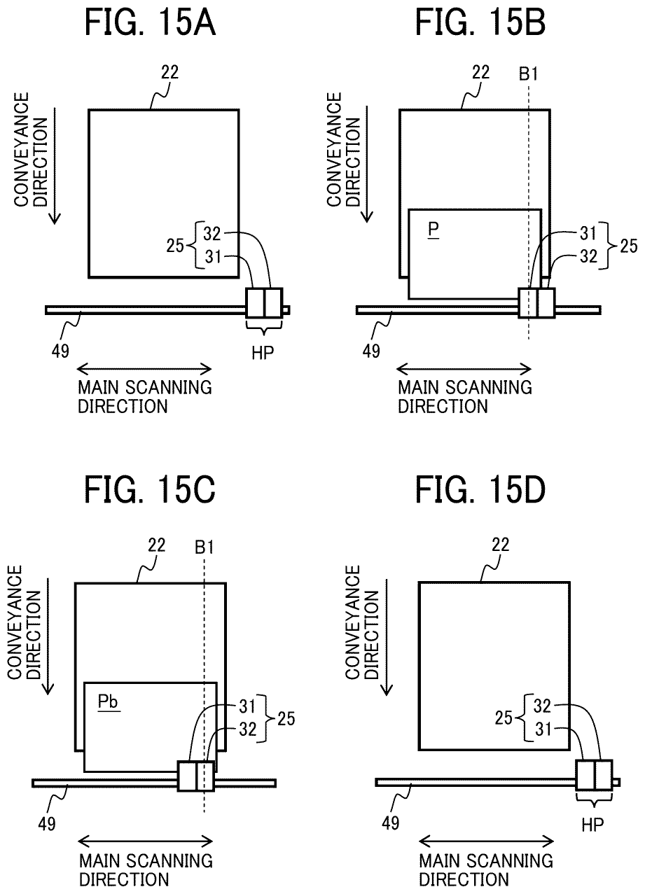

FIGS. 15A, 15B, 15C, and 15D are diagrams illustrating the position shift of the edge binder 25 (the liquid applier 31 and the crimper 32) during the one-point binding process.

FIGS. 15A, 15B, 15C, and 15D do not illustrate changes in the postures of the liquid applier 31 and the crimper 32. The position (liquid application position) at which liquid application is executed on the sheet P or the sheet bundle Pb by the liquid applier 31 corresponds to the binding position on the sheet bundle Pb to be crimped and bound by the crimper 32. For this reason, in the following description, the liquid application position and the binding position are denoted by the same reference numeral (B1 and B2).

For example, the controller 100b starts the binding process illustrated in FIG. 14 when the controller 100b acquires an instruction to execute the binding process from the image forming apparatus 2. In the following description, the instruction to execute the binding process may be referred to as a “binding command”.

The binding command includes, for example, the type of the sheet P (i.e., information affecting the spread of liquid, such as material and thickness), the number of sheets P of the sheet bundle Pb, the number of sheet bundles Pb to be bound, the binding position on the sheet bundle Pb, and the binding posture of the edge binder 25. In the following description, the number of sheets P of the sheet bundle Pb may be referred to as “given number of sheets N” whereas the number of sheet bundles Pb to be bound may be referred to as “requested number of copies M”. The liquid applier 31 and the crimper 32 are, as illustrated in FIG. 15A, assumed to be in a parallel binding posture and located at a standby position HP that is a position shifted in the width direction from the sheets P placed on the internal tray 22 at the start of the binding process.

When the posture that is instructed by the binding command is the “inclined binding posture”, the controller 100b drives the crimper pivot motor 56 to rotate the crimper 32 of the edge binder 25 into the inclined binding posture (step S1401). The controller 100b causes the liquid applier pivot assembly 126 to rotate the liquid applier 31 of the edge binder 25 to the inclined binding posture. When the posture is the “inclined binding posture”, the crimper 32 alone may be rotated to the inclined binding posture and the liquid applier 31 may be restricted not to rotate in the forward and reverse directions. Thus, the driving assembly may be simplified as compared with a case where both the liquid applier 31 and the crimper 32 are rotated in the forward and reverse directions, and thus effects of cost reduction, downsizing of the apparatus, and reduction of failure of the device are exhibited.

On the other hand, when the posture that is instructed by the binding command is the “parallel binding posture”, the controller 100b omits the aforementioned operation of rotating the liquid applier 31 and the crimper 32 of the edge binder 25 to the inclined binding posture. The controller 100b drives the edge binder movement motor 55 to move the edge binder 25 in the main scanning direction so that the liquid applier 31 faces the first liquid application position B1 instructed by the binding command (step S1401). The controller 100b executes the operation of step S1401 before a first sheet P is conveyed to the internal tray 22 by the conveyance roller pairs 10, 11, 14, and 15.

The controller 100b rotates the conveyance roller pairs 10, 11, 14, and 15 to store the sheet P, on which the image has been formed by the image forming apparatus 2, onto the internal tray 22 (step S1402). The controller 100b causes the side fences 24L and 24R to move to align the position of the sheet P or the sheet bundle Pb placed on the internal tray 22 in the main scanning direction (step S1402). In short, the controller 100b performs so-called jogging.

The controller 100b causes the liquid applier 31 facing the first liquid application position B1 to apply liquid to the first liquid application position B1 of the sheet P placed on the internal tray 22 in the immediately preceding step S1402, based on the liquid application control data adjusted in advance (step S1403). In other words, the controller 100b drives the liquid applier movement motor 42 to bring the liquid application member 451 into contact with the first liquid application position B1 on the sheet P placed on the internal tray 22 (see FIG. 15B). In the liquid application process in step S1403, the controller 100b adjusts the position at which the liquid application member 451 applies liquid to the sheet P in accordance with the type of the sheet P and the binding position included in the binding command. The controller 100b adjusts the amount of pressing the liquid application member 451 against the sheet P. In other words, the controller 100b controls the driving of the liquid applier movement motor 42 based on the adjusted control data, and adjusts the amount of movement of the liquid application member 451 with respect to the binding position B1 of the sheet P placed on the internal tray 22.

The controller 100b determines whether or not the number of sheets P placed on the internal tray 22 has reached the given number of sheets N instructed by the binding command (step S1404). When the controller 100b determines that the number of sheets P placed on the internal tray 22 has not reached the given number of sheets N (NO in step S1404), the controller 100b executes the operations of steps S1402 to S1404 again until the number of sheets P placed on the internal tray 22 reaches the given number of sheets N (YES in step S1404).

In other words, the controller 100b executes the processing of steps S1402 to S1404 each time the sheet P is conveyed to the internal tray 22 by the conveyance roller pairs 10, 11, 14, and 15.

The liquid application by the liquid applier 31 may be performed on each of the plurality of sheets P of the sheet bundle Pb.

When the controller 100b determines that the number of sheets P placed on the internal tray 22 has reached the given number of sheets N (YES in step S1404), the controller 100b drives the edge binder movement motor 55 to move the edge binder 25 in the main scanning direction so that the crimper 32 faces the first binding position B1 as illustrated in FIG. 15C (step S1405).

The controller 100b causes the crimper 32 to crimp the sheet bundle Pb placed on the internal tray 22 (step S1406). The controller 100b causes the conveyance roller pair 15 to eject the sheet bundle Pb thus crimped and bound by the crimper 32 to the second ejection tray 26 (step S1407). Specifically, the controller 100b drives the contact-separation motor 32d to cause the upper crimping teeth 32a and the lower crimping teeth 32b to nip the first binding position B1 on the sheet bundle Pb placed on the internal tray 22. The sheet bundle Pb is pressed and deformed between the upper crimping teeth 32a and the lower crimping teeth 32b. Thus, the crimper 32 crimps the sheet bundle Pb. Then, the controller 100b rotates the conveyance roller pair 15 to eject the sheet bundle Pb thus crimped and bound to the second ejection tray 26.

The sheet bundle Pb that is placed on the internal tray 22 has a crimping area (corresponding to the first binding position B1) sandwiched between the upper crimping teeth 32a and the lower crimping teeth 32b in step S1406. The crimping area overlaps a liquid application area (corresponding to the first liquid application position B1) contacted by the end of the liquid application member 451 in step S1403. In other words, the crimper 32 crimps an area to which liquid is applied by the liquid applier 31 on the sheet bundle Pb placed on the internal tray 22. The crimping area that is nipped by the upper crimping teeth 32a and the lower crimping teeth 32b may completely or partially overlaps the liquid application area contacted by the distal end (tip portion) of the liquid application member 451, to obtain a sufficient binding strength.

The controller 100b determines whether or not the number of sheet bundles Pb thus ejected to the second ejection tray 26 has reached the requested number of copies M indicated by the binding command (step S1408). When the controller 100b determines that the number of sheet bundles Pb thus ejected has not reached the requested number of copies M (NO in step S1408), the controller 100b executes the operations of step S1402 and the following steps again. In other words, when the controller 100b determines that the number of sheet bundles Pb thus ejected has not reached the requested number of copies M (YES in step S1408), the controller 100b repeats the operations of steps S1402 to S1408 until the number of sheet bundles Pb ejected to the second ejection tray 26 reaches the requested number of copies M.

On the other hand, when the controller 100b determines that the number of sheet bundles Pb ejected to the second ejection tray 26 has reached the requested number of copies M (YES in step S1408), the controller 100b drives the edge binder movement motor 55 to move the edge binder 25 (the liquid applier 31 and the crimper 32) to the standby position HP as illustrated in FIG. 15D (step S1409). When the posture that is instructed by the binding command is the “inclined binding posture”, the controller 100b also drives the crimper pivot motor 56 to rotate the crimper 32 into the parallel binding posture (step S1409). The controller 100b causes the liquid applier pivot assembly 126 to rotate the liquid applier 31 to the parallel binding posture (step S1409). On the other hand, when the posture that is instructed by the binding command is the “parallel binding posture”, the controller 100b skips the aforementioned operation of rotating the liquid applier 31 and the crimper 32 to the parallel binding posture. Thus, the edge binder 25 (the liquid applier 31 and the crimper 32) returns to the standby position HP position illustrated in FIG. 15D. In steps S1401 and S1409, the execution order of the movement in the main scanning direction and the rotation in the forward and reverse directions of the liquid applier 31 and the crimper 32 is not limited to the aforementioned order and may be reversed.

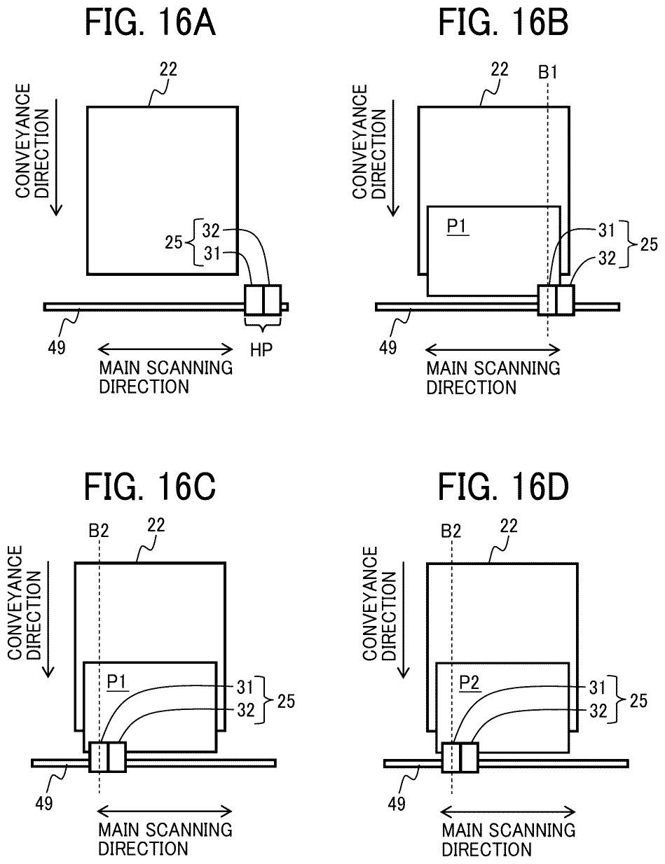

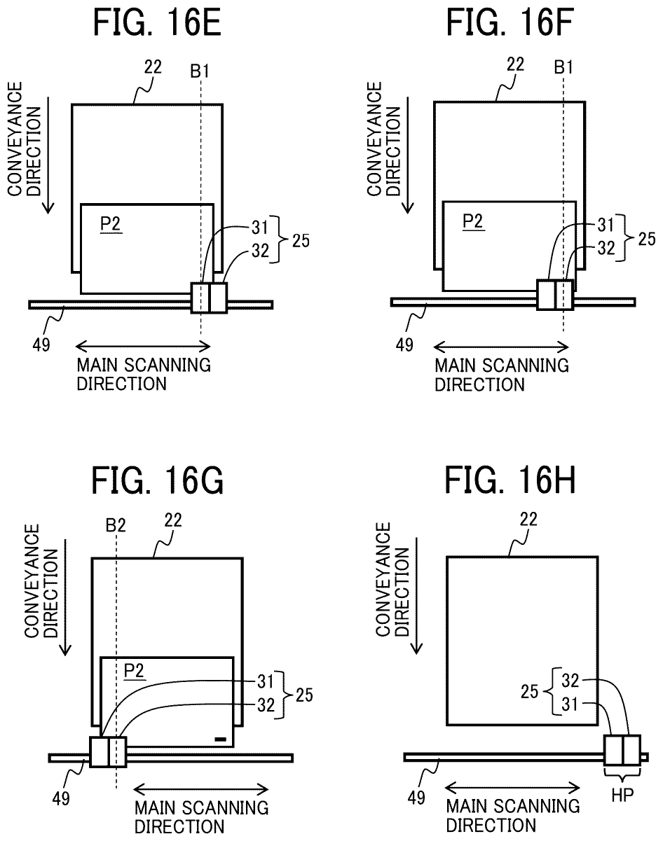

FIGS. 16A, 16B, 16C, 16D, 16E, 16F, 16G, and 16H are diagrams illustrating shifts of the positions of the edge binder 25 during the operation of a two-point binding.

A detailed description of points common to the process described with reference to FIGS. 15A, 15B, 15C, and 15D may be omitted, and differences will be mainly described. As illustrated in FIG. 16A, it is assumed that the edge binder 25 is located at the standby position HP at the start point of the two-point binding. Further, the first binding position B1 and the second binding position B2 are apart from each other in the main scanning direction. In FIGS. 16A to 16H, the case where two sheets P1 and P2 are crimped and bound (in other words, the given number of sheets N=2) will be described. However, the number of sheets P of the sheet bundle Pb is not limited to two.

Before the first sheet P1 of the sheet bundle Pb is placed on the internal tray 22, the controller 100b causes the edge binder 25 to move in the main scanning direction so that the liquid applier 31 can face the first liquid application position B1. Subsequently, as illustrated in FIG. 16B, the controller 100b places the liquid applier 31 at the position to face the first liquid application position B1. With this state, the sheet P1 on which an image has been formed by the image forming apparatus 2 is placed on the internal tray 22, and the controller 100b causes the side fences 24L and 24R to move in the main scanning direction to jog the sheets.

Subsequently, with the first sheet P1 being placed on the internal tray 22, the controller 100b causes the liquid applier 31 to apply the liquid at the first liquid application position B1 of the first sheet P1. Then, as illustrated in FIG. 16C, the controller 100b causes the edge binder 25 to move in the main scanning direction so that the liquid applier 31 faces the second liquid application position B2 of the first sheet P1. Subsequently, the controller 100b causes the liquid applier 31 to apply the liquid at the second liquid application position B2 of the first sheet P1.

Then, in response to the completion of liquid application by the liquid applier 31 to the first liquid application position B1 and the second liquid application position B2 of the first sheet P1, the controller 100b causes the second sheet P2 of the sheet bundle Pb to be accommodated in the internal tray 22 and the side fences 24L and 24R to move in the main scanning direction to jog the sheets, with the liquid applier 31 being disposed at a position to face the second liquid application position B2, as illustrated in FIG. 16D.

Subsequently, with the second sheet P2 being placed on the internal tray 22, the controller 100b causes the liquid applier 31 to apply the liquid at the second liquid application position B2 of the second sheet P2. Then, as illustrated in FIG. 16E, the controller 100b causes the edge binder 25 to move in the main scanning direction so that the liquid applier 31 faces the first liquid application position B1 of the second sheet P2. Subsequently, the controller 100b causes the liquid applier 31 to apply the liquid at the first liquid application position B1 of the second sheet P2.

In other words, the controller 100b controls the conveyance roller pairs 10, 11, 14, and 15 and the liquid applier 31 to repeat the conveyance of the sheet P and the liquid application to the first liquid application position B1 and the second liquid application position B2 until the number of sheets P placed on the internal tray 22 reaches the given number of sheets N. At this time, the controller 100b controls the liquid applier 31 to apply the liquid to the B-th sheet P (B<N) in the order of the first liquid application position B1 and the second liquid application position B2. Subsequently, the controller 100b controls the liquid applier 31 to apply the liquid to the (B+1)-th sheet P in the order of the second liquid application position B2 and the first liquid application position B1. In other words, the controller 100b changes the order in which the liquid applier 31 applies the liquid to the first liquid application position B1 and the second liquid application position B2 for each sheet P. The controller 100b also causes the edge binder 25 to move from one side of the first liquid application position B1 and the second liquid application position B2 to the other side of the first liquid application position B1 and the second liquid application position B2 in the shortest distance without passing through the standby position HP.

Subsequently, when the controller 100b determines that the number of sheets P placed on the internal tray 22 has reached the given number of sheets N, the controller 100b causes the edge binder 25 to move in the main scanning direction so that the crimper 32 faces the first binding position B1 as illustrated in FIG. 16F. The controller 100b causes the crimper 32 to crimp and bind the first binding position B1 of the sheet bundle Pb including the first sheet P1 and the second sheet P2 placed on the internal tray 22. Then, as illustrated in FIG. 16G, the controller 100b causes the edge binder 25 to move in the main scanning direction so that the crimper 32 faces the second binding position B2 of the sheet bundle Pb. The controller 100b causes the crimper 32 to crimp and bind the second binding position B2 of the sheet bundle Pb placed on the internal tray 22.

In the example illustrated in FIGS. 16A to 16H, since the controller 100b causes the liquid applier 31 to finally apply the liquid to the first liquid application position B1, the crimper 32 performs the crimp binding in the order of the first binding position B1 and the second binding position B2. On the other hand, when the controller 100b causes the liquid applier 31 to finally apply the liquid to the second liquid application position B2, the crimper 32 may perform the crimp binding in the order of the second binding position B2 and the first binding position B1.

In other words, as illustrated in FIGS. 16A to 16H, the controller 100b causes the edge binder movement assembly 57 to move the edge binder 25 by the shortest distance between the position at which the liquid applier 31 faces the first liquid application position B1 and the position at which the liquid applier 31 faces the second liquid application position B2 without passing through the standby position HP. The controller 100b causes the edge binder movement assembly 57 to move the edge binder 25 by the shortest distance between the position at which the crimper 32 faces the first binding position B1 and the position at which the crimper 32 faces the second binding position B2 without passing through the standby position HP. Further, the controller 100b causes the edge binder movement assembly 57 to move the edge binder 25 by the shortest distance between the position at which the liquid applier 31 faces the first liquid application position B1 (or the second liquid application position B2) and the position at which the crimper 32 faces the first binding position B1 (or the second binding position B2) without passing through the standby position HP.

Then, the controller 100b causes the conveyance roller pair 15 to rotate to eject the sheet bundle Pb to the second ejection tray 26 after the sheet bundle Pb is crimped and bound by the crimper 32 at the first binding position B1 and the second binding position B2. Further, as illustrated in FIG. 16H, the controller 100b drives the edge binder movement motor 55 to move the edge binder 25 (the liquid applier 31 and the crimper 32) to the standby position HP.

### Correlation between Configuration of Image Forming System and Relay Peripheral Device and Liquid Application Amount

In the image forming system 1 described above, a unit responsible for relay processing of the sheet P may be disposed between the image forming apparatus 2 and the post-processing apparatus 3. Depending on the configuration of a relay processing unit, a sheet conveyance distance to be described later changes.

When the crimp binding process is executed by the edge binder 25 included in the post-processing apparatus 3, the sheet P is conveyed from the image forming apparatus 2 to the edge binder 25. The conveyance path of the sheet P is a path in which the image forming apparatus 2 passes through various configurations and reaches the edge binder 25 after an image is formed on the sheet P in the image former 213.

Various types of image forming methods for forming an image on the sheet P in the image former 213 are already known, but various methods are known as processing performed before processing by the edge binder 25 on the sheet P. In any method, the image forming process for the sheet P includes processing of changing the temperature of the sheet P. For example, in the case of the electrophotographic method, a fixing process for fixing the image forming material to the sheet P is executed in the image former 213, and in this fixing process, a fixing unit that heats the sheet P is used.

A fixing temperature that is a temperature at which the sheet P is heated in the fixing unit is acquired by a temperature and humidity sensor provided in the image forming apparatus 2. The fixing temperature varies depending on the type of the sheet P and the thickness of the sheet P (sheet thickness). It also correlates with the time required to fix the image forming material and the processing time of the entire image forming process. Therefore, the temperature of the sheet P after fixing (hereinafter referred to as “sheet temperature”) is different depending on the productivity in the image forming apparatus 2 that executes the image fixing process and the sheet thickness.

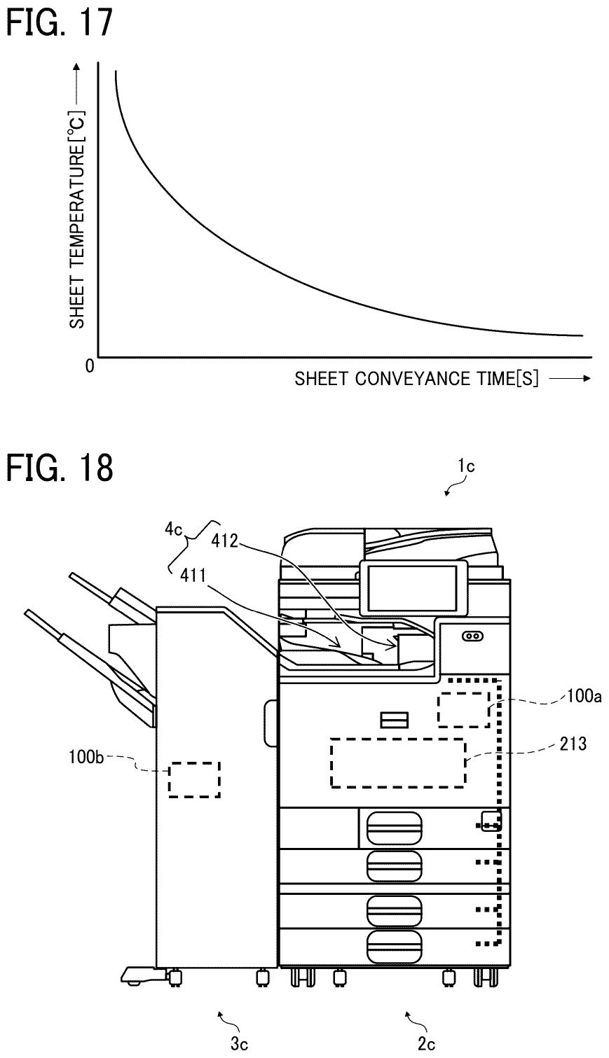

FIG. 17 exemplifies the correlation between the conveyance time of the sheet P starting from the fixing unit of the image former 213 and the sheet temperature warmed by the fixing unit.

As illustrated in FIG. 17, when the conveyance time of the sheet P increases, the temperature of the sheet P decreases accordingly. The conveyance time of the sheet P is proportional to the conveyance distance of the sheet P. Therefore, when the conveyance distance of the sheet P becomes longer, the sheet temperature decreases from the temperature at the time of being warmed in the fixing unit by that amount.

In the present specification, the “conveyance distance” assumes a distance by which the sheet P moves from the fixing unit included in the image former 213 to the post-processing apparatus 3 including the edge binder 25. The conveyance distance of the sheet P is referred to as a “sheet conveyance distance”.

In the case of a system configuration in which only the image forming apparatus 2 and the peripheral (post-processing apparatus 3) to which the crimp binding is attached are combined, the sheet conveyance distance from the exit of the fixing unit to the post-processing apparatus 3 is relatively short, so that the sheet conveyance time is short, and the degree of decrease in the sheet temperature is relatively low. On the other hand, in the case of a system configuration in which a plurality of relay processing units is connected, the conveyance time of the sheet P is long, and thus the degree of decrease in the sheet temperature is relatively high. That is, the sheet temperature when the sheet P warmed in the image former 213 reaches the post-processing apparatus 3 is lower in a system configuration in which the sheet conveyance distance is relatively long than in a system configuration in which the sheet conveyance distance is relatively short.

In a case where the sheet temperature is relatively high, the liquid applied by the liquid applier 31 is more likely to evaporate as compared to a case where the sheet temperature is relatively low. Since the degree of evaporation of the liquid applied to the sheet by the liquid application executed in the edge binder 25 (liquid applier 31) is correlated with the sheet temperature, it is also correlated with the sheet conveyance distance. That is, in the case of performing the liquid application crimp binding in the system configuration in which the sheet conveyance distance is relatively long, the liquid is less likely to evaporate as compared with the case of the system configuration in which the sheet conveyance distance is relatively short. Therefore, if the amount of liquid to be applied is the same, in a system configuration in which the sheet conveyance distance is relatively long, the liquid content of the sheet P when the crimp binding is executed becomes high.

By applying the liquid to the sheet P, the flexibility of the binding position of the sheet P is enhanced, and in particular, the degree of pressure deformation of the sheet P at the time of performing the crimp binding is increased, and the binding strength can be enhanced. That is, appropriate binding strength can be implemented and binding quality can be improved by adjusting the appropriate liquid content by applying the liquid. Therefore, appropriately adjusting the amount of liquid applied by liquid application based on the liquid content of the sheet P reaching the liquid applier 31 affects the improvement of the binding quality.

In a post-processing apparatus 3c included in an image forming system 1c according to the present embodiment described below, a heating state of the sheet P is acquired from an image forming apparatus 2c in controlling liquid application to the sheet P whose temperature has changed by processing (fixing processing or the like) executed before the processing in the edge binder 25. Further, the post-processing apparatus 3c acquires an actual sheet conveyance distance from the exit of the fixing unit to the post-processing apparatus 3c, based on connection information of a relay peripheral device 4c that is a peripheral device actually coupled to each of the image forming apparatus 2c and the post-processing apparatus 3c and the sheet conveyance distance in the relay peripheral device 4c that is a peripheral device coupled to the image forming apparatus 2c and the post-processing apparatus 3c.

Then, the post-processing apparatus 3c according to the present embodiment estimates the temperature of the sheet P based on the acquired information, and adjusts the appropriate liquid application amount according to the estimated temperature.

### First Configuration Example of Image Forming System

A configuration example of adjusting the liquid application amount for improving the binding strength in the medium processing apparatus according to the present invention will be described with reference to the drawings. For example, the image forming system 1c illustrated in FIG. 18 is an example of a system configuration in which the sheet conveyance distance is relatively short. As illustrated in FIG. 18, the image forming apparatus 2c, which is an upstream apparatus of the post-processing apparatus 3c, includes an in-body finisher 411 constituting the relay peripheral device 4c and a relay unit 412. A plurality of variations is assumed in the image forming apparatus 2c, such as a case where only one of the in-body finisher 411 and the relay unit 412 is mounted, a case where both the in-body finisher 411 and the relay unit 412 are mounted, and the like.

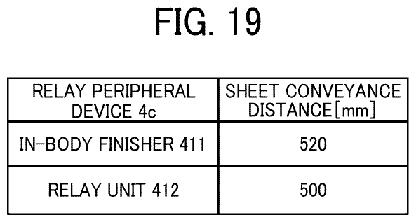

As illustrated in FIG. 19, data indicating the conveyance distance to each relay peripheral device 4c is held in advance in the controller 100b of the post-processing apparatus 3c included in the image forming system 1c. As illustrated in FIG. 19, for example, the conveyance distance of the in-body finisher 411 is 520 [mm], and the conveyance distance of the relay unit 412 is 500 [mm].

### Second Configuration Example of Image Forming System

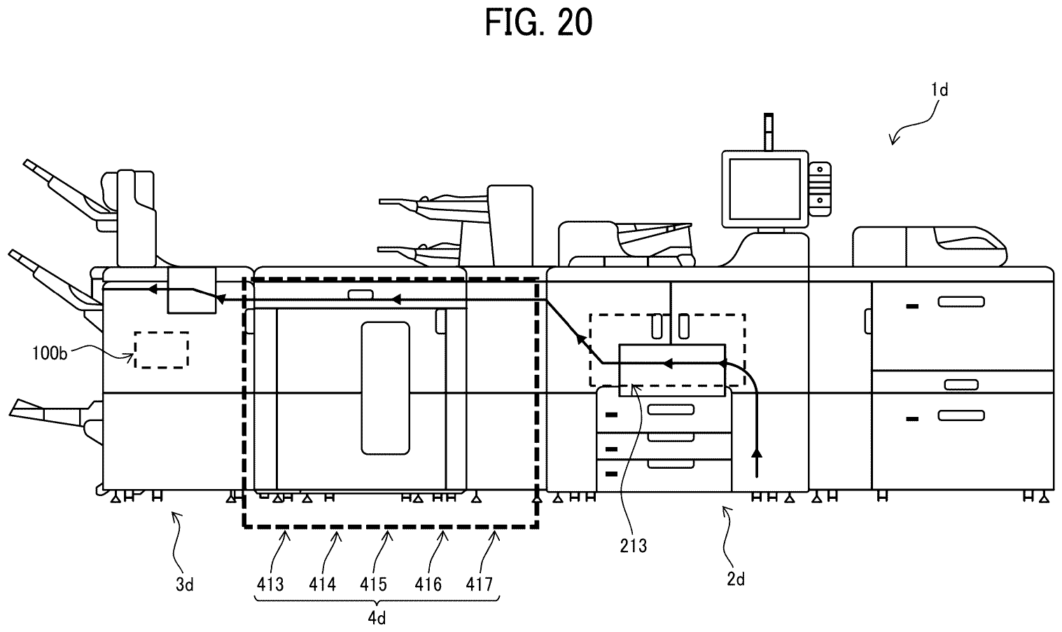

For example, the image forming system 1d illustrated in FIG. 20 is an example of a system configuration in which the sheet conveyance distance is relatively long. As illustrated in FIG. 20, in a case of a so-called “on-demand printing machine” in which a relay peripheral device 4d including a plurality of devices is disposed between a post-processing apparatus 3d and the image forming apparatus 2d that is an upstream apparatus of the post-processing apparatus 3d, the sheet conveyance distance is longer than that of the image forming system 1c.

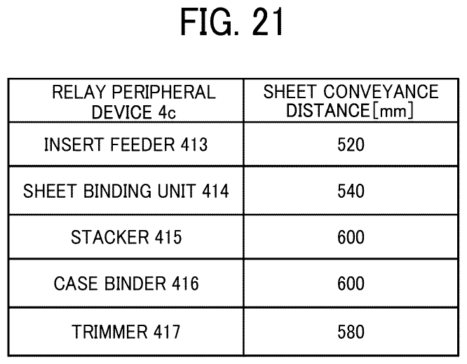

The relay peripheral device 4d illustrated in FIG. 20 includes, for example, an insert feeder 413, a paper folding unit 414, a stacker 415, a case binder 416, and a trimmer 417 as illustrated in FIG. 21. The respective conveyance distances are 520 [mm], 540 [mm], 600 [mm], 600 [mm], and 580 [mm]. In this manner, data indicating the sheet conveyance distance corresponding to the system configuration is held in the controller 100b.

In both the first configuration example and the second configuration example, the system configuration is an example, and the characteristic control processing described below can be applied to other system configurations.

Furthermore, in the above description, an example has been described in which the data of the conveyance distance corresponding to the system configuration is held in advance, but the embodiments of the present disclosure are not limited thereto, and it is also possible to hold the above data as the conveyance time instead of the conveyance distance by the conveyance distance and the conveyance speed, and execute the following control based on the conveyance time.

The controller 100b acquires the data illustrated in FIG. 19 or FIG. 21 as information of the relay peripheral devices 4c and 4d from the image forming apparatus 2 in accordance with the system configuration, and calculates and holds the total conveyance distance from the image forming apparatus 2 to the edge binder 25.

In any of the above system configurations, the distance from where the sheet P is carried into the post-processing apparatuses 3c and 3d to where the edge binder 25 is attached to when the sheet P reaches the edge binder 25 is, for example, 350 [mm].

The correlation between the system configuration and the sheet conveyance distance will be exemplified with reference to the image forming systems 1c and 1d.

### First Example of Sheet Conveyance Distance

For example, in the case of a system configuration by the image forming apparatus 2c, the relay unit 412, and the post-processing apparatus 3c including the edge binder 25, the sheet conveyance distance is the relay unit 412 (500 mm) and the edge binder 25 (350 mm), and thus the total sheet conveyance distance is 850 [mm].

### Second Example of Sheet Conveyance Distance

In addition, in the case of a system configuration by the image forming apparatus 2d and the post-processing apparatus 3d including the edge binder 25, since there is no relay peripheral device 4d, the edge binder 25 (350 mm) is the total sheet conveyance distance.

### Third Example of Sheet Conveyance Distance

Furthermore, in the image forming system 1d, in the case of a system configuration by the post-processing apparatus 3d including the case binder 416, the paper folding unit 414, the stacker 415, and the edge binder 25, since the case binding machine (600 mm) +the paper folding unit (540 mm)+the stacker (600 mm)+the edge binder 25 (350 mm), the total sheet conveyance distance is 2090 [mm].

### Example of Liquid Application Setting Pattern

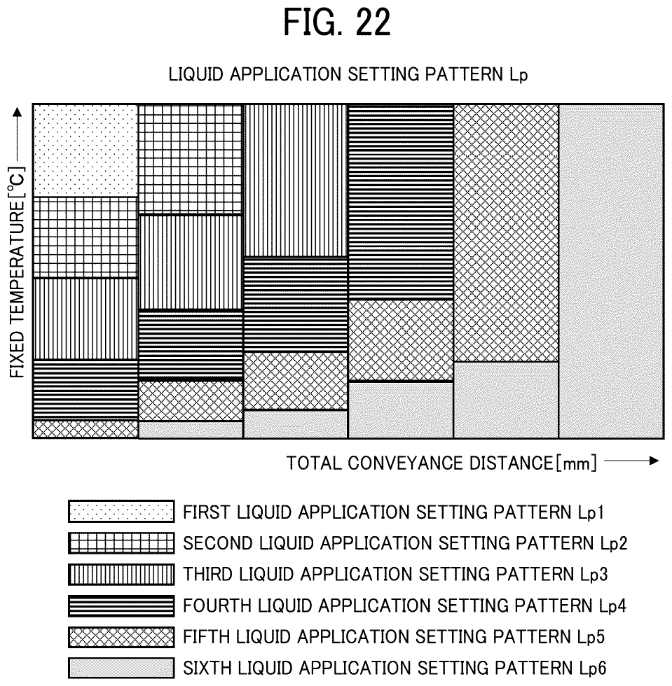

A pattern of setting values (liquid application setting pattern Lp) for controlling the liquid application operation will be described. The liquid application setting pattern Lp is a type of control information stored in advance in the storage area of the controller 100b. The liquid application setting pattern Lp is distinguished by a combination of the fixing temperature and the sheet conveyance distance. In FIG. 22, with the sheet conveyance distance on the horizontal axis and the fixing temperature on the vertical axis, the correlation is distinguished into several sections by a combination of a certain range of the sheet conveyance distance and a certain range of the fixing temperature. Then, the liquid application setting pattern Lp corresponding to each area is held in advance.

FIG. 22 illustrates a first liquid application setting pattern Lp1 to a sixth liquid application setting pattern Lp6.

As illustrated in FIG. 22, in the first liquid application setting pattern Lp1, since the temperature of the sheet P is relatively high, the liquid applied to the sheet P is likely to evaporate. Therefore, it is necessary to control the liquid application so as to increase the liquid application amount. In addition, since the temperature of the sheet P is not relatively high in the sixth liquid application setting pattern Lp6, control may be performed so that liquid application is performed by the liquid application amount derived from the sheet thickness and the number of bound sheets by applying a well-known technique. The distribution of the liquid application setting patterns Lp and the number of the liquid application setting patterns Lp illustrated in FIG. 22 are examples.

The liquid application setting pattern Lp for liquid application is set to any one of the first liquid application setting pattern Lp1 to the sixth liquid application setting pattern Lp6 using FIG. 22 according to the first to third examples of the sheet conveyance distance and the correlation with the fixing temperature.

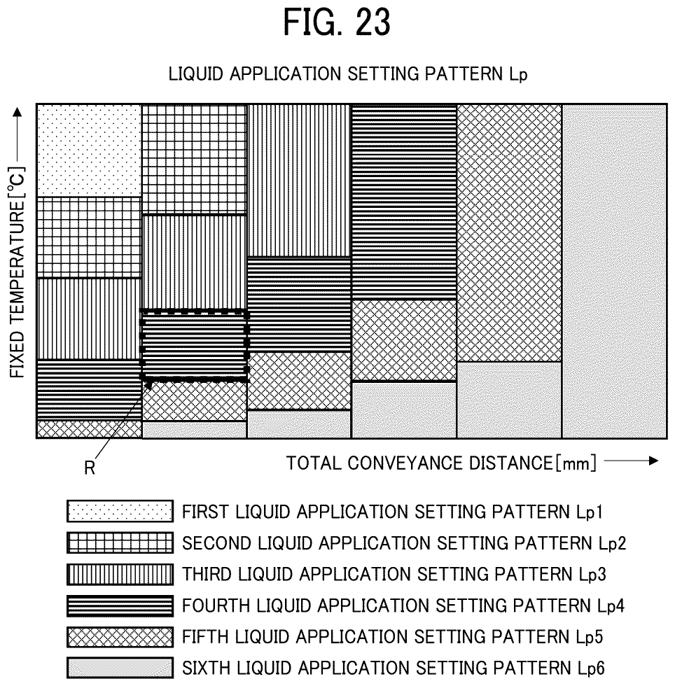

For example, in the case of the first example of the sheet conveyance distance, the image forming apparatus 2c is a so-called multifunction peripheral, and has a lower image forming speed and a lower conveyance speed of the sheet P than an on-demand printing machine such as the image forming apparatus 2d, and the productivity is relatively low. Therefore, the fixing temperature is also low. Further, since the relay unit 412 is mounted as the relay peripheral device 4c, the sheet conveyance distance is 850 [mm]. Therefore, the liquid application setting pattern Lp becomes the fourth liquid application setting pattern Lp4 corresponding to the region R surrounded by a broken line rectangle in FIG. 23.

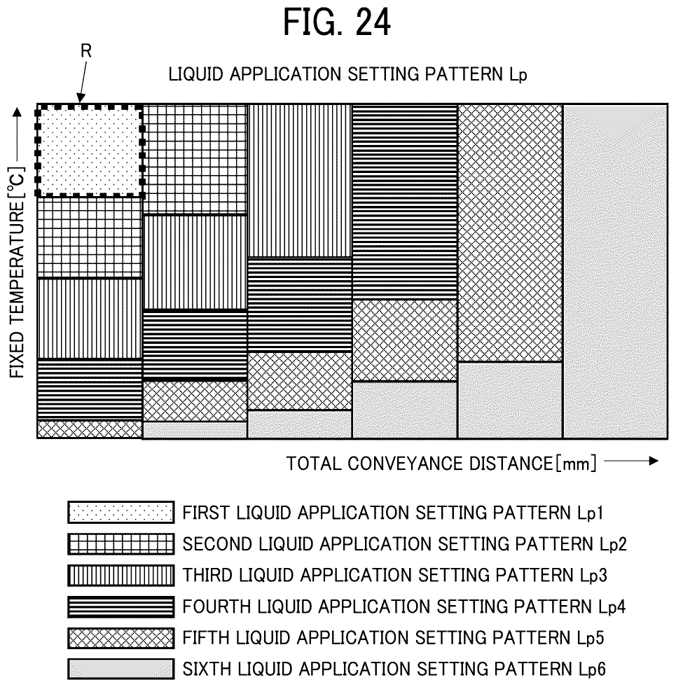

In addition, in the case of the second example of the sheet conveyance distance, the image forming apparatus 2d is a so-called on-demand printing machine, and thus has a high fixing temperature. Further, since there is no relay peripheral device 4d, the sheet conveyance distance is short. Therefore, a liquid application pattern in this case is the first liquid application setting pattern Lp1 corresponding to the region R surrounded by a broken line rectangle in FIG. 24.

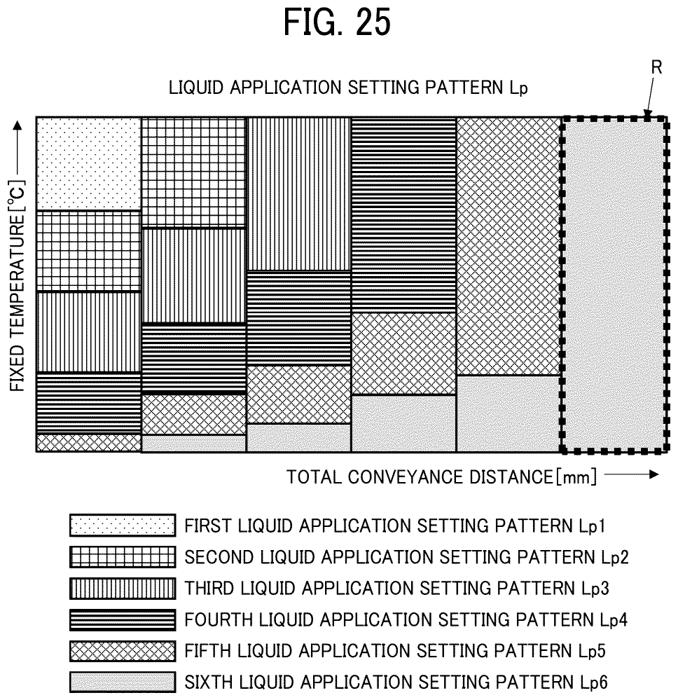

In addition, in the case of the third example of the sheet conveyance distance, the image forming apparatus 2d is a so-called on-demand printing machine, and thus has a high fixing temperature. In addition, since the relay peripheral device 4d has many configurations, the conveyance distance is 2090 [mm] as a whole. Therefore, the liquid application setting pattern Lp is the sixth liquid application setting pattern Lp6 corresponding to the region R surrounded by a broken line rectangle in FIG. 25.

As described above, the liquid application setting pattern Lp differs depending on the fixing temperature and the total conveyance distance of each apparatus. In the controller 100b included in the post-processing apparatuses 3c and 3d according to the present embodiment, setting values of the pressing amount of the liquid application member 501 and the time (liquid application time) for which the liquid application member 501 is brought into contact with the sheet P are held for each liquid application setting pattern Lp, and a liquid application control is performed using the setting values.

As described above, the liquid application setting amount used for the liquid application control is set based on the total conveyance distance and the fixing temperature (the temperature applied by the process of causing a temperature change on the sheet P). The liquid application setting amount is defined by a “pressing amount X [mm]” of pressing the liquid application member 501 against the sheet P and a “liquid application time Y [ms]” that is a time for maintaining a state where the liquid application member 501 is in contact with the sheet P and is a contact time. The process of determining the liquid application setting amount is a well-known technique, and thus a detailed description thereof will be omitted.

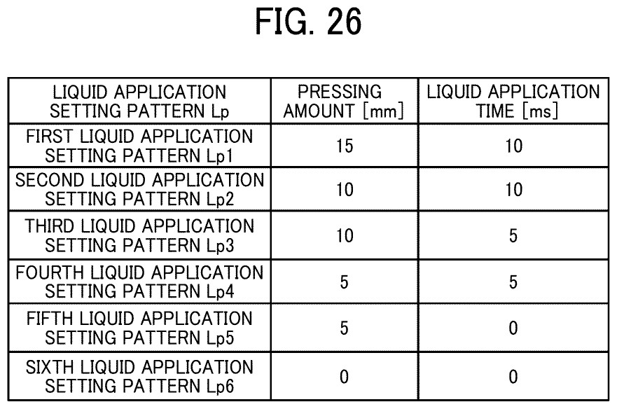

In the present embodiment, the liquid application amount is controlled using the liquid application setting pattern Lp based on the conveyance distance and the fixing temperature with respect to the pressing amount X and the liquid application time Y, which are the liquid application setting amounts determined based on the thickness of the sheet P and the number of sheets P constituting the sheet bundle Pb. FIG. 26 is an example of a combination (addition/subtraction value) of adjustment amounts of the pressing amount X [mm] and the liquid application time Y [ms] for each liquid application pattern. As illustrated in FIG. 26, instead of adding or subtracting the “pressing amount X [mm]” and the “liquid application time Y [ms]” for each liquid application pattern, the actual liquid application amount (liquid application+addition/subtraction determined based on the sheet P) may be used.

The example of the liquid application setting amount illustrated in FIG. 26 is applied to the “first example of the sheet conveyance distance” illustrated above. Since the liquid application setting pattern Lp in this case corresponds to the fourth liquid application setting pattern Lp4, the pressing amount X is +5 [mm] and the liquid application time Y is +5 [ms] based on the liquid application setting amount in FIG. 26.

Further, this is applied to the “second example of the sheet conveyance distance”. Since the liquid application setting pattern Lp in this case is the first liquid application setting pattern Lp1, the pressing amount X is +15 [mm] and the liquid application time Y is +10 [ms] based on the liquid application setting amount in FIG. 26.

It is applied to the third example of the sheet conveyance distance. Since the liquid application setting pattern Lp in this case is the sixth liquid application setting pattern Lp6, there is no addition or subtraction of the pressing amount X and there is no addition or subtraction of the liquid application time Y based on the liquid application setting amount of FIG. 26. That is, liquid application is controlled by a value defined by the thickness of the sheet P and the number of sheets P constituting the sheet bundle Pb.

As exemplified above, it is possible to control the liquid content of the sheet P at the stage of executing liquid application in consideration of the fixing temperature in the image forming apparatuses 2c and 2d and the liquid evaporation time defined by the length of the sheet conveyance distance to the post-processing apparatuses 3c and 3d.

### Configuration Example of Liquid Applier According to Present Embodiment

A configuration example of the liquid applier 31c that enables the control of the liquid application described above will be described.

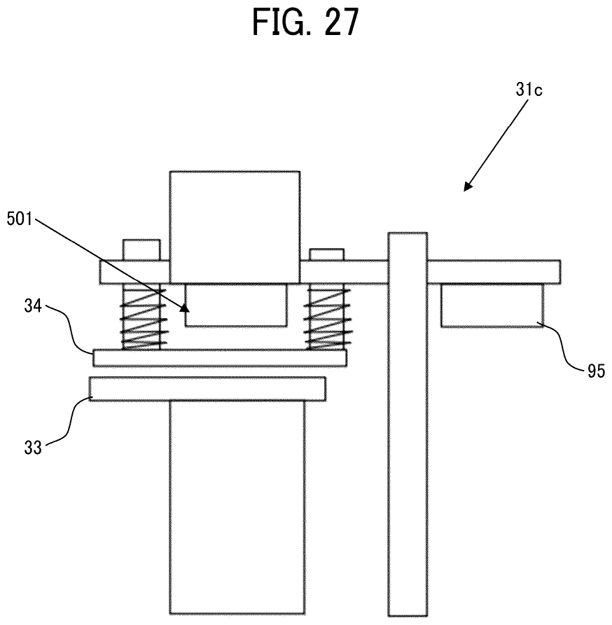

FIG. 27 is a configuration example of the liquid applier 31c according to the present embodiment.

A difference from the liquid applier 31 described above is that a liquid application amount detection sensor 95 is provided.

The liquid application amount detection sensor 95 holds the liquid application member 501 movably between a contact position in contact with the sheet P and a separation position separated from the sheet P, and is held in a configuration including a pressing unit that presses the liquid application member 501 in contact with the sheet P. The liquid application amount detection sensor 95 moves to a position (liquid application position) where the liquid application member 501 is brought into contact with and pressed against the sheet P positioned between the lower pressure plate 33 and the upper pressure plate 34, and moves with respect to the liquid application position by the pressing unit after the liquid application to detect the liquid amount (liquid content) at the liquid application position.

The liquid application amount detection sensor 95 as a liquid application amount detector detects the liquid amount (liquid content) of the portion of the sheet P on which the liquid has been applied and notifies the controller 100b of the liquid amount. The controller 100b calculates the liquid content of the sheet P based on the notification from the liquid application amount detection sensor 95.

As the liquid application amount detection sensor 95, for example, a near-infrared type, an electric resistance type, an electric capacitance type, or the like can be employed. As long as the liquid amount of the sheet P can be detected, the form is not limited.

At the time of execution of a job including a process of forming the sheet bundle Pb by crimp binding, the controller 100b detects the liquid application amount of the first sheet P by the liquid application amount detection sensor 95 after liquid application based on the setting value determined by the liquid application setting pattern Lp is performed on the first sheet P. Then, the liquid application amount for the second and subsequent sheets P is adjusted based on the liquid application amount detected from the first sheet P.

### Flow of Process of Liquid Application Amount Control (First Example)

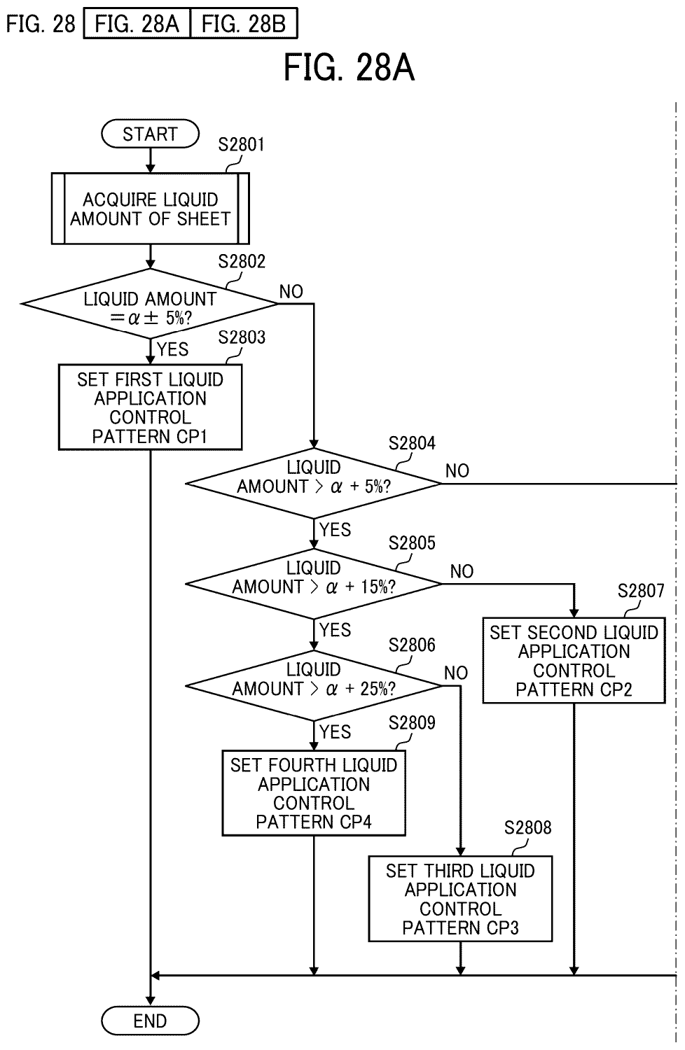

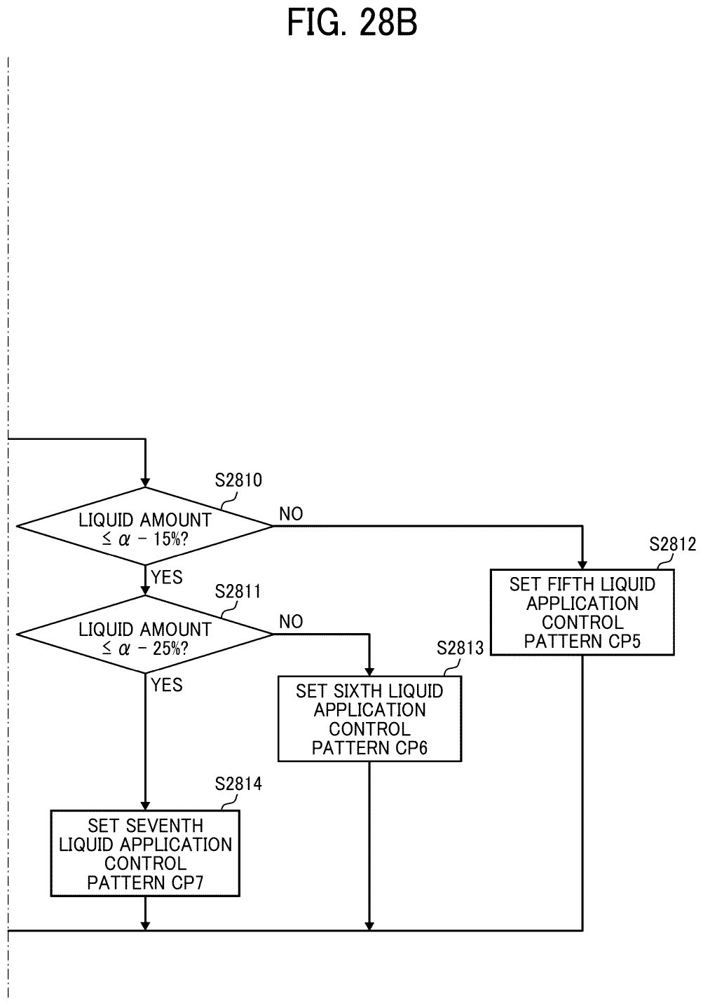

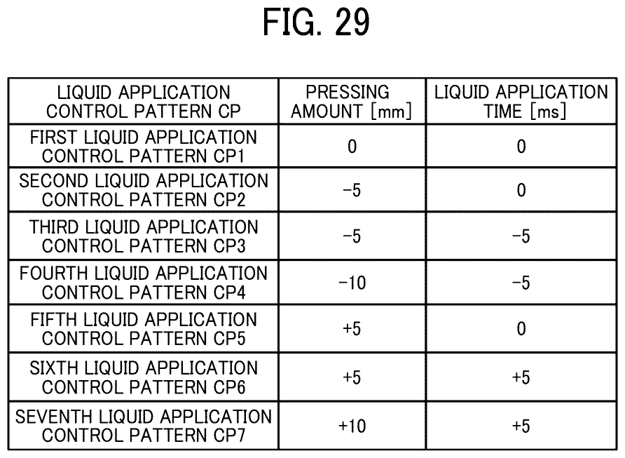

The flow of the liquid application amount control process implemented in the controller 100b included in the post-processing apparatuses 3c and 3d will be described with reference to FIGS. 28 (including FIGS. 28A and 28B) and 29.

FIG. 28 including FIGS. 28A and 28B is a flowchart illustrating an example of a flow of a process of liquid application control.

After execution of a job including a binding process involving liquid application is started and liquid application is performed on the first sheet P constituting the sheet bundle Pb, a liquid application amount detection process is performed by the liquid application amount detection sensor 95 (step S2801).

The liquid content detected in step 2801 is compared with an appropriate amount α [%] of the liquid content preset with respect to the thickness of the sheet P (step S2802). Since it is difficult to match the liquid content detected from the sheet P with the appropriate amount α without an error, a range that can be compromised with respect to the appropriate amount α is defined in advance as an allowable error, and as long as the liquid content falls within the range of the allowable error with respect to the appropriate amount α, the liquid content is determined as the same amount as the appropriate amount α, and control is performed. In this example, the description will be given assuming that the allowable error is “±5%”. The value of the tolerance is an example.

In step S2802, when the liquid content of the first sheet P is within the range of ±5 [%] of the appropriate amount α (YES in step S2802), a first liquid application control pattern CP1 of liquid application control patterns CP illustrated in FIG. 29 is set, and the process is ended (step S2803).

When the liquid content of the first sheet P is out of the range of ±5% of the appropriate amount α (NO in step S2802), it is determined whether the liquid content of the first sheet P is larger or smaller than the appropriate amount α (step S2804). If the liquid content is larger than +5% with respect to the appropriate amount α in step S2804 (YES in step S2804), subsequently, it is determined whether or not the liquid content is larger than +15% with respect to the appropriate amount α (step S2805). When it is determined in step S2805 that the liquid content is equal to or less than +15% with respect to the appropriate amount α (NO in step S2805), the second liquid application control pattern CP2 is set and the process is ended step (step S2807).

When it is determined in step S2805 that the liquid content is larger than +15% with respect to the appropriate amount α (YES in step S2805), it is determined whether or not the liquid content of the first sheet P is larger than +25% with respect to the appropriate amount (step S2806). When it is determined in step S2806 that the liquid content is equal to or less than +25% with respect to the appropriate amount α (NO in step S2806), the third liquid application control pattern CP3 is set and the process is ended (step S2808). When it is determined in step S2806 that the liquid content is larger than +25% with respect to the appropriate amount α (YES in step S2806), the fourth liquid application control pattern CP4 is set and the process is ended (step S2809).

If the liquid content is less than +5% with respect to the appropriate amount α in step S2804 (NO in step S2804), it is subsequently determined whether or not the liquid content is equal to or less than −15% with respect to the appropriate amount α (step S2810). When it is determined in step 2810 that the liquid content is not equal to or less than −15% of the appropriate amount α (NO in step S2810), the fifth liquid application control pattern CP5 is set and the process is ended (step S2812).

When it is determined in step 2810 that the liquid content is equal to or less than −15% of the appropriate amount α (YES in step S2810), subsequently, it is determined whether or not the liquid content is equal to or less than−25% of the appropriate amount (step S2811). When it is determined in step S2811 that the liquid content is equal to or less than −25% of the appropriate amount α (YES in step S2811), the seventh liquid application control pattern CP7 is set and the process is ended (step S2814). When it is determined in step S2811 that the liquid content is not equal to or less than −25% of the appropriate amount α (NO in step S2811), the sixth liquid application control pattern CP6 is set and the process is ended (step S2813).

FIG. 29 illustrates a combination of the liquid application control pattern CP and an adjustment amount of the pressing amount X and an adjustment amount of the liquid application time Y corresponding thereto for switching the liquid application control mode.

The liquid application control pattern CP illustrated in FIG. 29 is an example, and a comparison range of the liquid content is also an example. The timing of acquiring the liquid content need not be the timing of acquiring a result of applying the liquid to the first sheet P. For example, after the liquid is applied to the second sheet P, processing may be performed so as to acquire the liquid content of the second sheet. In addition, results of applying the liquid to the first and second sheets P may be acquired, and an average value may be set as the liquid content to set the pattern of the adjustment control of the liquid application amount as described above.

As described above, the controller 100b sets the liquid application pattern based on the system configuration according to the post-processing apparatuses 3c and 3d, and sets the liquid application control pattern CP for adjusting the setting value by the liquid application setting pattern Lp based on the liquid content acquired from the sheet P to which the liquid has been applied by the setting.

In other words, the adjustment amount determined by the liquid application control pattern CP is added to the pressing amount X [mm] obtained by applying an addition/subtraction value determined by the liquid application setting pattern Lp defined by the correlation between the fixing temperature and the conveyance distance to the operation amount of the liquid application member 501 defined by the thickness of the sheet P to which the liquid is applied and the number of sheets P constituting the sheet bundle Pb, and the liquid application is controlled with the adjusted value.

In the liquid application control pattern CP illustrated in FIG. 29, the addition/subtraction value is set, but an actual liquid application amount (liquid application+addition/subtraction value determined by the total conveyance distance and the fixing temperature) may be used.

A value obtained by applying the addition/subtraction value illustrated in FIG. 26 to the pressing amount X is γ [mm], and a value obtained by applying the addition/subtraction value illustrated in FIG. 26 to the liquid application time Y is ζ [ms]. In this case, when the first liquid application control pattern CP1 is set, the pressing amount of the second sheet is “γ+0=γ [mm]”. The liquid application time of the second sheet is “ζ+0=ζ [ms]”.

Similarly, when the fourth liquid application control pattern CP4 is set, the pressing amount of the second sheet is “γ−10=γ−10 [mm]”. In addition, the liquid application time for the second time is “ζ−5=ζ−5 [ms]”.

By the liquid application amount control described above, the liquid application control pattern can be switched and set according to the liquid content of the sheet P. Thus, even if the characteristics of the sheet P are not grasped in advance, it is possible to control liquid application to the sheet P that easily absorbs liquid in accordance with the characteristics. Thus, it is possible to generate the sheet bundle Pb securing an appropriate binding force.

### Flow of Process of Liquid Application Amount Control (Second Example)

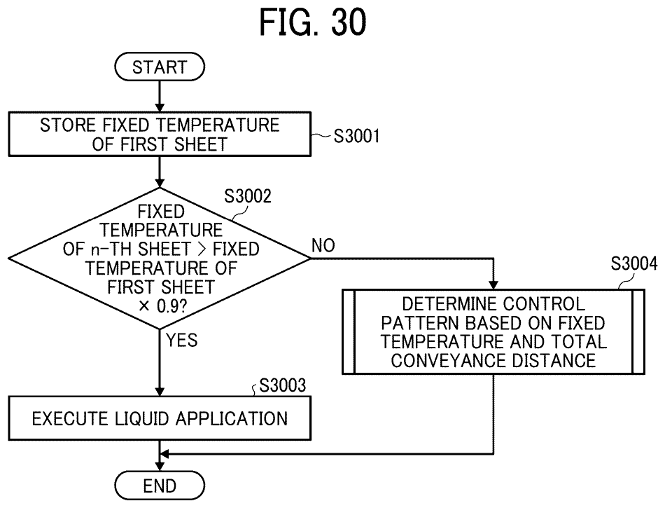

Another example of the flow of the liquid application amount control process implemented in the controller 100b included in the post-processing apparatuses 3c and 3d will be described with reference to FIG. 30.

The flowchart illustrated in FIG. 30 is a process of setting control of liquid application on the first sheet P from the fixing temperature and the total conveyance distance when execution of a job including the binding process with liquid application is started and liquid application is performed on the first sheet P constituting the sheet bundle Pb. The fixing temperature of the image forming apparatus 2 may change depending on continuous passing of a plurality of sheets P or an external factor. Therefore, in a case where the fixing temperature of the image forming apparatus 2 largely deviates from the fixing temperature of the first sheet (fixing CPM down), the process of reviewing the adjustment value is executed again by the correlation between the fixing temperature and the total conveyance distance illustrated in FIG. 22.

The controller 100b starts the binding process involving liquid application and stores the fixing temperature transmitted from the image forming apparatus 2 to the post-processing apparatus 3 in the storage area (step S3001). The fixing temperature in this case is “a° C.”.

Subsequently, since the fixing temperature for the second and subsequent sheets P is also transmitted from the image forming apparatus 2 to the post-processing apparatus 3 each time, the transmitted fixing temperature for the second and subsequent sheets P is compared with “a° C.” that is the fixing temperature for the first sheet (step S3002). In this case, a° C. that is the fixing temperature of the first sheet is a predetermined value of the sheet temperature.

The newly transmitted fixing temperature is compared with the fixing temperature of the first sheet, and it is determined whether or not the newly transmitted fixing temperature, that is, the fixing temperature of the second and subsequent sheets is lower than a° C. by 10% or more. When the difference is less than 10% (YES in step S3002), the same liquid application control is executed without changing the setting value and the adjustment value of the control (step S3003).

In step S3002, when the difference is equal to or more than 10% (NO in step S3002), that is, when the fixing temperature of the second and subsequent sheets P is lower than the fixing temperature (a° C.) of the first sheet P, the liquid application setting pattern Lp used to control the liquid application is updated. That is, the liquid application setting pattern Lp is set again based on the newly transmitted fixing temperature (step S3004), and the liquid application is executed (step S3003).

The threshold for determining the difference between the fixing temperatures exemplified above is an example, and the threshold is not limited thereto. In addition, the difference in fixing temperature is determined by the ratio (%), but a unique temperature may be used as a threshold. In the determination of the fixing temperature, the fixing temperature of the first sheet P is compared with the fixing temperatures of the second and subsequent sheets P, and a temperature that is a branch point of the liquid application pattern illustrated in FIG. 22 may be employed as the threshold.

By the liquid application control described above, it is possible to suppress an increase in manufacturing cost and perform appropriate liquid application control without adding a new sensor or the like to the post-processing apparatus 3.

### Flow of Process of Liquid Application Amount Control (Third Example)

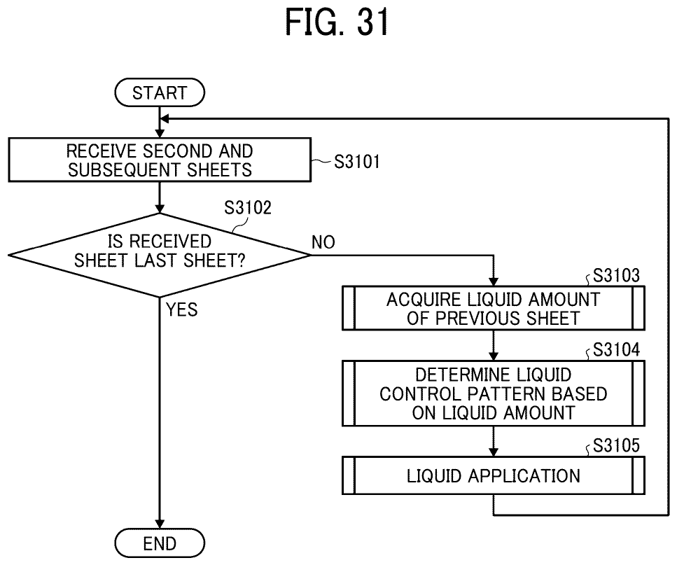

Another example of the flow of the liquid application amount control process implemented in the controller 100b included in the post-processing apparatuses 3c and 3d will be described with reference to FIG. 31. In the process of the liquid application amount control described above, when a job including liquid application crimp binding is executed in the controller 100b, the liquid content after the liquid is applied to the first sheet P constituting the sheet bundle Pb is acquired. Then, the liquid application amount in the liquid application to the second and subsequent sheets P is adjusted using the acquired liquid content of the first sheet P.

In the third example described below, the confirmation of the liquid content and the control pattern of the liquid application control pattern CP for the third and subsequent sheets P are determined by the liquid application amount control process according to the first example illustrated in FIG. 28 (including FIGS. 28A and 28B). In the present example, the liquid content is confirmed for each sheet P constituting the sheet bundle Pb. In addition, the addition/subtraction value of the liquid application is adjusted on the basis of the pressing amount and the liquid application time with respect to the sheet P before the sheet P to be detected.

As illustrated in FIG. 31, the second and subsequent sheets P are received (step S3101), and it is determined whether or not the sheet P to be determined is the last sheet of the liquid application crimp binding (step S3102). In step S3102, when the paper is the last paper (YES in step S3102), liquid application is not executed, and thus the process is ended.

In step S3102, when the sheet P is not the last paper (NO in step S3102), the liquid content is acquired using the liquid application amount detection sensor 95 for the sheet P immediately before the sheet P to be processed (step S3103).

Subsequently, the determination process of the liquid application control pattern CP described with reference to FIG. 28 (including FIGS. 28A and 28B) is executed with respect to the liquid content acquired in step 3103, and a specific liquid application control pattern CP is set (step S3104).

Subsequently, based on the set liquid application control pattern CP, the adjustment amount is specified with reference to the table data illustrated in FIG. 29, the liquid application amount is set in consideration of the adjustment amount, and the liquid application is performed (step S3105). The process from S3101 to S3105 is repeatedly executed until the last sheet is obtained. This makes it possible to perform highly accurate and appropriate liquid application.

By the process according to the present example, the number of sheets is increased by adding or subtracting the liquid application to or from the previous sheet P, whereby adjustment with high accuracy can be performed. Further, even when the lot difference or the type of the sheet P stored in the sheet tray 211 is changed, the optimum liquid application can be performed.

### Flow of Process of Liquid Application Amount Control (Fourth Example)

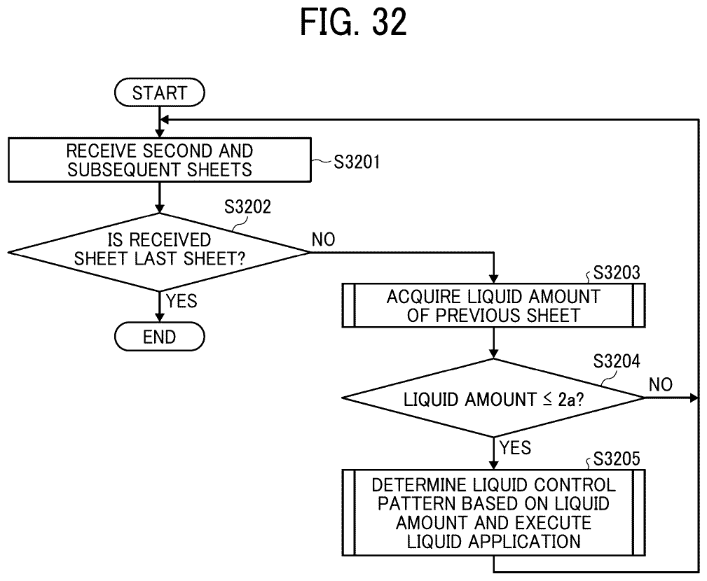

Another example of the flow of the liquid application amount control process implemented in the controller 100b included in the post-processing apparatuses 3c and 3d will be described with reference to FIG. 32. In the liquid application amount control process according to the third example described above, adjustment to reduce the liquid application amount is performed for each of the sheets P when the liquid content is large.

In the liquid application control process according to the present example, the control is switched so that the liquid application is executed every several sheets, instead of decreasing the liquid application amount when the liquid content with respect to the sheet-like sheet P is large. For example, control is performed so that the liquid is applied to an even number of sheets and liquid is not applied to an odd number of sheets. Control may be performed so that the liquid is applied to an odd number of sheets and no liquid is applied to an even number of sheets.

As illustrated in FIG. 32, the second and subsequent sheets P are received (step S3201), and it is determined whether or not the sheet P to be determined is the last sheet of the liquid application crimp binding (step S3202). In step S3202, when the paper is the last sheet (YES in step S3202), the liquid application is not executed, and thus the process is ended.

In step S3202, when the sheet P is not the last sheet (NO in step S3202), the liquid content is acquired using the liquid application amount detection sensor 95 for the sheet P immediately before the sheet P to be processed (step S3203).

Subsequently, it is determined whether or not the liquid content acquired in step 3103 is less than twice the appropriate amount α [%] of the liquid content (step S3204). In step S3204, when the liquid content is less than twice the appropriate amount α (YES in step S3204), the liquid application is performed by the setting based on the liquid application control pattern CP illustrated in FIG. 29 (step S3205).

In step S3204, when the liquid content is not less than 2 twice the appropriate amount α (NO in step S3204), the process returns to step S3201 without applying the liquid. That is, the liquid application is not performed when the liquid content is too large with respect to the appropriate amount α, and the liquid application is controlled to be performed when the liquid content is within an allowable range with respect to the appropriate amount α. It is thus possible to suppress an excessive application of liquid. The sheet P on which the liquid application has not been performed absorbs a part of the liquid on the sheet P on which the liquid application has been performed, thereby replacing the liquid application.

The determination condition (whether or not it is less than twice the appropriate amount α) in step S3204 is an example and is not limited thereto. The determination condition may be a magnification with respect to the appropriate amount α, or the difference may be determined by a fixed value.

By the liquid application control process according to the present example, by applying the liquid every several sheets when the liquid application amount is large, the liquid content of the sheet P on which the liquid application is large is adjusted by the sheet P on which the liquid is not applied, and excessive liquid application can be prevented. Thus, the optimum liquid application amount can be implemented in units of the sheet bundle Pb, and the binding force can be secured.

By the liquid application control process according to the present embodiment described above, with respect to the liquid application process of bringing the liquid application member 501 into contact with the sheet P in the post-processing apparatus 3, a unit (liquid application amount detection sensor 95) that detects the amount of liquid absorbed by the sheet P by the liquid application and a unit that changes the liquid application control according to the amount of liquid absorbed by the sheet P are provided. Thus, it is possible to achieve liquid application corresponding to different liquid absorption characteristics depending on the type of sheet P (sheet type). At the same time, it is possible to implement the liquid application corresponding to different liquid absorption characteristics, which are different even when being the same paper type depending on a year, a lot, and a storage environment of a sheet P as well as a fixing temperature in an apparatus main body and a conveyance distance to (conveyance time until) the liquid application.

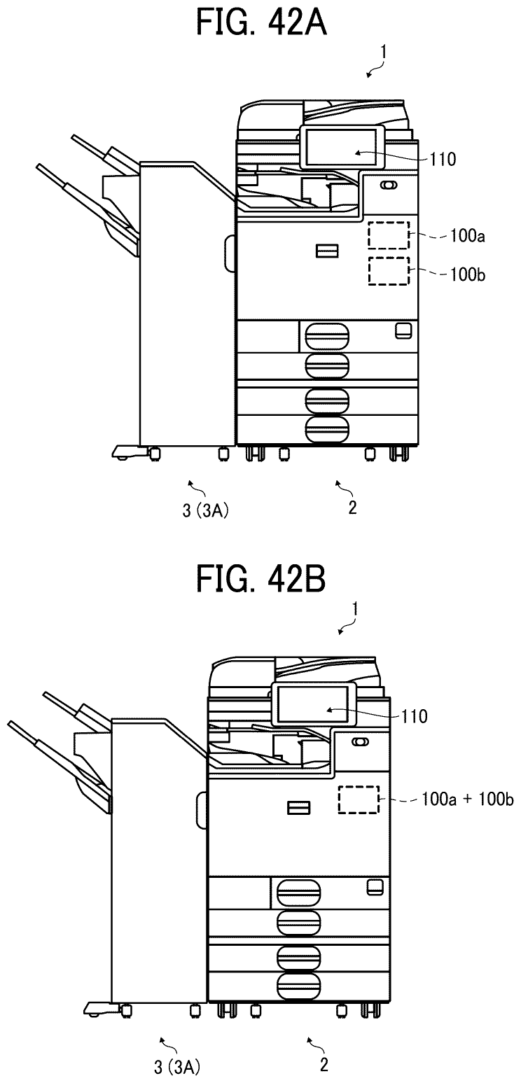

In the above description, the controller 100b of the post-processing apparatus 3 is provided separately from the controller 100a of the image forming apparatus 2 as illustrated in FIG. 1. However, embodiments of the present disclosure are not limited to the above-described configuration. For example, as illustrated in FIG. 42A, the controller 100b of the post-processing apparatus 3 may be disposed on the side of the image forming apparatus 2. Further, as illustrated in FIG. 42B, the controller 100b of the post-processing apparatus 3 may be integrated with the controller 100a of the image forming apparatus 2.

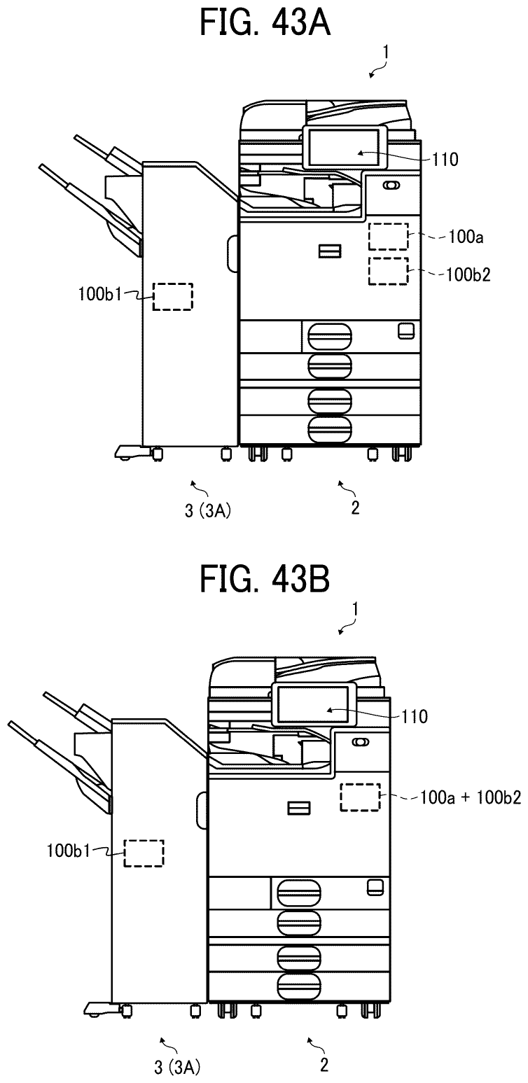

As illustrated in FIG. 43A, the controller 100b of the post-processing apparatus 3 may be divided into a controller 100b1 (e.g., a drive unit such as a motor) and a controller 100b2 (a detector such as a sensor) according to the function, and the controller 100b2 of the post-processing apparatus 3 may be disposed on the side of the image forming apparatus 2. Further, as illustrated in FIG. 43B, the controller 100b2 of the post-processing apparatus 3 disposed on the side of the image forming apparatus 2 may be integrated with the controller 100a of the image forming apparatus 2.

### Second Embodiment of Post-Processing Apparatus

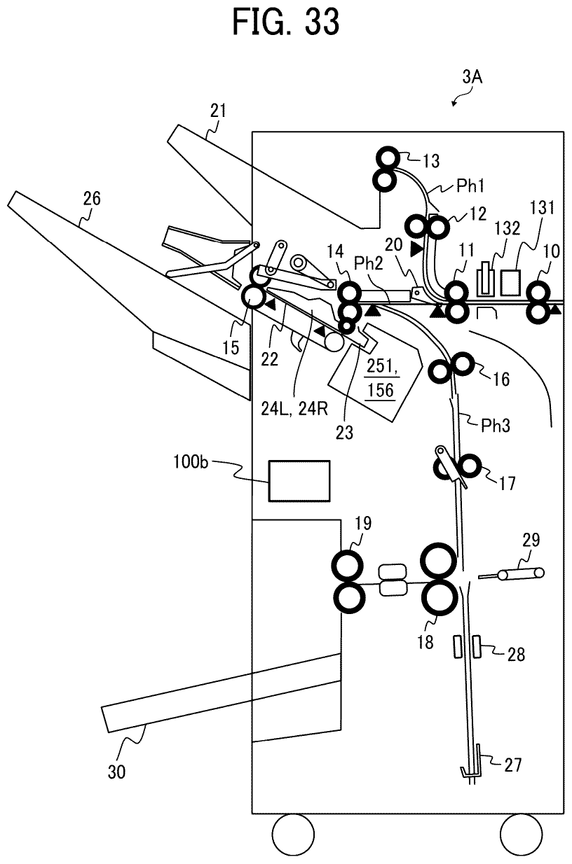

Referring now to FIGS. 33 to 41, a description is given of a post-processing apparatus 3A according to a second embodiment.

Components common to those of the post-processing apparatus 3 according to the first embodiment are denoted by the same reference numerals, and a detailed description thereof may be omitted.

The post-processing apparatus 3A according to the second embodiment includes an edge binder 251. The edge binder 251 is different from the edge binder 25 of the post-processing apparatus 3 according to the first embodiment, in which the liquid applier 31 and the crimper 32 are arranged side by side, in that the edge binder 251 includes a crimper 32′ and a liquid applier 131 is provided on the upstream side of a conveyance path. Such a configuration allows a given number of sheets P to be stacked after the liquid application process and conveyed to the crimper 32′ of the edge binder 251 disposed downstream. Accordingly, the productivity of the binding process performed by the crimper 32′ is improved.

The direction in which the conveyance roller pairs 10, 11, and 14 convey the sheet P is a direction opposite to the “conveyance direction” defined in the above description, and therefore is defined as an “opposite conveyance direction.” A direction that is orthogonal to both the opposite conveyance direction and the thickness direction of the sheet P is defined as the “main scanning direction” or the “width direction of the sheet P.” The liquid application position to which liquid is applied on a sheet P or a sheet bundle Pb by the liquid applier 131 corresponds to the binding position on the sheet bundle Pb to be crimped by the crimper 32′. For this reason, in the following description, the liquid application position and the binding position are described with the same reference sign (B1).

FIG. 33 is a diagram illustrating an internal configuration of the post-processing apparatus 3A according to the second embodiment of the present disclosure.

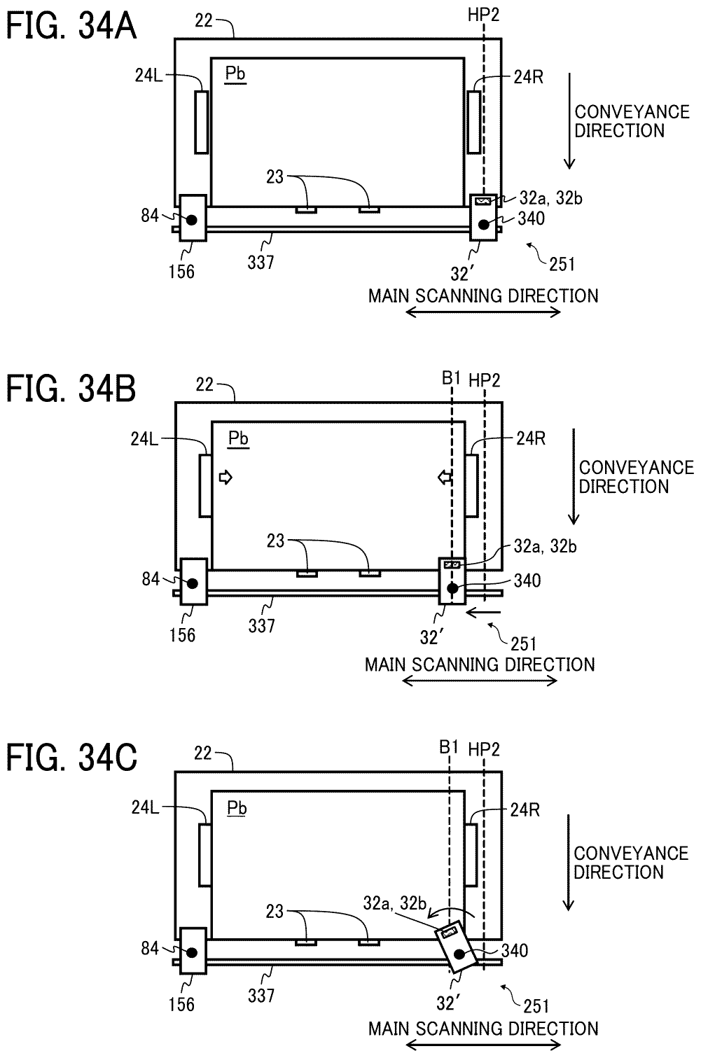

As illustrated in FIGS. 34A, 34B, and 34C, the edge binder 251 includes the crimper 32′ alone. As illustrated in FIGS. 34A, 34B, and 34C, the crimper 32′ and the staple binder 156 are disposed downstream from the internal tray 22 in the conveyance direction. In addition, the crimper 32′ and the staple binder 156 are located to face a downstream end, in the conveyance direction, of the sheet bundle Pb placed on the internal tray 22 and is movable in the main scanning direction.

Further, the crimper 32′ and the staple binder 156 are rotatable in the forward and reverse directions about a crimper shaft 340 and a stapler shaft 84 extending in the thickness direction of the sheet bundle Pb placed on the internal tray 22. In other words, the crimper 32′ and the staple binder 156 bind, at a desired angle, a desired position in the main scanning direction on the sheet bundle Pb placed on the internal tray 22 as in, for example, corner inclined binding, parallel one-point binding, or parallel two-point binding.

The crimper 32′ presses and deforms the sheet bundle Pb with the serrate upper crimping teeth 32a and the serrate lower crimping teeth 32b to bind the sheet bundle Pb (hereinafter denoted as “crimping”). On the other hand, the staple binder 156 passes the staple through a binding position on the sheet bundle Pb placed on the internal tray 22, thus allowing the sheet bundle Pb to be stapled.

Each of FIGS. 34A, 34B, and 34C is a schematic view of the internal tray 22 in the thickness direction of the sheet bundle Pb.

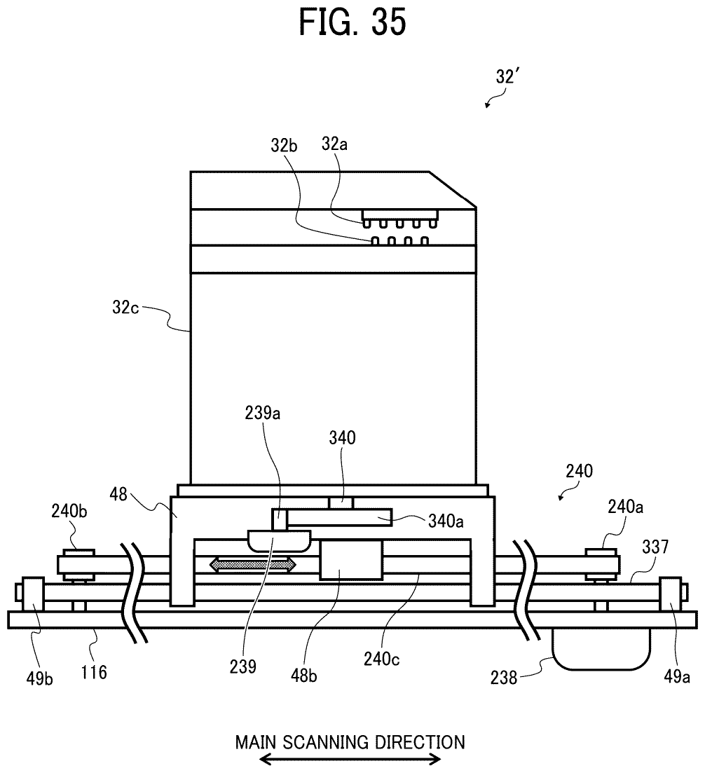

FIG. 35 is a schematic view of the crimper 32′ as viewed from the downstream side in the conveyance direction.

As illustrated in FIGS. 34A, 34B, and 34C, the crimper 32′ and the staple binder 156 are disposed downstream from the internal tray 22 in the conveyance direction. The crimper 32′ is movable in the main scanning direction along the surface of the sheet bundle Pb placed on the internal tray 22. The crimper 32′ is rotatable in the forward and reverse directions about the crimper shaft 340 extending in the thickness direction of the sheet bundle Pb placed on the internal tray 22.

Similarly, the staple binder 156 is movable in the main scanning direction of the sheet bundle Pb. Further, the staple binder 156 is rotatable in the forward and reverse directions about a stapler shaft 84 extending in thickness direction of the sheet bundle Pb. The other components of the staple binder 156 are similar to, even if not the same as, those of the staple binder 155 (see FIG. 9) of the post-processing apparatus 3 according to the first embodiment. For this reason, a detailed description thereof is omitted.

As illustrated in FIG. 35, the crimper 32′ includes a guide rail 337 extending in the main scanning direction at a position downstream from the internal tray 22 in the conveyance direction. The crimper 32′ includes a crimper movement motor 238 as a driving source. The base 48 supporting the crimping frame 32c has a fastening portion 48b for fastening the timing belt 240c at the bottom of the base 48. The driving force of the crimper movement motor 238 is transmitted to the base 48 by the drive transmission assembly 240 that includes the pullies 240a and 240b, the timing belt 240c, and the fastening portion 48b. By so doing, the crimper 32′ is moved in the main scanning direction along the surface of the sheet bundle Pb placed on the internal tray 22, in other words, along the guide rail 337. The crimper shaft 340 including a drive transmission gear 340a is fixed to a bottom face of the crimping frame 32c that holds the components of the crimper 32′.

The crimper shaft 340 and the drive transmission gear 340a are held by the base 48 on which the crimping frame 32c is disposed, so as to be rotatable in the forward and reverse directions. The drive transmission gear 340a meshes with an output gear 239a of a crimper pivot motor 239. When the driving force of the crimper pivot motor 239 is transmitted to the crimper shaft 340 via the output gear 239a and the drive transmission gear 340a, the crimper 32′ rotates in the forward and reverse directions on the base 48 about the crimper shaft 340 extending in the thickness direction of the sheet P placed on the internal tray 22. The guide rail 337, the crimper movement motor 238, the crimper pivot motor 239, the crimper shaft 340, and the drive transmission assembly 240 constitute an example of a driving assembly of the crimper 32′.

The crimper 32′ is movable between a standby position HP2 illustrated in FIG. 34A and a position where the crimper 32′ faces the first binding position B1 illustrated in FIGS. 34B and 34C. The standby position HP2 is a position deviated to one side in the main scanning direction from the sheet bundle Pb stacked on the internal tray 22. The first binding position B1 is a position on the sheet bundle Pb placed on the internal tray 22. Here, the specific position of the first binding position B1 is not limited to the example of FIGS. 34A to 34C, and may be any position in the main scanning direction at the downstream end in the conveyance direction of the sheet P, and may be a plurality of positions.

The posture of the crimper 32′ changes between a parallel binding posture illustrated in FIG. 34B and an inclined binding posture illustrated in FIG. 34C. In other words, the crimper 32′ is rotatable in the forward and reverse directions about the crimper shaft 340. The parallel binding posture is a posture of the crimper 32′ in which the longitudinal direction of the upper crimping teeth 32a and the lower crimping teeth 32b (in other words, a rectangular crimp binding trace) is along the main scanning direction. The inclined binding posture is a posture of the crimper 32′ in which the longitudinal direction of the upper crimping teeth 32a and the lower crimping teeth 32b (in other words, the rectangular crimp binding trace) is inclined with respect to the main scanning direction.

The rotational angle, which is an angle of the upper crimping teeth 32a and the lower crimping teeth 32b with respect to the main scanning direction, in the inclined binding posture is not limited to the angle illustrated in FIG. 34C, and may be any angle provided that the upper crimping teeth 32a and the lower crimping teeth 32b face the sheet bundle Pb placed on the internal tray 22.

The post-processing apparatus 3A includes the liquid applier 131 and a hole punch 132 (post-processing device). The liquid applier 131 and the hole punch 132 are disposed upstream from the internal tray 22 in the opposite conveyance direction. In addition, the liquid applier 131 and the hole punch 132 are disposed to be shifted from each other in the opposite conveyance direction at positions at which the liquid applier 131 and the hole punch 132 can simultaneously face one sheet P that is conveyed by the conveyance roller pairs 10 to 19.

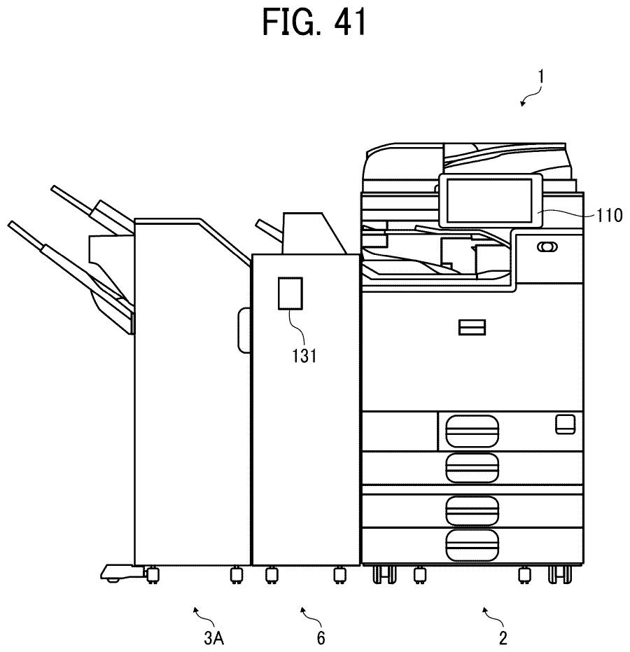

The liquid applier 131 and the hole punch 132 according to the present embodiment are disposed between the conveyance roller pairs 10 and 11. However, the arrangement of the liquid applier 131 is not limited to the example of FIG. 33. For example, in a case where an inserter 6 is disposed between the image forming apparatus 2 and the post-processing apparatus 3A as illustrated in FIG. 41, the liquid applier 131 may be disposed inside the inserter 6 located upstream from the post-processing apparatus 3A. Examples of the inserter 6 include, but are not limited to, an apparatus that allows a pre-printed medium, which is to be conveyed to the post-processing apparatus 3A together with the sheet P conveyed from the image forming apparatus 2, to be fed as a cover sheet, an insertion sheet, or a partition sheet without passing through the image forming apparatus 2.

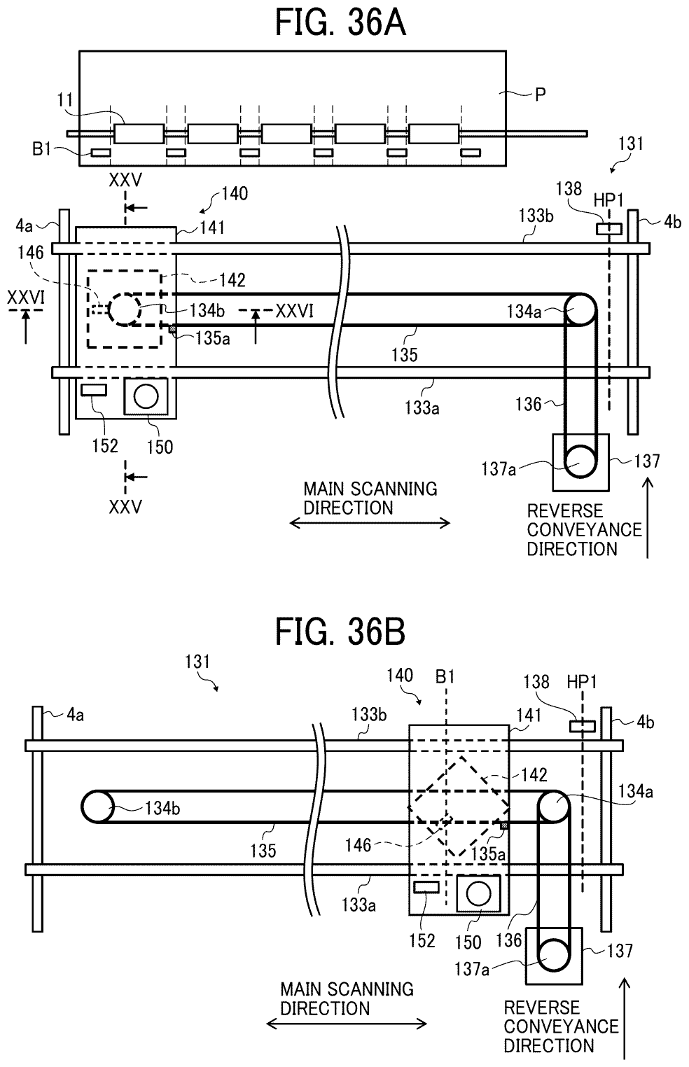

As illustrated in FIG. 36A, the conveyance roller pair 11 is located so as not to overlap, in the main scanning direction, the first liquid application position B1 on the sheet P to which the liquid has been applied by a liquid application head 146 of the liquid applier 131. This arrangement is to prevent the amount of liquid at the first liquid application position B1 from decreasing due to the multiple roller pairs pressing the first liquid application position B1 when the conveyance roller pair 11 conveys the sheet P. As a result, when the sheet P reaches the crimper 32′ disposed downstream from the liquid applier 131 in the opposite conveyance direction, the amount of liquid at the first liquid application position B1 is sufficient to maintain the binding strength. Accordingly, the binding strength of the sheet bundle Pb is prevented from decreasing due to a decrease in the amount of liquid at the first liquid application position B1 (corresponding to the first binding position B1) while the sheet P is conveyed.

In addition, the multiple roller pairs of the conveyance roller pair 11 that is located so as not to overlap the first liquid application position B1 on the sheet P in the main scanning direction prevents the conveying performance of the sheet P from being worse due to the adhesion of liquid to the multiple roller pairs and further prevents a conveyance jam caused by the worsened conveying performance of the sheet P.

Although only the conveyance roller pair 11 has been described above, the multiple roller pairs of the conveyance roller pairs 14 and 15 are preferably located so as not to overlap the first liquid application position B1 on the sheet P in the main scanning direction, like the multiple roller pairs of the conveyance roller pair 11.

The liquid applier 131 applies liquid to the sheet P that is conveyed by the conveyance roller pairs 10 and 11 (hereinafter denoted as “liquid application”). The hole punch 132 punches a hole in the sheet P that is conveyed by the conveyance roller pairs 10 and 11 so that the hole passes through the sheet P in the thickness direction of the sheet P. The processing device disposed near the liquid applier 131 is not limited to the hole punch 132, and may be an inclination corrector that corrects an inclination (skew) of the sheet P that is conveyed by the conveyance roller pairs 10 and 11.

FIGS. 36A and 36B are views of the liquid applier 131 in the thickness direction of the sheet P, according to the second embodiment of the present disclosure.

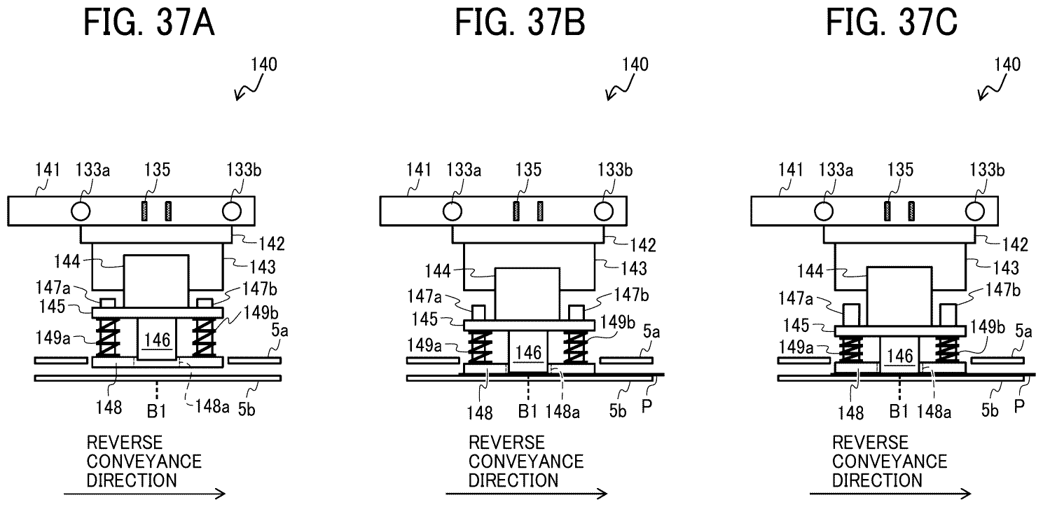

FIGS. 37A, 37B, and 37C are cross-sectional views taken along line XXV-XXV of FIG. 36A.

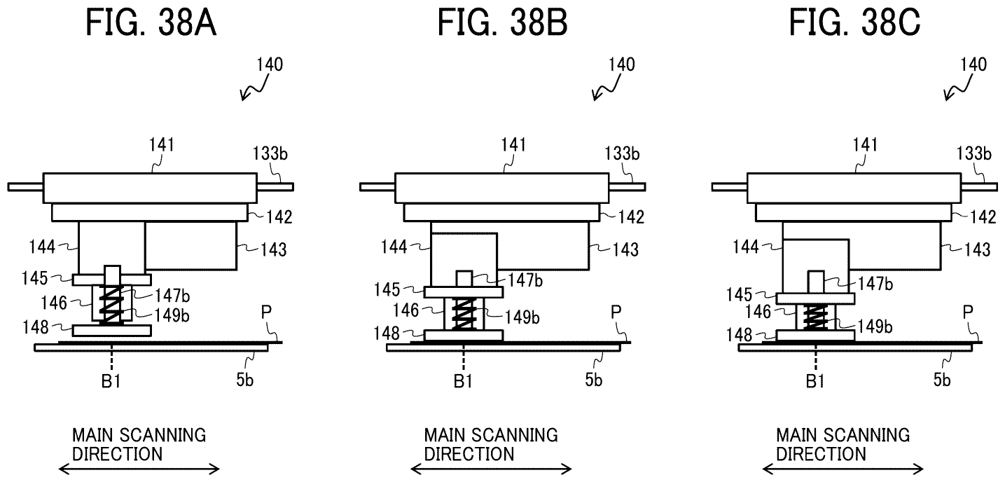

FIGS. 38A, 38B, and 38C are cross-sectional views taken along line XXVI-XXVI of FIG. 36A.

As illustrated in FIGS. 36A to 38C, the liquid applier 131 includes a pair of guide shafts 133a and 133b, a pair of pulleys 134a and 134b, endless annular belts 135 and 136, a liquid applier movement motor 137, a standby position sensor 138, and a liquid application unit 140.

The pair of guide shafts 133a and 133b each extend in the main scanning direction at positions spaced apart from each other in the opposite conveyance direction. The pair of guide shafts 133a and 133b are supported by a pair of side plates 4a and 4b of the post-processing apparatus 3A. The pair of guide shafts 133a and 133b support the liquid application unit 140 so that the liquid application unit 140 can move in the main scanning direction.

The pair of pulleys 134a and 134b is disposed between the guide shafts 133a and 133b in the opposite conveyance direction. The pair of pulleys 134a and 134b are spaced apart from each other in the main scanning direction. The pulleys 134a and 134b are supported by a frame of the post-processing apparatus 3A so as to be rotatable in the forward and reverse directions about the respective shafts extending in the thickness direction of the sheet P.

The endless annular belt 135 is looped around the pair of pulleys 134a and 134b. The endless annular belt 135 is coupled to the liquid application unit 140 by a coupling portion 135a. The endless annular belt 136 is entrained around the pulley 134a and a driving pulley 137a that is fixed to an output shaft of the liquid applier movement motor 137. The liquid applier movement motor 137 generates a driving force for moving the liquid application unit 140 in the main scanning direction.

As the liquid applier movement motor 137 rotates, the endless annular belt 136 circulates between the pulley 134a and the driving pulley 137a to rotate the pulley 134a. As the pulley 134a rotates, the endless annular belt 135 circulates around the pair of pulleys 134a and 134b. Thus, the liquid application unit 140 moves in the main scanning direction along the pair of guide shafts 133a and 133b. The rotation direction of the liquid applier movement motor 137 is switched to reciprocate the liquid application unit 140 in the main scanning direction.

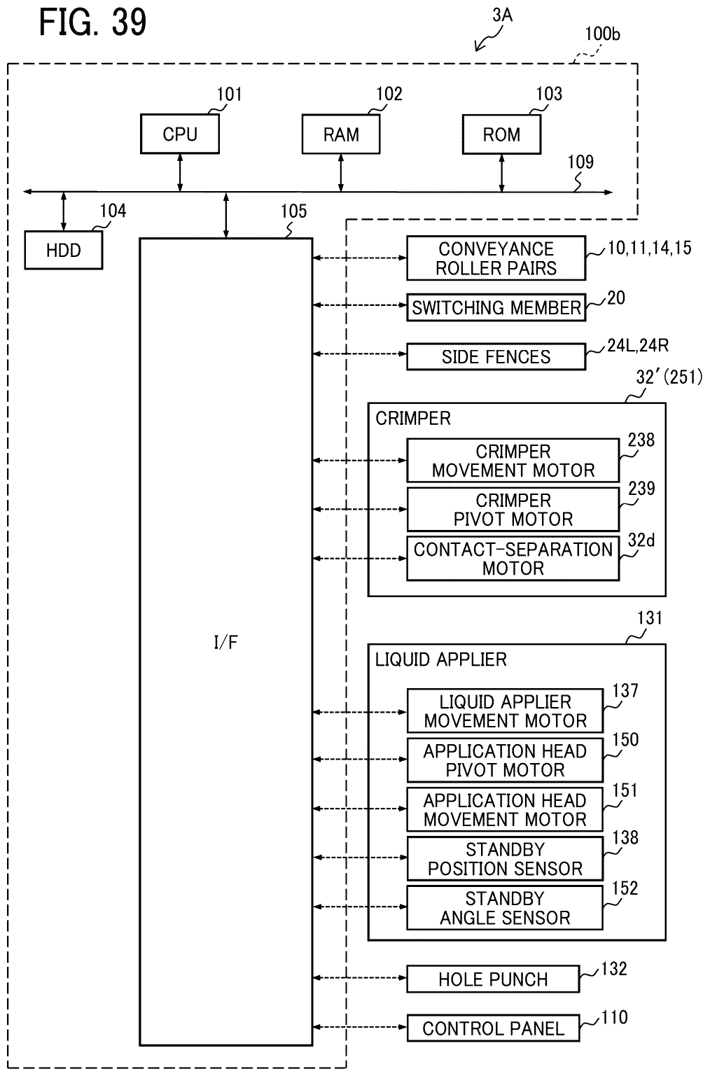

The standby position sensor 138 detects that the liquid application unit 140 has reached a standby position HP1 in the main scanning direction (see FIGS. 36A and 36B), and outputs a standby position signal indicating a detection result to a controller 100b to be described later (see FIG. 39). The standby position sensor 138 is, for example, an optical sensor including a light emitter and a light receiver. At the standby position HP1, the liquid application unit 140 blocks an optical path between the light emitter and the light receiver. The standby position sensor 138 outputs the standby position signal in response to the light output from the light emitter not being received by the light receiver. The specific configuration of the standby position sensor 138 is not limited to the configuration described above.

As illustrated in FIGS. 37A to 37C, the conveyance path inside the post-processing apparatus 3A is defined by an upper guide plate 5a and a lower guide plate 5b, which are apart from each other in the thickness direction of the sheet P. The liquid application unit 140 is located to face an opening of the upper guide plate 5a. In other words, the liquid application unit 140 is disposed to face the conveyance path (a position at which the liquid application unit 140 can face the sheet P) through the opening of the upper guide plate 5a.

As illustrated in FIGS. 36A to 38C, the liquid application unit 140 includes a base 141, a rotary bracket 142, a liquid storage tank 143, an application head mover 144, a holder 145, the liquid application head 146, columns 147a and 147b, a pressure plate 148, coil springs 149a and 149b, an application head pivot motor 150, an application head movement motor 151 (see FIG. 39), and a standby angle sensor 152 (see FIG. 39).

The base 141 is supported by the pair of guide shafts 133a and 133b so as to be slidable in the main scanning direction. The base 141 is coupled to the endless annular belt 135 by the coupling portion 135a. The base 141 supports the components (e.g., the rotary bracket 142 to the standby angle sensor 152) of the liquid application unit 140.

The rotary bracket 142 is attached to the lower face of the base 141 so as to be rotatable in the forward and reverse directions about an axis extending in the thickness direction of the sheet P. The rotary bracket 142 is rotated with respect to the base 141 by a driving force transmitted from the application head pivot motor 150. The rotary bracket 142 retains the liquid storage tank 143, the application head mover 144, the holder 145, the liquid application head 146, the columns 147a and 147b, the pressure plate 148, and the coil springs 149a and 149b.

The standby angle sensor 152, which is also illustrated in FIG. 39, detects that the rotary bracket 142 has reached a standby angle. The standby angle sensor 152 then outputs a standby angle signal indicating the detection result to the controller 100b. The standby angle is, for example, an angle for the parallel binding. The standby angle sensor 152 is, for example, an optical sensor including a light emitter and a light receiver. The rotary bracket 142 at the standby angle blocks an optical path between the light emitter and the light receiver. The standby angle sensor 152 outputs the standby angle signal in response to the light output from the light emitter not being received by the light receiver. However, the specific configuration of the standby angle sensor 152 is not limited to the above-described example.

FIG. 36A illustrates the rotary bracket 142 in a position for the parallel binding that is performed by the crimper 32′ disposed downstream from the liquid applier 131.

FIG. 36B illustrates the rotary bracket 142 in a position for the inclined binding (i.e., corner binding) that is performed by the crimper 32′ disposed downstream from the liquid applier 131.

The liquid storage tank 143 stores liquid to be applied to the sheet P. The application head mover 144 is attached by the liquid storage tank 143 so as to be movable (e.g., up and down) in the thickness direction of the sheet P. The application head mover 144 is moved with respect to the liquid storage tank 143 by a driving force transmitted from the application head movement motor 151. The holder 145 is attached to a lower end of the application head mover 144. The liquid application head 146 projects from the holder 145 toward the conveyance path (downward in the present embodiment). The liquid that is stored in the liquid storage tank 143 is supplied to the liquid application head 146. The liquid application head 146 is made of a material having a high liquid absorption (e.g., sponge or fiber).

The columns 147a and 147b project downward from the holder 145 around the liquid application head 146. The columns 147a and 147b are movable relative to the holder 145 in the thickness direction. The columns 147a and 147b have respective lower ends holding the pressure plate 148. The pressure plate 148 has a through hole 148a at a position where the through hole 148a faces the liquid application head 146. The coil springs 149a and 149b are fitted around the columns 147a and 147b, respectively, between the holder 145 and the pressure plate 148. The coil springs 149a and 149b bias the columns 147a and 147b and the pressure plate 148 in a direction away from the holder 145.

As illustrated in FIGS. 37A and 38A, before the sheet P is conveyed to the position where the sheet P faces the opening of the upper guide plate 5a, the pressure plate 148 is positioned at or above the opening. Subsequently, when the sheet P that is conveyed by the conveyance roller pairs 10 and 11 stops at a position where the first liquid application position B1 on the sheet P faces the opening, the application head movement motor 151 is rotated in a first direction. Thus, the application head mover 144, the holder 145, the liquid application head 146, the columns 147a and 147b, the pressure plate 148, and the coil springs 149a and 149b are moved down together to allow the pressure plate 148 to contact the sheet P. The first liquid application position B1 is a position (that is, the first binding position B1) scheduled to be crimped and bound by the edge binder 251 (that is, the crimper 32′).

As the application head movement motor 151 keeps rotating in the first direction after the pressure plate 148 contacts the sheet P, the coil springs 149a and 149b are compressed to further move down the application head mover 144, the holder 145, the liquid application head 146, and the columns 147a and 147b. As illustrated in FIGS. 37B and 38B, a lower face of the liquid application head 146 contacts the sheet P through the through hole 148a. As a result, the liquid contained in the liquid application head 146 is applied to the sheet P.

Further rotation of the application head movement motor 151 in the first direction further strongly presses the liquid application head 146 against the sheet P as illustrated in FIGS. 37C and 38C. Accordingly, the amount of liquid that is applied to the sheet P increases. In short, the liquid applier 131 changes the pressing force of the liquid application head 146 against the sheet P to adjust the amount of liquid applied to the sheet P.

On the other hand, the rotation of the application head movement motor 151 in the second direction opposite to the first direction moves up the application head mover 144, the holder 145, the liquid application head 146, the columns 147a and 147b, the pressure plate 148, and the coil springs 149a and 149b together. Thus, as illustrated in FIGS. 37A and 38A, the liquid application head 146 and the pressure plate 148 are separated from the sheet P. In other words, the liquid applier 131 includes the liquid application head 146 that can be separated from the sheet P.

FIG. 39 is a block diagram illustrating a hardware configuration of the control block of the post-processing apparatus 3A to control the operation of the post-processing apparatus 3A according to the second embodiment of the present disclosure.

As illustrated in FIG. 39, the post-processing apparatus 3A includes a central processing unit (CPU) 101, a random access memory (RAM) 102, a read only memory (ROM) 103, a hard disk drive (HDD) 104, and an interface (I/F) 105. The CPU 101, the RAM 102, the ROM 103, the HDD 104, and the I/F 105 are connected to each other via a common bus 109.

The CPU 101 is an arithmetic unit and controls the overall operation of the post-processing apparatus 3A. The RAM 102 is a volatile storage medium that allows data to be read and written at high speed. The CPU 101 uses the RAM 102 as a working area for data processing. The ROM 103 is a read-only non-volatile storage medium that stores programs such as firmware. The HDD 104 is a non-volatile storage medium that allows data to be read and written and has a relatively large storage capacity. The HDD 104 stores, for example, an operating system (OS), various control programs, and application programs.

The post-processing apparatus 3A processes, by an arithmetic function of the CPU 101, e.g., a control program stored in the ROM 103 and an information processing program (or application program) loaded into the RAM 102 from a storage medium such as the HDD 104. Such processing configures a software controller including various functional modules of the post-processing apparatus 3A. The software controller thus configured cooperates with hardware resources of the post-processing apparatus 3A to construct functional blocks that implement functions of the post-processing apparatus 3A. In other words, the CPU 101, the RAM 102, the ROM 103, the HDD 104, and the I/F 105 constitute at least part of a controller 100b (control unit) serving as a control device that controls the operation of the post-processing apparatus 3A.

The I/F 105 is an interface that connects the conveyance roller pairs 10, 11, 14, and 15, the switching member 20, the side fences 24L and 24R, the crimper movement motor 238, the crimper pivot motor 239, a contact-separation motor 32d, the liquid applier movement motor 137, the application head pivot motor 150, the application head movement motor 151, the standby position sensor 138, the standby angle sensor 152, the hole punch 132, and the control panel 110 to the common bus 109.

The controller 100b controls, via the I/F 105, the operations of the conveyance roller pairs 10, 11, 14, and 15, the switching member 20, the side fences 24L and 24R, the crimper movement motor 238, the crimper pivot motor 239, the contact-separation motor 32d, the liquid applier movement motor 137, the application head pivot motor 150, the application head movement motor 151, and the hole punch 132. The controller 100b acquires detection results from the standby position sensor 138 and the standby angle sensor 152 through the I/F 105.

Although FIG. 39 illustrates the components of the liquid applier 131 and the edge binder 251 (the crimper 32′) that executes the edge binding, the components of the saddle binder 28 that executes the saddle binding process are controlled by the controller 100b like the components of the liquid applier 131 and the edge binder 251 (the crimper 32′) that executes the edge binding process.

As illustrated in FIG. 41, the image forming apparatus 2 includes the control panel 110. The control panel 110 includes an operation unit that receives instructions input by a user and a display serving as a notifier that notifies the operator of information. The operation unit includes, for example, physical input buttons and a touch screen overlaid on a display. The control panel 110 acquires information from the user through the operation unit and provides the information to the user through the display. The post-processing apparatus 3A may include an control panel 110 similar to the above-described control panel 110.

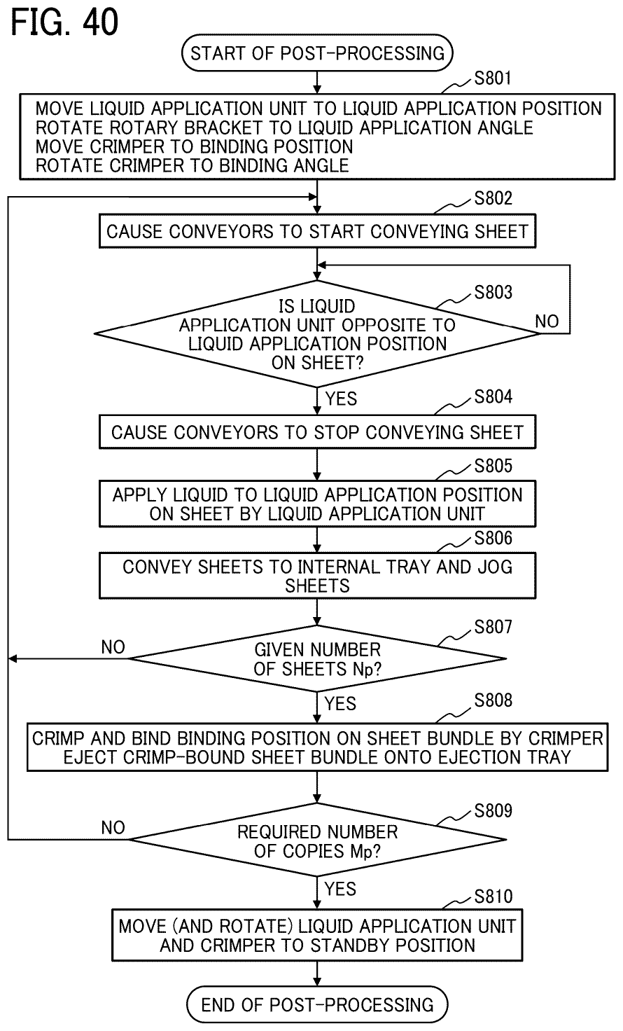

FIG. 40 is a flowchart of post-processing performed by the post-processing apparatus 3A according to the second embodiment.

Specifically, FIG. 40 is a flowchart in executing the one-point binding process illustrated in FIGS. 34A to 34C.

For example, the controller 100b executes the post-processing operation illustrated in FIG. 40 when the controller 100b acquires an instruction to execute the post-processing operation from the image forming apparatus 2. In the following description, the instruction to execute the post-processing operation may be referred to as a “post-processing command”. The post-processing command includes, for example, the number of sheets P of the sheet bundle Pb (hereinafter, referred to as “given number Np of sheets”), the number of copies of the sheet bundle Pb on which the binding process is to be executed (hereinafter, referred to as “requested number Mp of copies”), the first binding position B1 (corresponding to the first liquid application position B1), the angle of the first binding position B1 (corresponding to the angle of the first liquid application position B1), the type of the binding process (parallel binding process and oblique binding process), and the process (in the present embodiment, drilling a punch hole) executed in parallel with the liquid application process. At the start of the post-processing operation, the liquid application unit 140 is at the standby position HP1 illustrated in FIGS. 36A and 36B, and the rotary bracket 142 is held at the standby angle (corresponding to the parallel binding posture) at the standby position HP1.

First, the controller 100b drives the liquid applier movement motor 137 to move the liquid application unit 140 (corresponding to the liquid applier) in the main scanning direction, so that the liquid application head 146 moves from the standby position HP1 to a position where the liquid application head 146 faces the first liquid application position B1 (see FIG. 36B, the position corresponding to the first binding position B1 illustrated in FIGS. 34B and 34C). If the type of the binding process instructed by the post-processing command is “inclined binding process”, in step S801, the controller 100b drives the application head pivot motor 150 to rotate the rotary bracket 142. Thus, the liquid application head 146 is rotated from the standby angle to the liquid application angle corresponding to the “inclined binding posture”. It is ascertained, based on a pulse signal output from a rotary encoder of the liquid applier movement motor 137, that the liquid application head 146 has reached the position where the liquid application head 146 can face the first liquid application position B1. Similarly, it is ascertained, based on a pulse signal output from a rotary encoder of the application head pivot motor 150, that the liquid application head 146 has reached the liquid application angle. If the type of the binding process instructed by the post-processing command is “parallel binding process”, the controller 100b omits the above-described operation of rotating the rotary bracket 142. In other words, the liquid application unit 140 moves in the main scanning direction while holding the rotary bracket 142 at the standby angle.

Further, the controller 100b drives the crimper movement motor 238 to move the crimper 32′ from the standby position HP2 to the position where the crimper 32′ can face the first binding position B1 as illustrated in FIGS. 32A and 32B (step S801). Alternatively, if the type of the binding process instructed by the post-processing command is “inclined binding process”, the controller 100b drives the crimper pivot motor 239 to rotate the crimper 32′ from the standby angle to the crimping angle corresponding to the “inclined binding posture” (step S801). It is ascertained, based on a pulse signal output from a rotary encoder of the crimper movement motor 238, that the crimper 32′ has reached the position where the crimper 32′ can face the first binding position B1. Similarly, it is ascertained, based on a pulse signal output from a rotary encoder of the crimper pivot motor 239, that the crimper 32′ has reached the crimping angle. If the type of the binding process instructed by the post-processing command is “parallel binding process”, the controller 100b omits the above-described operation of rotating the crimper 32′. In other words, the crimper 32′ moves in the main scanning direction while maintaining the standby angle.

Subsequently, the controller 100b drives the conveyance roller pairs 10 and 11 to start conveying the sheet P on which an image has been formed by the image forming apparatus 2 (step S802). Then, the controller 100b determines whether or not the first liquid application position B1 of the sheet P faces the liquid application unit 140 (more particularly, the liquid application head 146) (step S803). In a case where the controller 100b determines that the first liquid application position B1 of the sheet P does not face the liquid application unit 140 (NO in step S803), the controller 100b continues the conveyance of the sheet P by the conveyance roller pairs 10 and 11 until the first liquid application position B1 of the sheet P faces the liquid application unit 140 (YES in step S803). When the controller 100b determines that the first liquid application position B1 on the sheet P has faced the liquid application head 146 (YES in step S803), the controller 100b causes the conveyance roller pairs 10 and 11 (step S804) to stop conveying the sheet P. It is ascertained, based on a pulse signal output from a rotary encoder of a motor that drives the conveyance roller pairs 10 and 11, that the first liquid application position B1 on the sheet P has faced the liquid application head 146.

The controller 100b causes the liquid application unit 140 to execute the process of applying liquid to the first liquid application position B1 on the sheet P (step S805). More particularly, the controller 100b rotates the application head movement motor 151 in the first direction to bring the liquid application head 146 into contact with the first liquid application position B1 on the sheet P. The controller 100b changes the pressing force of the liquid application head 146 (i.e., the amount of rotation or rotation speed of the application head movement motor 151) depending on the amount of liquid to be applied to the sheet P.

The amount of liquid that is applied to the sheet P may be the same for all the sheets P of the sheet bundle Pb or may be different for each sheet P. For example, the controller 100b may decrease the amount of liquid applied to a sheet P conveyed later. The amount of rotation of the application head movement motor 151 can be ascertained based on a pulse signal output from a rotary encoder of the application head movement motor 151.

The controller 100b drives the conveyance roller pairs 10, 11, 14, and 15 to stack the sheet P on the internal tray 22 (step S806). The controller 100b also moves the side fences 24L and 24R in the main scanning direction to align the position of the sheet P or the sheet bundle Pb placed on the internal tray 22 in the main scanning direction. In short, the controller 100b performs so-called jogging (step S806).

The controller 100b determines whether or not the number of sheets P placed on the internal tray 22 has reached the given number of sheets Np indicated by the post-processing command (step S807). When the controller 100b determines that the number of sheets P placed on the internal tray 22 has not reached the given number of sheets Np (NO in step S807), the controller 100b executes the operations of steps S802 to S807 again until the number of sheets P placed on the internal tray 22 reaches the given number of sheets Np (YES in step S807).

By contrast, when the controller 100b determines that the number of sheets P that are placed on the internal tray 22 has reached the given number of sheets Np (YES in step S807), the controller 100b causes the crimper 32′ to crimp the binding position B1 (corresponding to the first liquid application position B1) on the sheet bundle Pb to which the liquid has been applied by the liquid application unit 140 (step S808). In addition, in step S808, the controller 100b rotates the conveyance roller pair 15 to eject the crimped sheet bundle Pb to the second ejection tray 26.

The controller 100b determines whether or not the number of sheet bundles Pb thus ejected to the second ejection tray 26 has reached the requested number of copies Mp indicated by the post-processing command (step S809). When the controller 100b determines that the number of the sheet bundles Pb ejected to the second ejection tray 26 has not reached the requested number of copies Mp (NO in step S809), the controller 100b repeats the process of steps S802 to S809 until the number of the sheet bundles Pb ejected to the second ejection tray 26 reaches the requested number of copies Mp (YES in step S809).

When the controller 100b determines that the number of sheet bundles Pb ejected to the second ejection tray 26 reaches the requested number of copies Mp (YES in step S809), the controller 100b drives the liquid applier movement motor 137 to move the liquid application unit 140 to the standby position HP1 (see FIGS. 36A and 36B) and drives the crimper movement motor 238 to move the crimper 32′ to the standby position HP2 (see FIGS. 34A to 34C) (step S810). When the posture that is instructed by the post-processing command is the “inclined binding posture”, the controller 100b drives the application head pivot motor 150 and the crimper pivot motor 239 to rotate the liquid application unit 140 and the crimper 32′ and the parallel binding posture (standby angle) into the parallel binding posture (step S810). On the other hand, when the posture that is instructed by the post-processing command is the “parallel binding posture”, the operation of rotating the liquid application unit 140 and the crimper 32′ to the parallel binding posture (standby angle) is skipped. In steps S801 and S810, the execution order of the movement in the main scanning direction and the rotation in the forward and reverse directions of the liquid application unit 140 and the crimper 32′ is not limited to the aforementioned order and may be reversed.

The present invention can be applied to not only the edge binder 25 that executes edge binding process but also to the saddle binder 28 that executes saddle binding process.

The controller 100b of the post-processing apparatus 3A according to the second embodiment illustrated in FIG. 33 is provided separately from the controller 100a of the image forming apparatus 2 as in the configuration of FIG. 1. However, embodiments of the present disclosure are not limited to the above-described configuration. For example, as illustrated in FIG. 42A, the controller 100b of the post-processing apparatus 3A may be disposed in the image forming apparatus 2. As in the configuration of FIG. 42B, the controller 100b of the post-processing apparatus 3A may be integrated with the controller 100a of the image forming apparatus 2.

As in the configuration of FIG. 43A, the controller 100b of the post-processing apparatus 3A may be divided into a controller 100b1 (e.g., a driver system such as a motor) and a controller 100b2 (a detector such as a sensor) according to the function, and the controller 100b2 of the post-processing apparatus 3A may be disposed in the image forming apparatus 2. Further, as in the configuration of FIG. 43B, the controller 100b2 of the post-processing apparatus 3A disposed in the image forming apparatus 2 may be integrated with the controller 100a of the image forming apparatus 2.

As described above, the control method by the controller 100b described above is implemented by cooperation between hardware resources of a computer and a program as computer software. In other words, the control method may be a method executed by a computer causing an arithmetic device, a storage device, an input device, an output device, and a control device to operate in cooperation with each other based on a program. The program may be written in, for example, a storage device or a storage medium and distributed with the storage device or the storage medium, or may be distributed through, for example, an electric communication line.

The present invention is not limited to each of the above-exemplified embodiments, and various modifications are possible within the range that does not depart from its technical gist, and all the technical contents included in the technical ideas described in the scope of claims are subject to the present invention. Although the above-described embodiments represent preferable examples, various modifications can be achieved by those skilled in the art from the disclosed contents. Such modifications are included in the technical scope described in the scope of claims.

### ASPECTS OF THE PRESENT DISCLOSURE

Aspects of the present disclosure are, for example, as follows.

### Aspect 1

In Aspect 1, a medium processing apparatus includes a liquid applier that performs liquid application to a part of at least one medium, a medium processing unit that performs processing on a bundle of media including the at least one medium to which the liquid application has been performed by the liquid applier, and a controller that controls operations of the liquid applier and the medium processing unit. The liquid applier includes a liquid application member that applies liquid in contact with the medium, a pressing unit that moves the liquid application member between a liquid application position in contact with the medium and a separated position separated from the liquid application position to press the liquid application member against the medium, and a liquid application amount detector that detects an amount of liquid applied to the medium by the liquid application. The controller changing a liquid application control mode for setting a movement amount of the liquid application member by the pressing unit and a contact time to the medium in accordance with at least the liquid amount.

### Aspect 2

In Aspect 2, in the medium processing apparatus according to Aspect 1, the controller changes the liquid application control mode based on the liquid amount, a temperature of the medium changed by processing performed on the medium before the processing in the medium processing unit, and a conveyance distance of the medium from a position where the temperature of the medium is caused to the medium processing unit.

### Aspect 3

In Aspect 3, in the medium processing apparatus according to Aspect 2, the controller performs the liquid application by setting the movement amount and the contact time with respect to a first medium constituting the bundle of media based on the temperature and the conveyance distance of the first medium, and changes the liquid application control mode based on the liquid amount of the first medium.

### Aspect 4

In Aspect 4, in the medium processing apparatus according to Aspect 2 or 3, in a case where the temperature of a second or subsequent medium among media constituting the bundle of media is equal to or less than a predetermined value with respect to the temperature of the first medium constituting the bundle of media, the controller changes the liquid application control mode of the medium in which the temperature is equal to or less than the predetermined value based on the temperature and the conveyance distance.

### Aspect 5

In Aspect 5, in the medium processing apparatus according to any one of Aspects 1 to 4, the liquid application amount detector sets a first medium among media constituting the bundle of media as a detection target of the liquid amount.

### Aspect 6

In Aspect 6, in the medium processing apparatus according to any one of Aspects 1 to 4, the liquid application amount detector sets all of media constituting the bundle of media as a detection target of the liquid amount.

### Aspect 7

In Aspect 7, in the medium processing apparatus according to any one of Aspects 1 to 6, the controller controls the liquid applier so as not to apply the liquid when the liquid amount is equal to or more than a predetermined value.

### Aspect 8

In Aspect 8, in the medium processing apparatus according to any one of Aspects 1 to 7, the process is crimp binding in which a part of the bundle of media is pressed and deformed and bound.

### Aspect 9

In Aspect 9, an image forming system includes an image forming apparatus that forms an image on the medium, the medium being one of a plurality of media, and the medium processing apparatus according to any one of Aspects 1 to 8 that performs the processing on the plurality of media on which the image has been formed by the image forming apparatus.

### Aspect 10

In Aspect 10, a medium processing apparatus includes a liquid applier, a medium processing device, and circuitry. The liquid applier includes a liquid application member, a pressing member, and a detector. The liquid application member contacts a part of at least one medium and apply liquid to the part of the at least one medium to perform liquid application. The pressing member moves the liquid application member between a liquid application position at which the liquid application member contacts the at least one medium and a separation position at which the liquid application member is separated from the liquid application position, and press, the liquid application member at the liquid application position, against the at least one medium. The detector detects a liquid amount of the liquid applied to the at least one medium subjected to the liquid application. The medium processing device performs a predetermined process on a bundle of media including the at least one medium subjected to the liquid application. The circuitry is to control the liquid applier and the medium processing device to set an amount of movement of the liquid application member moved by the pressing member and a contact time of the liquid application member to the at least one medium, to set a control mode, and change the control mode according to the liquid amount detected by the detector.

### Aspect 11

In Aspect 11, in the medium processing apparatus according to Aspect 10, the circuitry is further configured to change the control mode according to the liquid amount, a temperature of the medium changed by another process performed on the medium at a first position before the process performed by the medium processing device at a second position, and a conveyance distance of the medium from the first position to the second position.

### Aspect 12

In Aspect 12, in the medium processing apparatus according to Aspect 11, the bundle of media includes a first medium and a second medium conveyed subsequent to the first medium. The circuitry is further to set the amount of movement and the contact time for the first medium based on the temperature and the conveyance distance of the first medium, apply the liquid to the first medium, and change the control mode according to the liquid amount applied to the first medium.

### Aspect 13

In Aspect 13, in the medium processing apparatus according to Aspect 11 or 12, the bundle of media includes a first medium, a second medium conveyed subsequent to the first medium, and a subsequent medium conveyed subsequent to the second medium. The circuitry is further to change the control mode of the second medium and the subsequent medium based on the temperature and the conveyance distance, when the temperature of the second medium and the subsequent medium is equal to or less than a predetermined value.

### Aspect 14

In Aspect 14, in the medium processing apparatus according to any one of Aspects 10 to 13, the detector detects the liquid amount of the liquid applied to the first medium of the bundle of media.

### Aspect 15

In Aspect 15, in the medium processing apparatus according to any one of Aspects 10 to 13, the detector detects the liquid amount of the liquid applied to each medium of the bundle of media.

### Aspect 16

In Aspect 16, in the medium processing apparatus according to any one of Aspects 10 to 15, the circuitry is further to refrain from applying the liquid when the liquid amount is equal to or greater than a given value.

### Aspect 17

In Aspect 17, in the medium processing apparatus according to any one of Aspects 10 to 16, the medium processing device is a crimper to press and deform the bundle of media to bind the bundle of media.

### Aspect 18

In Aspect 18, an image forming system includes an image former, a liquid applier, a medium processing device, and circuitry. The image former forms an image on at least one medium. The liquid applier includes a liquid application member, a pressing member, and a detector. The liquid application member contacts a part of the at least one medium and applies liquid to the part of the at least one medium on which the image is formed by the image former to perform liquid application. The pressing member moves the liquid application member between a liquid application position at which the liquid application member contacts the medium and a separation position at which the liquid application member is separated from the liquid application position, and presses the liquid application member at the liquid application position against the medium. The detector detects a liquid amount of the liquid applied to the at least one medium subjected to the liquid application. The medium processing device performs a predetermined process on a bundle of media including the medium subjected to the liquid application. The circuitry is to control the liquid applier and the medium processing device to set an amount of movement of the liquid application member moved by the pressing member and a contact time of the liquid application member to the medium, to set a control mode, and change the control mode according to the liquid amount detected by the detector.

The present disclosure is not limited to specific embodiments described above, and numerous additional modifications and variations are possible in light of the teachings within the technical scope of the appended claims. It is therefore to be understood that, the disclosure of this patent specification may be practiced otherwise by those skilled in the art than as specifically described herein, and such, modifications, alternatives are within the technical scope of the appended claims. Such embodiments and variations thereof are included in the scope and gist of the embodiments of the present disclosure and are included in the embodiments described in claims and the equivalent scope thereof.

The effects described in the embodiments of this disclosure are listed as the examples of preferable effects derived from this disclosure, and therefore are not intended to limit to the embodiments of this disclosure.

The embodiments described above are presented as an example to implement this disclosure. The embodiments described above are not intended to limit the scope of the invention. These novel embodiments can be implemented in various other forms, and various omissions, replacements, or changes can be made without departing from the gist of the invention. These embodiments and their variations are included in the scope and gist of this disclosure and are included in the scope of the invention recited in the claims and its equivalent.

Any one of the above-described operations may be performed in various other ways, for example, in an order different from the one described above.

Each of the functions of the described embodiments may be implemented by one or more processing circuits or circuitry. Processing circuitry includes a programmed processor, as a processor includes circuitry. A processing circuit also includes devices such as an application specific integrated circuit (ASIC), digital signal processor (DSP), field programmable gate array (FPGA), and conventional circuit components arranged to perform the recited functions.

1. A medium processing apparatus comprising:
a liquid applier including:
a liquid application member to contact a part of at least one medium and apply liquid to the part of the at least one medium to perform liquid application;
a pressing member to:
move the liquid application member between:
a liquid application position at which the liquid application member contacts the at least one medium; and
a separation position at which the liquid application member is separated from the liquid application position; and
press, the liquid application member at the liquid application position, against the at least one medium; and
a detector to detect a liquid amount of the liquid applied to the at least one medium subjected to the liquid application;
a medium processing device to perform a predetermined process on a bundle of media including the at least one medium subjected to the liquid application; and
circuitry configured to control the liquid applier and the medium processing device to:
set:
an amount of movement of the liquid application member moved by the pressing member; and
a contact time of the liquid application member to the at least one medium,
to set a control mode; and
change the control mode according to the liquid amount detected by the detector.

2. The medium processing apparatus according to claim 1,
wherein the circuitry is further configured to change the control mode according to:
the liquid amount;
a temperature of the medium changed by another process performed on the medium at a first position before the process performed by the medium processing device at a second position; and
a conveyance distance of the medium from the first position to the second position.

3. The medium processing apparatus according to claim 2,
wherein the bundle of media includes:
a first medium; and
a second medium conveyed subsequent to the first medium, and
the circuitry is further configured to:
set the amount of movement and the contact time for the first medium based on the temperature and the conveyance distance of the first medium;
apply the liquid to the first medium for the liquid amount; and
change the control mode according to the liquid amount applied to the first medium.

4. The medium processing apparatus according to claim 2,
wherein the bundle of media includes a first medium, a second medium conveyed subsequent to the first medium, and a subsequent medium conveyed subsequent to the second medium, and
the circuitry is further configured to:
change the control mode of the second medium and the subsequent medium based on the temperature and the conveyance distance,
when the temperature of the second medium and the subsequent medium is equal to or less than a predetermined value.

5. The medium processing apparatus according to claim 4,
wherein the detector detects the liquid amount of the liquid applied to the first medium of the bundle of media.

6. The medium processing apparatus according to claim 1,
wherein the detector detects the liquid amount of the liquid applied to each medium of the bundle of media.

7. The medium processing apparatus according to claim 1,
wherein the circuitry is further configured to refrain from applying the liquid when the liquid amount is equal to or greater than a given value.

8. The medium processing apparatus according to claim 1,
wherein the medium processing device is a crimper to press and deform the bundle of media to bind the bundle of media.

9. An image forming system comprising:
an image former to form an image on at least one medium;
a liquid applier including:
a liquid application member to contact a part of the at least one medium and apply liquid to the part of the at least one medium on which the image is formed by the image former to perform liquid application;
a pressing member to:
move the liquid application member between:
a liquid application position at which the liquid application member contacts the medium; and
a separation position at which the liquid application member is separated from the liquid application position; and
press, the liquid application member at the liquid application position, against the medium; and
a detector to detect a liquid amount of the liquid applied to the at least one medium subjected to the liquid application;
a medium processing device to perform a predetermined process on a bundle of media including the medium subjected to the liquid application; and
circuitry configured to control the liquid applier and the medium processing device to:
set:
an amount of movement of the liquid application member moved by the pressing member; and
a contact time of the liquid application member to the medium,
to set a control mode; and
change the control mode according to the liquid amount detected by the detector.
